(19) United States
(12) Patent Application Publication
(10) Pub. No.: US 2022/0107008 A1
(43) Pub. Date: Apr. 7, 2022

(54) INFINITELY VARIABLE AND PSEUDO CONTINUOUSLY TRANSMISSION CAPABLE OF UNINTERRUPTED SHIFTING UTILIZING CONTROLLED ROTATION TECHNOLOGY

(71) Applicants: Raja Ramanujam Rajendran, Troy, MI (US); Prashanth Ram Rajendran, Troy, MI (US)

(72) Inventors: Raja Ramanujam Rajendran, Troy, MI (US); Prashanth Ram Rajendran, Troy, MI (US)

(21) Appl. No.: 17/542,482

(22) Filed: Dec. 5, 2021

Related U.S. Application Data
(63) Continuation-in-part of application No. PCT/US2019/041748, filed on Jul. 15, 2019.
Application No. PCT/US2019/041748 is a continuation-in-part of application No. PCT/US2020/036636, filed on Jun. 8, 2020.
Application No. PCT/US2020/036636 is a continuation-in-part of application No. PCT/US2021/017984, filed on Feb. 12, 2021.
Application No. PCT/US2021/017984 is a continuation-in-part of application No. PCT/US2021/036266, filed on Jun. 7, 2021.
Application No. PCT/US2021/036266 is a continuation-in-part of application No. 16/395,219, filed on Apr. 25, 2019.

(51) Int. Cl. F16H 3/76; F16H 27/06

(52) U.S. Cl. CPC F16H 3/76; F16H 2035/003; F16H 27/06

(57) ABSTRACT

This invention discloses uninterrupted shifting in transmissions with the use of controlled rotation to achieve desired profile for input to output ratio, thereby eliminating synchronized clutch. Controlled rotation achieved using non-circular gears or Geneva pin and slot wheel mechanism with a customized path for the slot, is used to achieve multiple speed/infinitely variable transmission ratios and/or to transition from one transmission ratio to another. The transition happens over multiple rotations of the input making it highly suited for high torque applications. Since it is not using sprag or one way bearing engine breaking can be achieved. Infinitely Variable Transmission offers steady and uniform output for a steady and uniform input. With co-axial input and output, using planetary gear system, the output can be made continuous from forward to reverse. Multi-Speed uninterrupted shifting is achieved without the need for synchronizers and using a dog clutch or similar device.

### CROSS REFERENCE TO RELATED APPLICATIONS

1. US non-provisional utility patent application
   Application Number: Ser. No. 16/395,219
   Title: Infinitely Variable Transmission with uniform input-to-output ratio that is non-dependent on friction
2. PCT Application
   Application Number: PCT/US2019/041748
   Title: Pseudo Continuously Variable Transmission
3. PCT Application
   Application Number: PCT/US2020/036636
   Title: Pseudo Continuously Variable Transmission with uninterrupted shifting
4. PCT Application
   Application Number: PCT/US2021/017984
   Title: Infinitely Variable Transmission with uniform input-to-output ratio that is non-dependent on friction
5. PCT Application
   Application Number: PCT/US2021/036266
   Title: Pseudo Continuously Variable Transmission with uninterrupted shifting

### BACKGROUND OF THE INVENTION

Presently, synchronized clutch is used in transmissions to shift from one ratio to another ratio which involves a brief torque interruption affecting efficiency. This invention pertains to uninterrupted shifting in transmissions with the use of controlled rotation to achieve the desired profile for the input to output ratio over time, thereby eliminating synchronized clutch.

Controlled rotation is achieved using non-circular gears or Geneva pin and slot wheel mechanism with a customized path for the slot. All the non-circular gears and regular gears in this invention can be replaced with Geneva pin and wheel mechanism. Controlled rotation using non-circular gears or Geneva mechanism can be used to achieve multiple speed/infinitely variable transmission ratios and/or to transition from one transmission ratio to another. Multiple pins and multiple slots are used and with an overlap of more than one pin achieving a portion of the same results simultaneously.

CVT using ratchet mechanism with scotch yoke mechanism, rack, and pinion and one way bearing 138 must use controlled rotation in order to have uniform rack movement.

Geneva pin wheel 96 and Geneva slot wheel 97 with a slot with a specific geometry/path can be used in place of non-circular gears or circular gears briefly overlapping with existing ratio and ramping up or down to reach the targeted ratio and then overlapping with the targeted ratio and disconnecting.

In the prior arts CN101737461A and WO2017190727A1, the operating plane is moved along with a single driven circular gear.

In prior art CN101737461A the input shaft and output shaft are placed at an angle, and not parallel. So, the “depth’ dimension depends on the sizes of the circular gears and could be large.

In prior art WO2017190727A1, the center-to-center distance changes with every shifting. So, this invention cannot be used in applications where the center-to-center distance is required to be constant.

In both prior arts the design has only one size gear for the driven gear. This limits the number of inputs to output combination. A steep increase or decrease of ratio is hard to achieve.

Another disadvantage for both the prior arts is that for all the driving gears there is a single driven gear which limits the range for the input-to-output ratio.

In prior art CN100400940C non-circular gears are used to bridge transition from one ratio to another by briefly overlapping the constant regions of the existing ratio to the targeted ratio of the transmission ratios for a smooth transition. The non-circular gear has regions of existing ratios and targeted ratio separated by ramp up and ramp down regions. The drawback is that these driving and driven non-circular gears must have exact number of teeth and the ratio of their pitch circle perimeters must be an integer or reciprocal of an integer in order to achieve repeatability. This reduces the duration of one or more regions and not suitable for high-speed application such as electric vehicles where the RPM is very high. The current invention uses non-circular gears with “bald” region in place of ramp up region or ramp down region to eliminate the need to have repeatability. The missing region is added to another set of non-circular gear pairs. These non-circular/circular gears are segmented and have the ability to axially move away/toward their operating planes to engage/disengage with each other without the need of a clutch/dog clutch. Thus, need for repeatability is eliminated here.

The current invention eliminates all the above disadvantages. The current invention also allows a smooth transition from one ratio to another ratio in an uninterrupted manner without the need for a synchronizer or clutch. The current invention also uses a Geneva mechanism, with custom path for the slot wheel, to replace circular or non-circular gear. Non-circular gears are an expensive option when compared to Geneva mechanism with custom path. By having a circular pin or optionally non-circular pins for the pin wheel 96 any slight variation in the desired input/output can be easily adjusted. Cam and pin can also be used in place of Geneva mechanism.

Today, several Continuously Variable Transmissions exist that use a belt and variable diameter pulleys that totally relay on friction between the belt and the pulley to transmit power, offering infinite input to output ratios. The pseudo continuously variable transmission in this disclosure does not fall under the category “Continuously” Variable Transmission since it has a discrete number of ratios rather than infinite ratios. Each of them uses multiple sprockets/gears on driving and the driven ends while only one sprocket/gear is active at both the ends at any given time. By swapping between larger and smaller sprocket/gears the input to output ratio is changed. When shifting from one ratio to another, the change is continuous and gradual. Hence the name Pseudo Continuously Variable Transmission.

The present invention relates to smooth uninterrupted synchronizing before shifting of gears. Geared bicycles today have multiple sprockets with different sizes placed coaxial and offset to one another and the Chain/Belt 139 is made to travel axially using a derailleur to align with a specific sprocket. Another way to achieve this will be to keep the Chain/Belt 139 in the same plane and instead move the sprockets of various sizes in and out of chains plane. The same idea can be extended to regular gears, pulleys, and cage pins. Spring loaded segments forming different full larger size gears including non-circular gears are moved in and out of operating plane to achieve several input to output ratios. Same concept can be applied to pulleys too. With gears, pulleys or sprockets, this idea can be applied not just for bicycle application but also to automotive and other applications.

In chain and sprocket application, since there is a tensioner involved, so, the shifting will be smoother. However, this will not be true for gears. The change would be abrupt. When used with a set of non-circular gears, this shifting can be achieved in an uninterrupted manner. This idea can be applied not just for bicycle application but also to automotive and other applications.

The infinitely variable transmission in this disclosure pertains to transmissions having variable ratios between input and output velocities. Specifically, it relates to all-gear transmissions whose velocity ratios may be changed continuously over a wide range of values ranging from zero to non-zero values, without depending on friction. This invention provides a design for UNIFORM and STEADY output, when the input is uniform and steady, with the ability to transmit high torque without depending on friction or friction factor. Many of the continuously variable transmissions that are in the market today are friction dependent and therefor lack the ability to transmit high torque. Those continuously variable transmissions, which are non-friction dependent do not have a uniform and steady output when the input is uniform and steady. The design that offers all is too complex and hard to mass produce. This design aids reduction in the overall size and can be economically mass produced. This design can be easily integrated into any system. This design is very versatile and can be used ranging from light duty to heavy duty applications. This design allows replacement of existing regular transmission, requiring very little modification. This design offers stationary and co-axial input and output.

In order to switch ratios in a transmission the input shaft and output shaft disconnect and connect to gears that are different in size. Technology today enables this by temporarily disconnecting the set of gears that are engaged and with the use of synchronizers switches to another set of gears. A CVT that uses a variable pulley and belt system enables this, however the efficiency is lower than that of a transmission that uses gears. Since variable pulley and belt CVTs are friction dependent, the torque transmitting capacity is limited. Use of multi-speed transmission eliminates this problem. However, it has limited number of ratios.

This invention provides a design for a multi-speed transmission that does not use synchronizers or clutches. It uses an additional set of non-circular gears and dog clutch 53 which are comparatively inexpensive than having synchronizers and clutches. So synchronized uninterrupted shifting of two speed makes it ideal for an electric car. Geneva pin wheel 96 and Geneva slot wheel 97 with a slot with a specific geometry/path can be used in place of non-circular gears or circular gears.

A major advantage in today's Continuously Variable Transmissions that use a belt and variable diameter pulleys is that there is no interruption during ratio changing. However, they rely on friction. The ratio change is continuous. This new invention also offers uninterrupted shifting during ratio changing, however, has a discrete number of gear ratios. So, the current invention does not fall under the category “Continuously” Variable Transmission since it has a discrete number of ratios rather than infinite ratios. In a regular transmission, multiple gears on driving and the driven ends are used, while only one gear is active at both the ends at any given time. By simultaneously activating a non-circular gear pair for a brief period while swapping between larger and smaller gears, the input to output ratio is changed uninterrupted. When shifting from one ratio to another, the change is continuous and gradual. Hence the name Pseudo Continuously Variable Transmission. These concepts and detailed working operation are explained in Detailed Description of the Invention section.

The U.S. Pat. No. 9,970,520 offers a steady input to output ratio and co-axial input and output shaft in a comparably smaller envelope than that of its prior art. This is achieved with a use of a set of non-circular gears using as few as three modules. The drawback is that it is hard to mass produce the desired non-circular gears and will add significant manufacturing cost. It is also difficult to accurately design the tooth profile to achieve a uniform input to output ratio.

The present invention uses a custom designed Geneva wheel mechanism to achieve uniform rack velocity during functional region and circular/non-circular gear for non-functional region. The portion of the region used by the Geneva wheel mechanism is also non-functional region which overlap with the non-functional region achieved by the circular/non-circular gears for smooth transition. It is also possible to use Geneva wheel mechanism for functional and non-functional region. However, it will be economical to use a partial circular gear for the non-functional region. The path of the Geneva slot engaging with the Geneva pin determines the shape of the functional or non-functional region.

In general, a Geneva wheel mechanism has straight slot and is commonly used in applications needing indexing. Using a commonly used Geneva wheel mechanism with straight slot will not achieve uniform rack movement in the functional region and these slots must have a specific shape to achieve uniform rack movement in the functional region.

For Geneva wheel mechanism with straight slots, it is not possible to use multiple pins working at the same time. Resulting angular velocity will not be identical for both pins to have uniform overlap.

### BRIEF SUMMARY OF THE INVENTION

This invention provides a design for a Pseudo Continuously Variable Transmission with multi-speed uninterrupted shifting from one ratio to another. This design has multiple pairs of gears for the different gear ratios. The transition from one ratio to the next is continuous and gradual and is achieved using one of the following:
1. non-circular gears where activating a specific gear is achieved using a dog clutch or moving the gears in or out of an operating plane in segments
2. Geneva pin and wheel mechanism where specific pins are retracted or extended using position sensor and solenoids, or rotationally fixed axially movable spiral ramp/cam 168 to engage or disengage from the shaft. The Geneva pin wheel 96 and the slot wheel spin at different rpm, hence the pin wheel 96 and the slot wheel 97 may not meet exactly at the entry point. To aid this the slot wheel 97 is placed on a one way bearing and attached to a stepper motor which rotates the slot wheel 97 to its shaft in the direction that the one-way bearing allows. The stepper motor is controlled by a position sensor placed on the Geneva pin shaft and Geneva slot shaft and is controlled by a controller.

This invention also discloses an infinitely variable transmission with uniform and steady output, when the input is uniform and steady, with the ability to transmit high torque without depending on friction or friction factor. It uses controlled rotation between driving and driven shafts to achieve this. This design allows replacement of existing regular transmission, requiring very little modification. This design offers stationary and co-axial input and output.

This design uses
1. uniform rotation to non-uniform rotation using Geneva mechanism, which is transferred to
2. linear oscillation of a rack (a portion of which is uniform) using a scotch yoke mechanism, resulting in
3. uniform rocking of a pinion
4. and converted to uniform unidirectional rotation via a one-way bearing.

### BRIEF DESCRIPTION OF THE SEVERAL VIEWS OF THE DRAWINGS

FIG. 1—Front view of transmission assembly showing regions 1009 where swapping of the gear segments to make conjugate gears coplanar or offset is allowed

FIG. 2—Transmission assembly with combined large gear and transition gear and single operating plane 1003, in low-speed configuration showing low speed circular gears engaged

FIG. 3—Transmission assembly with combined large gear and transition gear and single operating plane 1003, with transition gears engaged in up-shift configuration

FIG. 4—Transmission assembly with combined large gear and transition gear and single operating plane 1003, in high-speed configuration showing high speed circular gears engaged

FIG. 5A-5B—Transition Gear pair with orifice matching contour of the smaller gear of the circular gear pair showing downshift
5A—Top View
5B—Side View

FIG. 6A-6B—Transition Gear pair with orifice matching contour of the smaller gear of the circular gear pair showing up-shift
6A—Side View
6B—Top View

FIG. 7—Large circular driving and driven circular gears each with orifice matching the contour of the small driving or driven gear on one side and contour overlapping larger gear portion of the transition gear on the other side

FIG. 8—Transmission assembly with combined large gear and transition gear and single operating plane 1003, with transition gears engaged in downshift configuration

FIG. 9—Transmission assembly with one set of segmented full gears and multiple operation planes, in Low-speed configuration

FIG. 10—Transmission assembly with one set of segmented full gears and multiple operation planes, in high-speed configuration

FIG. 11—Transmission assembly with one set of segmented full gears and multiple operation planes, with transition gears engaged in up-shift configuration

FIG. 12—Transmission assembly with one set of segmented full gears and multiple operation planes, with transition gears engaged in downshift configuration

FIG. 13—Transmission assembly using telescopic shafts and transition gears with partial teeth profile and large circular driving gear with clearance pocket to accommodate the transition gear, with transmission gears in up-shift configuration

FIG. 14—Transmission assembly using telescopic shafts and transition gears with partial teeth profile and large circular driving gear with clearance pocket to accommodate transition gear, in high-speed configuration

FIG. 15—Transmission assembly using telescopic shafts and transition gears with partial teeth profile and large circular driving gear with clearance pocket to accommodate transition gear, in low-speed configuration

FIG. 16—Transmission assembly using telescopic shafts and transition gears with partial teeth profile and large circular driving gear with clearance pocket to accommodate transition gear, with transition gears in downshift configuration

FIG. 17—Transmission assembly using telescopic shafts and transition gears with partial teeth profile and large circular driving gear with clearance pocket to accommodate transition gear, showing assembly side view with partial non-circular gears engaged

FIG. 18A-18E Transition gears with void zones (partial non-circular gears)
18A—transition gears with two void zones in Up-shift scenario
18B—transition gears with one void zone in Up-shift scenario
18C—transition gears with two void zones in downshift scenario
18D—transition gears with one void zone in downshift scenario
18E—non-circular gear with six zones that includes two void zones to allow axial translation of the non-circular gear to engage by moving co-planer and to dis-engage by moving offset

FIG. 19—Schematic View of transmission with two partial transition conjugate gears for a full transition gear and circular gear pairs using dog clutch 53, with high-speed circular gears engaged and transition gears fully disengaged

FIG. 20A-20F—Full transition gear engaged with one partial conjugate transition gear
20A—Full Non-circular gear for upshift with 1 zone and void zones
20B—Full Non-circular gear for downshift with 1 zone and void zones
20C—Full Non-circular gear for low speed with 2 zones and void zones
20D—Full Non-circular gear for high speed with 2 zones and void zones
20E—Full Non-circular gear for low speed with 2 zones and void zones
20E—Full Non-circular gear for high speed with 2 zones and void zones

FIG. 21A-21D—Noncircular Gear Segments forming full transition gear with their respective shafts
21A—Complete Isometric
21B—Exploded Isometric
21C—Top View
21D—Bottom View

FIG. 22-28—Schematic view of transmission with multiple operating planes 1003 with each low-speed gear pair, transition gear pair and high-speed gear pair with their own operating plane 1003, showing various steps in shifting from low-speed zone to high-speed zone through upshift zone

FIG. 22—Low speed circular gears engaged, and transition gears disengaged

FIG. 23—Low speed circular gears engaged and Transition Gears in the process of being engaged when they reach low speed zone

FIG. 24—Transition gears fully engaged at the end of low-speed zone with low-speed circular gears in the process of being disengaged

FIG. 25—Transition gear passed up-shift zone and having reached high speed zone and low speed circular gears fully disengaged

FIG. 26—Transition gears in high-speed zone and high-speed circular gears are in the process of being engaged

FIG. 27—Transition gears in the process of being disengaged when they are in high-speed zone and high-speed circular gears fully engaged

FIG. 28—High speed circular gears engaged, and transition gears disengaged

FIG. 29-35—Schematic view of transmission with multiple operating planes 1003 with each low-speed gear pair, transition gear pair and high-speed gear pair with their own operating plane 1003, showing various steps in shifting from high-speed zone to low-speed zone through downshift zone

FIG. 29—High speed circular gears engaged, and transition gears disengaged

FIG. 30—High speed circular gears engaged and Transition Gears in the process of being engaged when they reach high speed zone

FIG. 31—Transition gears fully engaged and at the end of high-speed zone with high-speed circular gears in the process of being disengaged

FIG. 32—Transition gear past down shift zone and reached low speed zone and high-speed circular gears fully disengaged

FIG. 33—Transition gears in low-speed zone and low speed circular gears are in the process of being engaged

FIG. 34—Transition gears in the process of being disengaged when they are in low-speed zone and low speed circular gears fully engaged

FIG. 35—Low speed circular gears engaged, and transition gears fully disengaged

FIG. 36—Schematic View of multi speed transmission with 3 transmission gear ratios showing 3 circular gear pairs and two non-circular transition gear pairs

FIG. 37—Schematic View of transmission with abrupt transition with torsion spring between engine and the transmission and also between wheel and transmission

FIG. 38—Transmission with Duration Extender Module (DEM) using Geneva wheel mechanism

FIG. 39A-39B—Double DEM Transmission with non-circular gears for controlled rotation device
39A—with ring gear
39B—with sprocket and chain

FIG. 40A-40B—Double DEM Transmission with Geneva mechanism for controlled rotation device with axial linking mechanism between slot wheel 97 and ring/sprocket and slot wheel 97 on a one way bearing with a stepper motor
40A—with ring gear
40B—with sprocket and chain

FIG. 41—Isometric view Double DEM Transmission without controlled rotation device

FIGS. 42-47—Schematic view of transmission with one-way bearing 50 in the largest driven gear showing various steps in shifting from low-speed zone to high-speed zone through up-shift zone

FIG. 42—(Low-Speed) smaller driving gear 13 is always engaged with larger driven gear. The larger driven gear is attached to the driven shaft via a one-way bearing 50. Neither of these gears are segmented. The low-speed gears are active via one-way bearing.

FIG. 43—When the orientation of the transition gears reaches low-speed zone the transition gears are made to engage with its conjugate gear, in segments in a region when none of the teeth in that segment are meshed with the conjugate transition gear. At this moment both the transition gear and the low-speed gears via one-way bearing 50 are active

FIG. 44—As the driven gear increases in speed the low-speed gears become inactive because of the One-way bearing 50. The transition gear reaches the high-speed zone after passing through the up-shift zone. The low-speed gears are inactive via One-way bearing 50

FIG. 45—When the transition gear reaches the high-speed zone, the larger driving gear, and the Smaller driven gear 16 are engaged, in segments in a region when none of the teeth in that segment are meshed with its conjugate gear. At this moment the transition gear and the high-speed gears are engaged. The low-speed gears are inactive via One-way bearing 50.

FIG. 46—While the larger driving gear engaged with the smaller driven gear 16 and before the transition gears transition to downshift zone, the transition gears are disengaged, in segments in a region when none of the teeth in that segment are meshed with the conjugate transition gear. The low-speed gears are inactive via One-way bearing.

FIG. 47—Transition to high-speed is achieved

FIGS. 48-53—Schematic view of transmission with one-way bearing in the largest driven gear showing various steps in shifting from high-speed zone to low-speed zone through downshift zone

FIG. 48—Shown: (High-Speed) larger driving gear engaged with the smaller driven gear 16. The low-speed gears are inactive via one-way bearing 50.

FIG. 49—While the larger driving gear engaged with the smaller driven gear 16 and when the orientation of the transition gears reaches high-speed zone (the larger gear segment of the driving transition gear is engaged with the smaller gear segment of the driven transition gear), the transition gears are engaged, in segments in a region when none of the teeth in that segment are meshed with the conjugate transition gear. At this moment both the transition gear and the high-speed gears are engaged. The low-speed gears are inactive via one-way bearing 50.

FIG. 50—Following immediately and before the transition gear changes to up-shift zone the driving larger gear is disengaged, in segments in a region when none of the teeth in that segment are meshed with the conjugate gear. The low-speed gears are inactive via one-way bearing 50.

FIG. 51—The transition gear reaches the low-speed zone after passing through the downshift zone. The low-speed gears are inactive via One-way bearing 50.

FIG. 52—Transition to low-speed is achieved

FIG. 53—Following immediately and before the transition gear changes to up-shift zone the driving transition gear is disengaged with, in segments in a region when none of the teeth in that segment are meshed with the conjugate transition gear. The low-speed gears are active via one-way bearing 50.

FIG. 54—Double DEM transmission with Geneva wheels

FIG. 55—Single DEM transmission with Geneva wheels

FIG. 56—Single DEM transmission with Geneva wheels

FIG. 57 A—No DEM transmission with Geneva wheels with all driving gears with dog clutches and all driven rigidly connected to its shaft

FIG. 57 B—No DEM transmission with Geneva wheels with dog clutch on largest driving gear and one-way bearing on the smallest driven gear and all others rigidly connected to its shaft

FIG. 58A-58B—Driven Geneva slot wheel 97
58A—Front view
58B—Side View
58C—Back View

FIG. 59A-59B—Driving Geneva pin wheel
59A—Front view
59B—Side View

FIG. 60A-60B—Spiral flute collar
60A—Front view
60B—Side View

FIG. 61A-61B—Spiral flute collar and Geneva pin wheel with shaft and key assembly
61A—Front view
61B—Side View

FIG. 61C-61E—Stepper motor Geneva pin wheel with shaft and key assembly
61C—Front view
61D—Side View
61E—Section view of FIG. 61C showing one way bearing and stepper motor
61F—Spiral Ramp for Geneva Pins

FIG. 62A-62C—Driving Geneva slot & pin wheel with partial gear assembly
62A—Top view
62B—Side View
62C—Isometric View

FIG. 63—Isometric view Driving Geneva slot & pin wheel with coaxial partial gear assembly

FIG. 64A-64C—Driving Geneva slot & pin wheel with partial gear assembly
64A—Front view
64B—Side View
64C—Isometric View

FIG. 65A-65E—Graphs showing angular velocity ratio of the Geneva pin and wheel mechanism over time
65A—Transition from lower to higher angular velocity ratio by ramping up
65B—Transition from higher to lower angular velocity ratio by ramping down
65C—Transition from lower to higher angular velocity ratio by ramping up followed by transition from higher to lower angular velocity ratio by ramping down
65D—Figure showing 2 cycles of the above (FIG. 65C).
65E—Graph showing more than two areas of constant angular velocity ratio and transition from lower to higher angular velocity ratio and transition from higher to lower angular velocity ratio between them

FIG. 66A-66D—Multiple ways to achieve Multi-Speed Transmission with Uninterrupted Shifting (MSTUS)
66A—Geneva Assembly with partial circular gear for MSTUS
66B—Cam Assembly for MSTUS
66C—Geneva Assembly for MSTUS
66D—Non-Circular Gear Assembly for MSTUS

FIG. 67A—Gate for crossing slot path for Geneva mechanism

FIG. 68—IVT general assembly perspective view—Exploded.

FIG. 69—Angular velocity module using Geneva pin and wheel mechanism along with partial circular/non-circular gears

FIG. 70A—Crank pin displacement mechanism using link mechanism with sliding collar placed coaxially inside the input shaft and crank pin shaft

FIG. 70B—Crank pin displacement mechanism using link mechanism with sliding collar placed coaxially inside the input shaft and input disk

FIG. 71A—71B—Scotch yoke module and rectifier module. Rectifier module showing rack and pinion, with pinions placed on a common output shaft on a one-way bearing along with dummy rack 105, and common output shaft. Showing force acting on the rack is co-planer with longitudinal axis of the pinion.
71A—Perspective view
71B—Perspective view exploded

FIG. 72—Input shaft and input disk assembly perspective view

FIG. 73A—73D Input disk, crank pin shaft and link pivot pin assembly
73A—Top view
73B—Front view
73C—Side view 1
73D—Perspective view

FIG. 74A-74C Different configurations for slotted rack holder

FIG. 75A-75C—Geneva pin wheel
75A—Front view
75B—Side view 1
75C—Perspective view

FIG. 76 Input disk

FIG. 77A-77C—Geneva slot wheel double sided with slot and wall
77A—Perspective view showing details of the bottom
77B—Perspective view showing details of the top
77C—Perspective view showing different configuration

FIGS. 78-79 Additional optional configurations for Geneva slot wheel

FIG. 80—Scotch yoke input frame

FIG. 81—Scotch yoke frame

FIG. 82—Scotch yoke rectifier frame

FIG. 83—Ratio modifier frame

FIG. 84—Ratio plate

FIG. 85—Partial driving/driven gear for non-functional region

FIG. 86—Link

FIG. 87—crank pin

FIG. 88A-88D Link Mechanism on crank pin shaft with non-circular input shaft and collar 108 with matching orifice, using offset crank pin mounted on crank pin collar with non-circular orifice sliding on crank pin shaft with matching cross-section
88A—Top view
88B—Front view
88C—Side view
88D—Perspective view

FIG. 89A-89D Link Mechanism on crank pin shaft with non-circular input shaft and collar 108 with matching orifice, using input disk
89A—Top view
89B—Front view
89C—Side view
89D—Perspective view

FIG. 90—Rack velocity profile

FIG. 91—Rotationally fixed axially movable spiral ramp/cam

FIG. 92-97—Options for connecting input, output and wheel using planetary gear

FIG. 98A-98B
98A Possible path of crank pin on Geneva wheel mechanism and showing partial gears for non-functional region.
98B Ramp in slot to push the Geneva pin to retracted position.

FIG. 99-101—Alternate configurations for ratio changing mechanism assembly using different shapes for input shaft, crank pin and collar 108

FIG. 102-103—Input shaft with notch for crank pin shaft, link, and pivot pin for collar 108 and link

FIG. 102—Front view

FIG. 103—Side view

FIG. 104—Dummy crank pin assembly

FIG. 105—Mechanism to compensate for vibration due to rotational imbalance

FIG. 106A-106D—Slotted hollow input shaft
106A—Top view
106B—Front view
106C—Side view
106D—Perspective view

FIG. 107A-107D—Collar with thrust bearings
107A—Top view
107B—Front view
107C—Side view
107D—Perspective view

FIG. 108A-108D—2 racks shown 180 degrees apart
108A—Top view
108B—Front view
108C—Side view
108D—Perspective view
108E—Isometric View

FIG. 109A-109D—2 dummy racks shown 180 degrees apart
109A—Top view
109B—Front view
109C—Side view
109D—Perspective view
108E—Isometric View

FIG. 110A-110B—Alternative angular velocity module using stationary sun gear
110A—Perspective view
110B—Section through driven gear

FIG. 111A-111B—Alternative angular velocity module using stationary ring gear
111A—Perspective view
111B—Section through driven gear

FIGS. 112-115—achieving Reverse/Park/Neutral using bevel gears:

FIG. 116—Rack velocity profile and overlap of functional regions of consecutive modules in X-Y plane

FIG. 117—Rack velocity profile and overlap of functional regions of consecutive modules using polar coordinates

FIG. 118 Achieving MSTUS with Chain and Sprocket (prior art)

FIG. 119—Achieving MSTUS with gears

FIG. 120—Achieving MSTUS with pin gear mechanism-pin wheel and non-circular pin gear wheels where the pins are in a pattern to work with the non-circular pin gear.

FIG. 121—MSTUS concept for a chain and sprocket transmission using chains and sprockets with Duration Extender Module (DEM)

FIG. 122—MSTUS concept for a gear transmission using gears with Duration Extender Module (DEM)

FIG. 123A—MSTUS with driving and driven circular and non-circular gear, without DEM without Linking Mechanism

FIG. 123B—ABOVE with axial Linking Mechanism between driving shaft and DEM driving shaft

FIG. 124A—MSTUS with DEM without Linking Mechanism

FIG. 124B—MSTUS with DEM with Linking Mechanism linking driving shaft to speed reduction gear

FIG. 124C—MSTUS with DEM with Linking Mechanism axially linking speed reduction gear to DEM

FIG. 124D—MSTUS with DEM with Linking Mechanism linking driving shaft to speed reduction gear and with DEM with Linking Mechanism axially linking speed reduction gear to DEM

FIG. 125A—MSTUS with DEM without Linking Mechanism with multiple layers of speed reduction

FIG. 125B—MSTUS with DEM with Linking Mechanism linking driving shaft to speed reduction gear with multiple layers of speed reduction

FIG. 125C—MSTUS with DEM with Linking Mechanism axially linking speed reduction gear to DEM with multiple layers of speed reduction

FIG. 125D—MSTUS with DEM with Linking Mechanism linking driving shaft to speed reduction gear with multiple layers of speed reduction and with DEM with Linking Mechanism axially linking speed reduction gear to DEM with multiple layers of speed reduction

FIG. 126A—MSTUS with DEM without Linking Mechanism using transmission gears as speed reduction gears, with common set of non-circular gears for all ratios

FIG. 126B—MSTUS with DEM using transmission gears as speed reduction gears, with common set of non-circular gears for all ratios with linking mechanism between driving shaft and DEM driving gear

FIG. 126C—MSTUS with DEM with Linking Mechanism axially linking speed reduction gear to DEM, using transmission gears as speed reduction gears

FIG. 126D MSTUS with DEM using transmission gears as speed reduction gears, with common set of non-circular gears for all ratios with linking mechanism between driving shaft and DEM driving gear with Linking Mechanism axially linking speed reduction gear to DEM, using transmission gears as speed reduction gears

FIG. 127A—MSTUS with DEM without Linking Mechanism using transmission gears as speed reduction gears, with a different set of non-circular gears for every ratio

FIG. 127B—MSTUS with DEM using transmission gears as speed reduction gears, with a different set of non-circular gears for every ratio with linking mechanism between driving shaft and DEM driving gear

FIG. 127C—MSTUS with DEM with Linking Mechanism axially linking speed reduction gear to DEM, using transmission gears as speed reduction gears, with a different set of non-circular gears for every ratio

FIG. 127D—MSTUS with DEM using transmission gears as speed reduction gears, with a different set of non-circular gears for every ratio with linking mechanism between driving shaft and DEM driving gear and with Linking Mechanism axially linking speed reduction gear to DEM, using transmission gears as speed reduction gears, with a different set of non-circular gears for every ratio

FIG. 128—Upshift scenario from ratio “A” to “B”

FIG. 129—Downshift scenario from ration “B” to “A”

FIG. 130A—MSTUS with DEM without Linking Mechanism, using multiple train, with one set of non-circular gears for every ratio

FIG. 130B—MSTUS with DEM, using multiple train, with one set of non-circular gears for every ratio with axial Linking Mechanism between driving shaft and DEM driving shaft

FIG. 130C—MSTUS with DEM, using multiple train, with one set of non-circular gears for every ratio with Linking Mechanism axially linking speed reduction gear to DEM

FIG. 130D—MSTUS with DEM, using multiple train, with one set of non-circular gears for every ratio with axial Linking Mechanism between driving shaft and DEM driving shaft with using multiple train, with one set of non-circular gears for every ratio with Linking Mechanism axially linking speed reduction gear to DEM

FIG. 131A—MSTUS with DEM without Linking Mechanism, using multiple train using transmission gears as speed reduction gears, with one set of non-circular gears for every ratio

FIG. 131B—MSTUS with DEM, using multiple train using transmission gears as speed reduction gears, with one set of non-circular gears for every ratio with axial Linking Mechanism between driving shaft and DEM driving shaft

FIG. 131C—MSTUS with DEM, using multiple train using transmission gears as speed reduction gears, with one set of non-circular gears for every ratio with Linking Mechanism axially linking speed reduction gear to DEM

FIG. 131D—MSTUS with DEM, using multiple train using transmission gears as speed reduction gears, with one set of non-circular gears for every ratio with axial Linking Mechanism between driving shaft and DEM driving shaft with DEM, using multiple train using transmission gears as speed reduction gears, with one set of non-circular gears for every ratio with Linking Mechanism axially linking speed reduction gear to DEM

FIG. 132A—MSTUS with DEM without Linking Mechanism, using multiple train, with multiple set of non-circular gears for every ratio

FIG. 132B—MSTUS with DEM, using multiple train, with multiple set of non-circular gears for every ratio with axial Linking Mechanism between driving shaft and DEM driving shaft

FIG. 132C—MSTUS with DEM, using multiple train, with multiple set of non-circular gears for every ratio with Linking Mechanism axially linking speed reduction gear to DEM

FIG. 132D—MSTUS with DEM, using multiple train, with multiple set of non-circular gears for every ratio with axial Linking Mechanism between driving shaft and DEM driving shaft with DEM, using multiple train, with multiple set of non-circular gears for every ratio with Linking Mechanism axially linking speed reduction gear to DEM

FIG. 133A—MSTUS with DEM without Linking Mechanism, using multiple train, with one set of non-circular gears for multiple ratios

FIG. 133B—MSTUS with DEM, using multiple train, with one set of non-circular gears for multiple ratios with axial Linking Mechanism between driving shaft and DEM driving shaft

FIG. 133C—MSTUS with DEM, using multiple train, with one set of non-circular gears for multiple ratios with Linking Mechanism axially linking speed reduction gear to DEM

FIG. 133D—MSTUS with DEM, using multiple train, with one set of non-circular gears for multiple ratios with axial Linking Mechanism between driving shaft and DEM driving shaft with DEM, using multiple train, with one set of non-circular gears for multiple ratios with Linking Mechanism axially linking speed reduction gear to DEM

FIG. 134A—MSTUS with DEM without Linking Mechanism, using multiple train, with multiple set of non-circular gears for multiple ratios

FIG. 134B—MSTUS with DEM, using multiple train, with multiple set of non-circular gears for multiple ratios with axial Linking Mechanism between driving shaft and DEM driving shaft

FIG. 134C—MSTUS with DEM, using multiple train, with multiple set of non-circular gears for multiple ratios with Linking Mechanism axially linking speed reduction gear to DEM

FIG. 134D—MSTUS with DEM, using multiple train, with multiple set of non-circular gears for multiple ratios with axial Linking Mechanism between driving shaft and DEM driving shaft, using multiple train, with multiple set of non-circular gears for multiple ratios with Linking Mechanism axially linking speed reduction gear to DEM

FIG. 135 DEM with two noncircular sprockets

FIG. 136 DEM with one noncircular sprocket and circular sprocket

FIG. 137A MSTUS with DEM without Linking Mechanism, using transmission gears as speed reduction gears, with one set of non-circular gears for each pair of ratios

FIG. 137B MSTUS with DEM, using transmission gears as speed reduction gears, with one set of non-circular gears for each pair of ratios with axial Linking Mechanism between driving shaft and DEM driving shaft

FIG. 137C MSTUS with DEM, using transmission gears as speed reduction gears, with one set of non-circular gears for each pair of ratios with Linking Mechanism axially linking speed reduction gear to DEM

FIG. 137D MSTUS with DEM, using transmission gears as speed reduction gears, with one set of non-circular gears for each pair of ratios with axial Linking Mechanism between driving shaft and DEM driving shaft, using transmission gears as speed reduction gears, with one set of non-circular gears for each pair of ratios with Linking Mechanism axially linking speed reduction gear to DEM

FIG. 138A MSTUS with DEM without linking mechanism using a separate DEM speed reduction gear and using a non-circular sprocket

FIG. 138B MSTUS with DEM, using a separate DEM speed reduction gear and using a non-circular sprocket with axial Linking Mechanism between driving shaft and DEM driving shaft

FIG. 138C MSTUS with DEM, using a separate DEM speed reduction gear and using a non-circular sprocket with Linking Mechanism axially linking speed reduction gear to DEM

FIG. 138D MSTUS with DEM, using a separate DEM speed reduction gear and using a non-circular sprocket with axial Linking Mechanism between driving shaft and DEM driving shaft using separate DEM speed reduction gears and using a non-circular sprocket with Linking Mechanism axially linking speed reduction gear to DEM

FIG. 139A MSTUS with transmission gears for multiple level DEM and a non-circular gear pair

FIG. 139B MSTUS with transmission gears for multiple level DEM and a non-circular gear pairs with axial Linking Mechanism between driving shaft and DEM driving shaft

FIG. 139C MSTUS with transmission gears for multiple level DEM and a non-circular gear pairs with Linking Mechanism axially linking speed reduction gear to DEM

FIG. 139D MSTUS with transmission gears for multiple level DEM and a non-circular gear pairs with axial Linking Mechanism between driving shaft and DEM driving shaft with transmission gears for multiple level DEM and a non-circular gear pairs with Linking Mechanism axially linking speed reduction gear to DEM

FIG. 140A MSTUS with DEM without linking mechanism, using transmission gears as speed reduction gears, with one set of non-circular sprockets and one set of circular sprockets for each pair of ratios.

FIG. 140B MSTUS with DEM, using transmission gears as speed reduction gears, with one set of non-circular sprockets and one set of circular sprockets for each pair of ratios with axial Linking Mechanism between driving shaft and DEM driving shaft

FIG. 140C MSTUS with DEM, using transmission gears as speed reduction gears, with one set of non-circular sprockets and one set of circular sprockets for each pair of ratios with Linking Mechanism axially linking speed reduction gear to DEM

FIG. 140D MSTUS with DEM, using transmission gears as speed reduction gears, with one set of non-circular sprockets and one set of circular sprockets for each pair of ratios with axial Linking Mechanism between driving shaft and DEM driving shaft with DEM, using transmission gears as speed reduction gears, with one set of non-circular sprockets and one set of circular sprockets for each pair of ratios with Linking Mechanism axially linking speed reduction gear to DEM

FIG. 141A MSTUS with DEM without Linking Mechanism, using transmission gears as speed reduction gears, with one set of non-circular sprockets and one set of circular sprockets for each pair of ratios

FIG. 141B MSTUS with DEM, using transmission gears as speed reduction gears, with one set of non-circular sprockets and one set of circular sprockets for each pair of ratios with axial Linking Mechanism between driving shaft and DEM driving shaft

FIG. 141C MSTUS with DEM, using transmission gears as speed reduction gears, with one set of non-circular sprockets and one set of circular sprockets for each pair of ratios with Linking Mechanism axially linking speed reduction gear to DEM

FIG. 141D MSTUS with DEM, using transmission gears as speed reduction gears, with one set of non-circular sprockets and one set of circular sprockets for each pair of ratios with axial Linking Mechanism between driving shaft and DEM driving shaft, using transmission gears as speed reduction gears, with one set of non-circular sprockets and one set of circular sprockets for each pair of ratios with Linking Mechanism axially linking speed reduction gear to DEM

FIG. 142A All belts MSTUS with DEM without Linking Mechanism, using transmission gears as speed reduction gears, with one set of non-circular sprockets and one set of circular sprockets for each pair of ratios

FIG. 142B—All belts MSTUS with DEM, using transmission gears as speed reduction gears, with one set of non-circular sprockets and one set of circular sprockets for each pair of ratios with Linking Mechanism axially linking speed reduction gear to DEM

FIG. 142C—All belts MSTUS with DEM, using transmission gears as speed reduction gears, with one set of non-circular sprockets and one set of circular sprockets for each pair of ratios with axial Linking Mechanism between driving shaft and DEM driving shaft

FIG. 142D—All belts MSTUS with DEM, using transmission gears as speed reduction gears, with one set of non-circular sprockets and one set of circular sprockets for each pair of ratios with axial Linking Mechanism between driving shaft and DEM driving shaft, using transmission gears as speed reduction sprockets, with one set of non-circular sprockets and one set of circular sprockets for each pair of ratios with Linking Mechanism axially linking speed reduction gear to DEM

FIG. 143A MSTUS with DEM without Linking Mechanism, using transmission sprockets as speed reduction gears, with one set of non-circular sprockets and one set of circular sprockets for each pair of ratios

FIG. 143B MSTUS with DEM, using transmission sprockets as speed reduction gears, with one set of non-circular sprockets and one set of circular sprockets for each pair of ratios with axial Linking Mechanism between driving shaft and DEM driving shaft

FIG. 143C MSTUS with DEM, using transmission sprockets as speed reduction gears, with one set of non-circular sprockets and one set of circular sprockets for each pair of ratios with Linking Mechanism axially linking speed reduction gear to DEM

FIG. 143D MSTUS with DEM, using transmission sprockets as speed reduction gears, with one set of non-circular sprockets and one set of circular sprockets for each pair of ratios with axial Linking Mechanism between driving shaft and DEM driving shaft, using transmission sprockets as speed reduction gears, with one set of non-circular sprockets and one set of circular sprockets for each pair of ratios with Linking Mechanism axially linking speed reduction gear to DEM

FIG. 144A MSTUS with DEM without Linking Mechanism, using transmission sprockets as speed reduction gears, with one set of non-circular gears and one set of circular gears for each pair of ratios

FIG. 144B MSTUS with DEM, using transmission sprockets as speed reduction gears, with one set of non-circular gears and one set of circular gears for each pair of ratios with axial Linking Mechanism between driving shaft and DEM driving shaft

FIG. 144C MSTUS with DEM, using transmission sprockets as speed reduction gears, with one set of non-circular gears and one set of circular gears for each pair of ratios with Linking Mechanism axially linking speed reduction gear to DEM

FIG. 144D MSTUS with DEM, using transmission sprockets as speed reduction gears, with one set of non-circular gears and one set of circular gears for each pair of ratios with axial Linking Mechanism between driving shaft and DEM driving shaft, using transmission sprockets as speed reduction gears, with one set of non-circular gears and one set of circular gears for each pair of ratios with Linking Mechanism axially linking speed reduction gear to DEM

FIG. 145A MSTUS for a sprocket transmission using circular and non-circular gears

FIG. 145B MSTUS for a sprocket transmission using circular and non-circular gears with axial Linking Mechanism between driving shaft and DEM driving shaft

FIG. 145C MSTUS for a sprocket transmission using circular and non-circular gears with Linking Mechanism axially linking speed reduction gear to DEM

FIG. 145D MSTUS for a sprocket transmission using circular and non-circular gears with axial Linking Mechanism between driving shaft and DEM driving shaft using circular and non-circular gears with Linking Mechanism axially linking speed reduction gear to DEM

FIG. 146A MSTUS for a sprocket transmission with circular and non-circular sprockets

FIG. 146B MSTUS for a sprocket transmission with circular and non-circular sprockets with axial Linking Mechanism between driving shaft and DEM driving shaft

FIG. 146C MSTUS for a sprocket transmission with circular and non-circular sprockets with Linking Mechanism axially linking speed reduction gear to DEM

FIG. 146D MSTUS for a sprocket transmission with circular and non-circular sprockets with axial Linking Mechanism between driving shaft and DEM driving shaft with circular and non-circular sprockets with Linking Mechanism axially linking speed reduction gear to DEM

FIG. 147A MSTUS for a gear transmission using circular sprocket and non-circular gears

FIG. 147B MSTUS for a gear transmission using circular sprocket and non-circular gears with axial Linking Mechanism between driving shaft and DEM driving shaft

FIG. 147C MSTUS for a gear transmission using circular sprocket and non-circular gears with Linking Mechanism axially linking speed reduction gear to DEM

FIG. 147D MSTUS for a gear transmission using circular sprocket and non-circular gears with axial Linking Mechanism between driving shaft and DEM driving shaft using circular sprocket and non-circular gears with Linking Mechanism axially linking speed reduction gear to DEM

FIG. 148A MSTUS with DEM without Linking Mechanism, using a set of speed reduction gears, with one set of non-circular gears for each pair of ratios

FIG. 148B MSTUS with DEM, using a set of speed reduction gears, with one set of non-circular gears for each pair of ratios with axial Linking Mechanism between driving shaft and DEM driving shaft

FIG. 148C MSTUS with DEM, using a set of speed reduction gears, with one set of non-circular gears for each pair of ratios with Linking Mechanism axially linking speed reduction gear to DEM

FIG. 148D MSTUS with DEM, using a set of speed reduction gears, with one set of non-circular gears for each pair of ratios with axial Linking Mechanism between driving shaft and DEM driving shaft, using a set of speed reduction gears, with one set of non-circular gears for each pair of ratios with Linking Mechanism axially linking speed reduction gear to DEM

### DETAILED DESCRIPTION OF THE INVENTION

### List of Components

1) Shaft for small driving gear
2) Shaft for small driven gear
3) Fixed small driving gear
4) Fixed small driven gear 4
5) Driving large gear segment
6) Driven large gear segment
7) Driving transition gear segment
8) Driven transition gear segment
9) Segment guide
10) Spring
11) Roller
12) Stopper
13) Smaller driving gear (shaftless)
14) Driving transition gear (crescent) with smaller driving gear 13 profile on the interior
15) Larger driving gear with smaller driving gear 13 profile on the interior with a pocket for transition gear
16) Smaller driven gear (shaftless)
17) Driven transition gear (crescent) with smaller driving gear 13 profile on the interior
18) Larger driven gear with smaller driving gear 13 profile on the interior with a pocket for transition gear
19) Driving non-circular shaft
20) Driven non-circular shaft
21) Driving transition gear fixed with non-circular orifice matching driving non-circular shaft
22) Driven transition gear segmented (full) with non-circular orifice matching driven non-circular shaft
23) Driving small gear fixed with non-circular orifice matching driving non-circular shaft
24) Driven small gear segmented (full) with non-circular orifice matching driven non-circular shaft
25) Driven large gear segmented (full) with non-circular orifice matching driven non-circular shaft
26) Driving large gear fixed with non-circular orifice matching driving non-circular shaft
27) Driving small gear rigidly fixed to driven shaft
28) Driving transition gear with a void zone rigidly fixed to driven shaft
29) Driving large gear rigidly fixed to driven shaft with a pocket for driven transition gear
30) Driven small gear segmented full allowing axial movement driving shaft
31) Driven transition gear placed on a tubular shaft with a void zone rotationally locked allowing axial movement on driving shaft
32) Driven large gear segmented full allowing axial movement with a pocket for driving transition gear on driving shaft
33) Driving transition gear non-segmented with void zone with clearance hole for transition gear on the interior
34) Driving transition gear non-segmented with void zone with clearance hole for transition gear on the interior
35) Driving large gear with a pocket for driving transition gear, rigidly fixed
36) Driven large gear with a pocket for driven transition gear, rigidly fixed
37) Driving small gear segmented (full)
38) Driven small gear segmented (full)
39) Driving or driven full transition gear
40) First driving or driven transition gear with one zone
41) Second driving or driven transition gear with one zone
42) First driving or driven transition gear with two zones
43) Second driving or driven transition gear with two zones
44) First driving or driven transition gear with three zones
45) Second driving or driven transition gear with three zones
46) Flanged tubular telescopic non-circular shaft for gear segments inner
47) Flanged tubular telescopic non-circular shaft for gear segments small intermediate
48) Flanged tubular telescopic non-circular shaft for gear segments large intermediate
49) Flanged tubular telescopic non-circular shaft for gear segments outer
50) One-way bearing
51) Torsion spring
52) Train of gears
53) Dog clutch
54) Angular position sensor
55) Small driving gear
56) Large driving gear
57) Small driven gear
58) Large driven gear
59) Duration extender module driving non-circular gear
60) Duration extender module driven non-circular gear
61) Duration extender module driving circular gear
62) Duration extender module driven circular gear
63) Driving circular gear
64) Drive shaft
65) Freewheeling conjugate driven gears
66) Double DEM driving circular gear
67) Intermediate shaft
68) Segmented Freewheeling Double DEM driven gear
69) Freewheeling DEM driving non-circular gear
70) Output shaft
71) Freewheeling DEM driven non-circular gear
72) Freewheeling DEM driving circular ring gear
73) DEM intermediate circular planet gear
74) Driving final output gear
75) Driven final output gear
76) Double DEM driving sprocket
77) Double DEM driving chain
78) Double DEM driven sprocket
79) DEM driving Geneva pin wheel with retractable pins
80) Geneva shaft
81) DEM driven Geneva slot wheel
82) DEM uninterrupted shifting wheel
83) Double DEM driven gear
84) Retractable pins
85) Partial driving gear
86) Partial driven gear
87) NO DEM driving and driven gear sub assembly
88) NO DEM Geneva slot and pin wheel sub assembly
89) Spiral fluted collar
90) Stepper motor
91) Scotch yoke Input frame
92) Ratio modifier frame
93) Scotch yoke rectifier frame
94) Output frame
95) Ratio plate
96) Geneva slot wheel mechanism pin wheel
97) Geneva slot wheel mechanism slot wheel
98) Non-functional region partial driving gear
99) Non-functional region partial driven gear
100) Input shaft
101) Crank pin
102) Input disk
103) Slotted Rack holder
104) Rack
105) Dummy Rack
106) Pinion
107) Pinion shaft
108) Collar
109) Link
110) Dummy link
111) Input shaft bearing
112) Input-Disk bearing
113) Thrust bearing
114) One-way bearing/Computer-Controlled-Clutch/Ratchet-mechanism
115) Crank pin shaft
116) Dummy Crank pin
117) Non-functional region driving gear
118) Non-functional region driven gear
119) Crank pin to link pivot pin
120) Collar to link pivot pin
121) Power shaft
122) Planetary gear
123) Miter/Bevel Gear Differential input shaft
124) Miter/Bevel Gear Differential output shaft
125) Miter/Bevel gear
126) Rack velocity profile
127) Clutch-Park/Neutral/Reverse clutch/dog clutch
128) Stationary sun gear
129) Cam shaft
130) Cam gear
131) Driving circular or non-circular gear
132) Driven circular or non-circular gear
133) Cam input shaft
134) Planet gear
135) Stationary sun gear
136) Stationary ring gear.
137) Carrier shaft
138) Bearing
139) Chain/Belt
140) Driven circular gear
141) Driven non-circular gear
142) Driven shaft
143) Driving non-circular gear
144) Driving shaft
145) Duration Extender Module driven non-circular sprocket
146) Duration Extender Module driven sprocket
147) Duration Extender Module driving non-circular sprocket
148) Duration Extender Module driving sprocket
149) Duration Extender Module intermediate shaft
150) Base operating plane gear
151) Gear segment
152) Gear segment guide
153) Linking Mechanism
154) Protrusion
155) Base operating plane sprocket
156) Sprocket segment
157) Tensioner/Idler
158) Transition gear
159) Transition sprocket
160) Transmission driven gears
161) Transmission driving gears
162) Transmission driving sprocket
163) Sprocket segment guide
164) Transmission driven sprocket
165) DEM Driven Gear
166) Speed Reduction Gear
167) Speed Reduction Gear train
168) Rotationally fixed axially movable spiral ramp/cam
169) Duration Extender Module Speed Reduction Gears/OPTIONAL Ratio A Gears
170) Tensioner Sprocket

All the gears in the component list can be replaced with a sprocket and chain system. The non-circular gear system can be replaced with a sprocket and chain system where at least one of the sprockets is non-circular.

I) Utilizing Gears and Sprockets (Circular and Non-Circular) to Achieve Multi-Speed Transmission with Uninterrupted Shifting (MSTUS) (FIG. 118-148)

Here the shifting is achieved by swapping to the operating plane between larger and smaller gears for the different ratios and non-circular gears moving to operating plane or extending Geneva pin to the Geneva slot to transition between them.

Similarly, with driving and driven sets of gears, two smallest size full gears are placed co-planer at a fixed center to center distance. Segments forming full larger size gears are placed co-axial but offset to the full-size gears. These spring-loaded segments of larger gears can be moved in and out of operating plane to achieve several input-to-output ratios.

Similarly, Cage pins/Geneva pins also can be used in place of segments of sprockets/gears to work with cycloidal disk/Geneva wheel.

Also, when segmentation of the gears is not desired, smooth uninterrupted shifting of gears can also be achieved by mounting all the driving gears (along with non-circular gears) on one shaft, namely drive shaft, and all the driven gears (along with non-circular gears) placed freewheeling on another shaft, namely Driven Shaft 142. The non-circular gear pairs (driving and driven) have regions where two or more constant ratios are preceded and followed by acceleration and deceleration regions. The constant regions have the same ratios of the circular gear pairs. The ramp up and/or ramp down regions connect one ratio to the next smaller or next larger ratio, as appropriate. The Driven Shaft 142 is linked with appropriate driven gear(s). When shifting from one ratio to another ratio it is sequenced via the non-circular gear pair that has the ratio of the region of exiting ratio and the ratio that is transitioned to.

FIG. 118 which is prior art, shows MSTUS using base operating plane sprockets 150, segmented sprockets 155, sprocket segment 156, transition sprocket 159, Sprocket Segment Guide 163 and tensioner/idler 157.

Achieving MSTUS with gears (FIG. 119):

With driving and driven sets of several pairs of gears, two smallest size full gears are placed co-planer at a fixed center to center distance. Spring loaded segments forming full larger size gears are placed co-axial but offset to the full-size gears or base operating plane gears 150. These spring-loaded segments of larger gears can be moved in and out of operating plane to achieve several input to output ratios.

A pair of driving and driven gear/Gear Segments 151 are selected so that the center-to-center distance which is the sum of the radii of the driving and driven pairs is constant. If the driving or driven gear is to be changed from smaller to larger size, then the larger Gear Segments 151 are slipped into the operating plane for one gear, and the larger Gear Segments 151 are slipped out of the operating plane for the other gear so that two gears can mesh with each other. The offset planes of segments of gears of driving and driven sets are so placed so that the largest gears of both sets do not interfere with each other. This can be achieved by placing the segment of large gears are placed on either side of the gears are slipped in and out on a protrusion 154 of the base operating plane gear 150 using a roller 11 and gear segment guide 152, in the regions where driving and driven gears are not in contact 1003 and 1004. In order for the teeth of the driving and driven gears to mesh exactly, the gears may have to be rotated to a certain correct position. This can be achieved using rotationally fixed axially movable spiral ramp/cam 168 or position sensors with computer-controlled solenoids.

Similarly, for achieving with Geneva pin wheel 96 and slot wheel 97 OR non-circular pin gear mechanism (FIG. 120):

Pins placed in a circular and also non-circular pattern on several circumferences are placed on Geneva wheel to mesh with several Geneva slot wheels 97, where matching Geneva slot wheels 97 are placed co-axial at an offset distance respective to their sizes. The pins are retracted and extended just to meet with the respective Geneva wheel from the side facing the smallest Geneva slot wheel 97. This is done to avoid interference of pins on larger circumference with larger Geneva slot wheel 97. The pins are extended only during when the pins are in contact with the slot in the region where the pin and wheel are in contact. When the pins are not in contact with the slot, the pins are retracted in that region. Also, the slot can ramp up when the pin and slot engagement region at the near end such that the pins are pushed out to the retracted position.

Also, when segmentation of the gears is not desired, new mechanisms that is patented, and existing technologies are shown in FIG. 121 and FIG. 122

FIG. 123A shows a prior art 1010 Smooth uninterrupted shifting of gears can also be achieved by mounting all the driving gears (including non-circular gears) on one shaft, namely the drive shaft, and all the driven gears (including non-circular gears) placed freewheeling on another shaft, namely the Driven Shaft 142. The largest Driven-Circular-Gear is optionally placed on a One-way bearing 50 50 or sprag or computer-controlled clutch, on the Driven Shaft 142. When placed on a One-way bearing 50 50 or sprag it loses the ability of engine braking al lowest speed. However, by also adding the ability to link to the drive shaft, a dog clutch, offers the ability to engine brake. Optionally the Driven-Non-Circular-Gear can also be mounted with One-way bearing 50 50 or sprag. The non-circular gear pairs (driving and driven) have regions where two or more constant ratios are preceded and followed by acceleration and deceleration regions. The constant regions have the same ratios of the circular gear pairs. The ramp up and/or ramp down regions connect one ratio to the next smaller or next larger ratio, as appropriate. The Driven Shaft 142 is linked with appropriate/desired driven gear(s). When shifting from the existing ratio to next higher or lower ratio it is sequenced via the non-circular gear pair that has the region with the exiting ratio and the region with the ratio that is transitioned to. The main advantage here is the continuous engagement of gears during the transitions. By adding a Linking Mechanism 153 to the Driving shaft 144, the rotation of non-circular gears can be limited to the duration of ratio change sequence to eliminate vibration as shown in FIG. 123B

The sequence of operation is as follows:

For upshift (FIG. 128)

a) With the Driven Shaft 142 linked to the existing driven gear,

b) when the non-circular gear, which has the constant region of the existing ratio followed by ramp up region to the region of the next higher ratio, reaches and well within the active region the current circular gear's ratio of the non-circular gear ratio is also linked to the Driven Shaft 142.

c) Once both the speed of the non-circular gear and the current circular gear are synchronized the circular gear is disengaged from the Driven Shaft 142.

d) As the ratio of the non-circular gear passes through the ramp up region to the next higher ratio, the driven gear with the larger ratio is also engaged to the Driven Shaft 142. This can be achieved with a One-way bearing 50 50 used at the driven gear of the larger ratio

e) When the ratio of the non-circular gear is synchronized with the active circular gears the Driven-Non-Circular-Gear is disengaged.

Similarly, for down shift (FIG. 129)

a) With the Driven Shaft 142 linked to the existing driven gear,

b) when the non-circular gear, which has the constant region of the existing ratio followed by ramp down region to the region of the next lower ratio, reaches and well within the active region the current circular gear's ratio of the non-circular gear ratio is also linked to the Driven Shaft 142.

c) Once both the speed of the non-circular gear and the current circular gear are synchronized the circular gear is disengaged from the Driven Shaft 142.

d) As the ratio of the non-circular gear passes through the ramp down region to the next lower ratio, the driven gear with the larger ratio is also engaged to the Driven Shaft 142. This can be achieved with a One-way bearing 50 50 used at the driven gear of the larger ratio e) When the ratio of the non-circular gears is synchronized with the active circular gears the Driven-Non-Circular-Gear is disengaged.

During normal operation when upshift or downshift are in action the Driving-Non-Circular-Gears are disengaged from the shaft it is mounted and remain stationary.

The engagement and disengagement can be achieved via a dog clutch or dry or wet clutch or any other suitable technology currently available in the industry

The non-circular gear pairs may have multiple constant regions with or without ramp (abrupt) ascending or descending

The non-circular gear pairs may have multiple constant regions ascending followed by ascending or descending and/or descending followed by ascending or descending in any desired movement path.

The non-circular gear pairs can be designed to have any desired movement function between driven to driving

The pair of noncircular gears can be sandwiched between circular gears. This will allow manual gear shifting possible without the need for a computer-controlled shifting.

In the above scenario one potential issue is that since the non-circular gears spin with the same angular velocity as the Driving shaft 144, the duration of each lower and higher region and the ramp region 1015 is short. So, it is not ideal for high-speed application. It is beneficial if the duration of each of these regions is increased. This can be achieved by a ‘Duration Extender Module’ 1001.

The Duration Extender Module 1001 has one or more pairs of speed reduction gears, a pair of non-circular gears, and one or more sets of pairs of Duration Extender Module driving gears 61 and Duration Extender Module (DEM) Driven Gears 165 arranged as shown in FIG. 124A. By adding a Linking Mechanism 153 to the Driving shaft 144, the rotation of gears in Duration

Extension Module can be limited to the duration of ratio change sequence to eliminate vibration as shown in FIG. 124B (linking Driving shaft 144 to Driving Speed Reduction Gear 166), 7C (axially linking Duration Extender Module Driving-Non-Circular-Gear to Driven speed reduction gear 167) and 7D (linking Driving shaft 144 to Driving Speed Reduction Gear 166 and axially linking Duration Extender Module to Driven speed reduction gear 167 167)

The Driving Non-Circular Gear 143 is axially connected to the large driven gear of a pair of speed reduction gears. The smaller Driving-Circular-Gear of the speed reduction gears is rigidly mounted to the Driving shaft 144 and the larger driven gear of the speed reduction gears is axially connected to the Driving-Non-Circular-Gear with an ability to engage/disengage via a Linking Mechanism 153. This extends the duration of lower and higher regions and the ramp region 1015 of the non-circular gears. The Driven-Non-Circular-Gear is mounted on a parallel shaft or on the Driving shaft 144 on a bearing 138. Several circular Duration Extender Module Driving Gear 61s, axially connected to the Driven-Non-Circular-Gear, are meshed to the corresponding circular Duration Extender Module Driven Gears 165 mounted on the Driven Shaft 142 that have the ability to engage or disengage with the Driven Shaft 142. The sizes of these circular Duration Extender Module gears are selected so that the angular velocities of the driven gears match the final angular velocities of the transmission. The low and high constant angular velocities of the non-circular gears is selected such that the angular velocities of the Duration Extender Module Driven Gears 165 are equal to the angular velocities of the Transmission Driven Gears 160. If the ratios of angular velocities of successive Transmission Driven Gears 160 are not identical, then multiple Duration Extender Modules 1001 will be needed.

While it is convenient to place the Driven-Non-Circular-Gear along with the Duration Extender Module Driving Gear 61s on the Driving shaft 144, it can be placed on a separate shaft parallel to the Driving shaft 144. And similarly, while it is convenient to place the Driving-Non-Circular-Gears along with the larger speed reduction gear on the Driven Shaft 142 it can be placed on a separate shaft parallel to the Driving shaft 144 or Driven Shaft 142.

Using multiple stages of reductions as shown in FIG. 125A can increase the duration required for the shifting process. In both the cases only one set of non-circular gear is used. By adding a Linking Mechanism 153 to the Driving shaft 144, the rotation of gears in Duration Extension Module can be limited to the duration of ratio change sequence to eliminate vibration as shown in FIG. 125B, (linking Driving shaft 144 to Driving speed reduction gear 166), 8C (axially linking Duration Extender Module Driving-Non-Circular-Gear to Driven speed reduction gear 167 167) and 8D (linking Driving shaft 144 to Driving speed reduction gear 166 and axially linking Duration Extender Module Driving-Non-Circular-Gear to Driven speed reduction gear 167)

It is also possible to use one of the pair of gears of transmission gears as the Duration Extender Module Driving Gear 61 and Duration Extender Module driven gear. It will be beneficial to have the smallest driving gear pairing with the largest driven gear to use as the Duration Extender driving gears and Duration Extender Module Driven Gears 165. That is the smallest driving gear pairing with the largest driven gear has the dual purpose of being a transmission gear and the Duration Extender driving gears and Duration Extender Module Driven Gears 62.

This concept is shown in FIG. 126A where one of the, preferably the one with the largest driven gear, is used as the speed reduction gear also and the original speed reduction gears are eliminated. Here only one pair of non-circular gears are used. This will work only if the Ratio A/Ratio B, Ratio B/Ratio C, Ratio C/Ratio D-(so on) is the same. By adding a Linking Mechanism 153 to the Driving shaft 144, the rotation of gears in Duration Extension Module can be limited to the duration of ratio change sequence to eliminate vibration as shown in FIG. 126B (linking Driving shaft 144 to Driving Ratio A Gear), 9C (axially linking Duration Extender Module Driving-Non-Circular-Gear to Driven speed reduction gear 167) and 9D (linking Driving shaft 144 to Driving Ratio A Gear and axially linking Duration Extender Module Driving-Non-Circular-Gear to Driven speed reduction gear 167)

In configuration shown in FIG. 127A the Driving-Non-Circular-Gear and the Driving-Non-Circular-Gears are interchanged and multiple non-circular gears are used. This eliminates the need for the Ratio A/Ratio B, Ratio B/Ratio C, Ratio C/Ratio D-(so on) to be the same. By adding a Linking Mechanism 153 to the Driving shaft 144, the rotation of gears in Duration Extension Module can be limited to the duration of ratio change sequence to eliminate vibration as shown in FIG. 127B (linking Driving shaft 144 to Driving Ratio A Gear), 10C (axially linking Duration Extender Module Driving-Non-Circular-Gear to Driven speed reduction gear 167) and 10D (linking Driving shaft 144 to Driving Ratio A Gear and axially linking Duration Extender Module Driving-Non-Circular-Gear to Driven speed reduction gear 167)

The configuration shown in FIG. 130A is when only two ratios are used, and multiple stages of reduction is desired. By adding a Linking Mechanism 153 to the Driving shaft 144, the rotation of gears in Duration Extension Module can be limited to the duration of ratio change sequence to eliminate vibration as shown in FIG. 130B (linking Intermediate Driven Shaft 142 to Driving Ratio A Gear), 13C (axially linking Duration Extender Module Driving-Non-Circular-Gear to Driven speed reduction gear 167) and 13D (linking Intermediate Driven Shaft 142 to Driving

Ratio A Gear and axially linking Duration Extender Module Driving-Non-Circular-Gear to Driven speed reduction gear 167) The configuration shown in FIG. 131A is multiple stages of reduction is desired and when one of the transmission gears is also used as one of the speed reduction gears allowing reduction in number of gear pairs. By adding a Linking Mechanism 153 to the Driving shaft 144, the rotation of gears in Duration Extension Module can be limited to the duration of ratio change sequence to eliminate vibration as shown in FIG. 131B (linking Intermediate Driven Shaft 142 to Driving Ratio A Gear), 14C (axially linking Duration Extender Module Driving-Non-Circular-Gear to Driven speed reduction gear 167) and 14D (linking Intermediate Driven Shaft 142 to Driving Ratio A Gear and axially linking Duration Extender Module Driving-Non-Circular-Gear to Driven speed reduction gear 167)

The configuration shown in FIG. 132A when multiple ratios are used, and multiple speed reduction is desired. By adding a Linking Mechanism 153 to the Driving shaft 144, the rotation of gears in Duration Extension Module can be limited to the duration of ratio change sequence to eliminate vibration as shown in FIG. 132B (linking Intermediate Driven Shaft 142 to Driving Ratio A Gear), 15C (axially linking Duration Extender Module Driving-Non-Circular-Gear to Driven speed reduction gear 167) and 15D (linking Intermediate Driven Shaft 142 to Driving Ratio A Gear and axially linking Duration Extender Module Driving-Non-Circular-Gear to Driven speed reduction gear 167)

The configuration in FIG. 133A shows where Duration Extender Modules 1001 Driving gears are placed on a Duration Extender Module Intermediate Shaft 149 instead on the Driving shaft 144. This configuration allows to use a different center to center distance for the transmission gears and non-circular gears. Again, here Ratio A/Ratio B, Ratio B/Ratio C, Ratio C/RatioD-(so on) must be same. By adding a Linking Mechanism 153 to the Driving shaft 144, the rotation of gears in Duration Extension Module can be limited to the duration of ratio change sequence to eliminate vibration as shown in FIG. 133B (linking Driving shaft 144 to Driving Ratio A Gear), 16C (axially linking Duration Extender Module Driving-Non-Circular-Gear to Driven speed reduction gear 167) and 16D (linking Driving shaft 144 to Driving Ratio A Gear and axially linking Duration Extender Module Driving-Non-Circular-Gear to Driven speed reduction gear 167)

The configuration in FIG. 134A allows where multiple non-circular pairs are used when Ratio A/Ratio B, Ratio B/Ratio C, Ratio C/Ratio D-(so on) is NOT the same. By adding a Linking Mechanism 153 to the Driving shaft 144, the rotation of gears in Duration Extension Module can be limited to the duration of ratio change sequence to eliminate vibration as shown in FIG. 134B (linking Driving shaft 144 to Driving Ratio A Gear), 17C (axially linking Duration Extender Module Driving-Non-Circular-Gear to Driven speed reduction gear 167) and 17D (linking Driving shaft 144 to Driving Ratio A Gear and axially linking Duration Extender Module Driving-Non-Circular-Gear to Driven speed reduction gear 167)

By using a multi radii/non-circular sprocket, as shown in FIG. 135, instead of non-circular gear, the same results can be achieved. A tensioner/idler sprocket can be used to eliminate the slack in the Chain/Belt 139 when the working region switches between larger and smaller pitch radii. In this configuration the driven sprocket can also be circular as shown in FIG. 136, to achieve the same results. It is also possible to have circular sprocket for the driving sprocket and non-circular sprocket for the driven sprocket. The sprocket can be also replaced with a ring gear and the Planet gear 134 to get the same result. The circular gear also can be replaced with bevel gears and appropriately placed shafts will get the same results.

By using various combinations of sprockets and gear there are many ways to achieve uninterrupted shifting.

Following are a few of different scenarios using different combinations of gears and sprockets

FIG. 137A uses all circular gears for transmission and circular gears and non-circular gears for Duration Extender Module 1001 and Driven-Circular-Gear linked to the Driven Shaft 142. By adding a Linking Mechanism 153 to the Driving shaft 144, the rotation of gears in Duration Extension Module can be limited to the duration of ratio change sequence to eliminate vibration as shown in FIG. 137B (linking Driving shaft 144 to Driving Ratio A Gear), 20C (axially linking Duration Extender Module Driving-Non-Circular-Gear to Driven speed reduction gear 167) and 20D (linking Driving shaft 144 to Driving Ratio A Gear and axially linking Duration Extender Module Driving-Non-Circular-Gear to Driven speed reduction gear 167)

A set of circular Transmission Driving Gears 161 varying in size are rigidly mounted on a Driving shaft 144. A set of matching circular Transmission Driven Gears 160 freewheeling on a Driven Shaft 142 with its axis placed parallel to the axis of the Driving shaft 144, with the ability to engage or disengage to any specific circular Transmission Driven Gears 160 using dog clutch or similar devices. One or more Duration Extender Module 1001 comprising a Duration Extender Module Driving Non-Circular Gear 59 axially connected to one of the Transmission Driven Gears 160, mounted on the Driven Shaft 142 or a larger driven gear of a pair of speed reduction circular gears mounted on the Driven Shaft 142 or on a Duration Extender Module Intermediate Driving shaft 144 parallel to the Driving shaft 144 driven by a smaller Driving-Non-Circular-Gear of the pair of speed reduction gears, with a Linking Mechanism 153 to engage/disengage, is mounted on the Driving shaft 144 a Duration Extender Module Driven Non-Circular Gear 60, meshing with the Duration Extender Module Driving Non-Circular gear 59, is mounted freewheeling on the Driving shaft 144 or on a Duration Extender Intermediate Driven Shaft 142 parallel to Driving shaft 144, one or more Duration Extender Module Driving Circular Gears 61 axially connected to the Duration Extender Module Driven Non-Circular Gear 60, and meshed to the corresponding Duration Extender Module Driven Circular Gears 62 mounted on the Driven Shaft 142, with the ability to engage or disengage with the Driven Shaft 142.

FIG. 138A uses all circular gears for transmission and circular gears and non-circular sprockets for Duration Extender Module 1001 and driven circular or non-circular sprocket linked to the Driven Shaft 142. By adding a Linking Mechanism 153 to the Driving shaft 144, the rotation of gears in Duration Extension Module can be limited to the duration of ratio change sequence to eliminate vibration as shown in FIG. 138B (linking Driving shaft 144 to Driving Ratio A Gear), 21C (axially linking Duration Extender Module Driving Non-Circular-Sprocket to Driven Speed Reduction Gear) and 10D (linking Driving shaft 144 to Driving Ratio A Gear and axially linking Duration Extender Module Driving Non-Circular-Sprocket to Driven Speed Reduction Gear)

A set of circular Transmission Driving Gears 161 varying in size are rigidly mounted on a Driving shaft 144, a set of matching circular Transmission Driven Gears 160 freewheeling on a Driven Shaft 142 with its axis placed parallel to the axis of the Driving shaft 144, with the ability to engage or disengage to any specific circular Transmission Driven Gears 160, One or more Duration Extender Module 1001 comprising a Duration Extender Driving Circular Gear 61 mounted on the Driving shaft 144, is meshed with Duration Extender Driven Circular Gear 62 mounted on a Duration Extender Module Intermediate Driving shaft 144 and which is axially connected to a Duration Extender Module Driving Non-Circular Sprocket 147 having two or more constant radii pitch circle with teeth uniformly spaced that is linked with a Duration Extender Module Driven Non-Circular Sprocket 147 mounted on the Driven Shaft 142.

FIG. 139A uses all circular gears for transmission and circular gears and non-circular gears for Duration Extender Module 1001 and Driven-Non-Circular-Gear linked to the Driven Shaft 142. By adding a Linking Mechanism 153 to the Driving shaft 144, the rotation of gears in Duration Extension Module can be limited to the duration of ratio change sequence to eliminate vibration as shown in FIG. 139B (linking Driving shaft 144 to Driving Ratio A Gear), 22C (axially linking Duration Extender Module Driving-Non-Circular-Gear to Driven speed reduction gear 167) and 22D (linking Driving shaft 144 to Driving Ratio A Gear and axially linking Duration Extender Module Driving-Non-Circular-Gear to Driven speed reduction gear 167)

A set of circular Transmission Driving Gears 161 varying in size are rigidly mounted on a Driving shaft 144. A set of matching circular Transmission Driven Gears 160 freewheeling on a Driven Shaft 142 with its axis placed parallel to the axis of the Driving shaft 144, with the ability to engage or disengage to any specific circular Transmission Driven Gears 160. One or more Duration Extender Module 1001 comprising, a Duration Extender Module Driving Circular Gear 61 axially connected to one of the Transmission Driven Gears 160, mounted on the Driven Shaft 142 or a larger driven gear of a pair of speed reduction circular gears mounted on the Driven Shaft 142 or on a Duration Extender Intermediate Driving shaft 144 parallel to the Driving shaft 144 a smaller Driving-Non-Circular-Gear of the pair of speed reduction gears via a Linking Mechanism 153 to engage/disengage is mounted on the Driving shaft 144, a Duration Extender Module Driven Circular Gear 62 meshing with the Duration Extender Module Driving Circular Gear 61 is mounted freewheeling on the Driving shaft 144 or on a Duration Extender Intermediate Driven Shaft 142 parallel to Driving shaft 144, one or more Duration Extender Module Driving Non-Circular gear 59s axially connected to the Duration Extender Module Driven Circular Gear 62, and meshed to the corresponding Duration Extender Module Driven Non-Circular Gear 60, meshing with the Duration Extender Module Driving Non-Circular gear 59, is mounted on the Driven Shaft 142, with the ability to engage or disengage with the Driven Shaft 142.

FIG. 140A uses all circular gears for transmission, circular sprockets and non-circular sprockets for Duration Extender Module 1001 and driven non-circular sprocket linked to the Driven Shaft 142. By adding a Linking Mechanism 153 to the Driving shaft 144, the rotation of gears in Duration Extension Module can be limited to the duration of ratio change sequence to eliminate vibration as shown in FIG. 140B (linking Driving shaft 144 to Driving Ratio A Gear), 23C (axially linking Duration Extender Module Driving Non-Circular-Sprocket to Driven Speed Reduction Sprocket) and 23D (linking Driving shaft 144 to Driving Ratio A Gear and axially linking Duration Extender Module Driving Non-Circular-Sprocket to Driven Speed Reduction Sprocket)

A set of circular Transmission Driving Gears 161 varying in size are rigidly mounted on a Driving shaft 144. A set of matching circular Transmission Driven Gears 160 freewheeling on a Driven Shaft 142 with its axis placed parallel to the axis of the Driving shaft 144, with the ability to engage or disengage to any specific circular Transmission Driven Gears 160. One or more Duration Extender Module 1001 comprising, a Duration Extender Driving Circular Sprocket is axially connected to one of the Transmission Driven Gears 160, mounted on the Driven Shaft 142 or a larger driven gear of a pair of speed reduction circular gears mounted on the Driven Shaft 142 or on a Duration Extender Intermediate Driving shaft 144 parallel to the Driving shaft 144 a smaller Driving-Non-Circular-Gear of the pair of speed reduction gears via a Linking Mechanism 153 to engage/disengage, is mounted on the Driving shaft 144, a Duration Extender Module Driven Circular Sprocket is linked by a Chain/Belt 139 and via a Tensioner Sprocket 170, with the Duration Extender Module Driving Circular Sprocket is mounted freewheeling on the Driving shaft 144 or on a Duration Extender Intermediate Driven Shaft 142 parallel to Driving shaft 144. This arrangement allows the Driven Circular Sprocket to spin in the same direction of the Driving Circular Sprocket.

This can also be achieved by replacing the both the Circular Sprockets with a Driving circular gear 63 connected to the Driven Circular Gear 140 via an intermediate Circular Gear placed on an auxiliary shaft. With this arrangement the rotation of Driving and Driven Shafts 144 and 142 can be achieved.

One or more Duration Extender Module Non-Circular Driving Sprockets with teeth uniformly spacing axially connected to the Duration Extender Module Driven Circular Sprocket, and linked via a Chain/Belt 139 and a Tensioner Sprocket 170 to the corresponding Duration Extender Module Circular or Non-Circular Driven Sprockets with teeth uniformly spaced as the Duration Extender Module Non-Circular Driving Sprockets mounted on the Driven Shaft 142, with the ability to engage or disengage with the Driven Shaft 142.

FIG. 141A uses all circular gears for transmission, circular sprockets and non-circular sprockets for Duration Extender Module 1001 and driven circular sprocket linked to the Driven Shaft 142. By adding a Linking Mechanism 153 to the Driving shaft 144, the rotation of gears in Duration Extension Module can be limited to the duration of ratio change sequence to eliminate vibration as shown in FIG. 141B (linking Driving shaft 144 to Driving Ratio A Gear), 24C (axially linking Duration Extender Module Driving Non-Circular-Sprocket to Driven speed reduction gear 167) and 24D (linking Driving shaft 144 to Driving Ratio A Gear and axially linking Duration Extender Module Driving Non-Circular-Sprocket to Driven speed reduction gear 167)

A set of circular Transmission Driving Gears 161 varying in size are rigidly mounted on a Driving shaft 144. A set of matching circular Transmission Driven Gears 160 freewheeling on a Driven Shaft 142 with its axis placed parallel to the axis of the Driving shaft 144, with the ability to engage or disengage to any specific circular Transmission Driven Gears 160. One or more Duration Extender Module 1001 comprising a Duration Extender Driving Circular Sprocket is axially connected to one of the Transmission Driven Gears 160, mounted on the Driven Shaft 142 or a larger driven gear of a pair of speed reduction circular gears mounted on the Driven Shaft 142 or on a Duration Extender Intermediate Driving shaft 144 parallel to the Driving shaft 144 a smaller Driving-Non-Circular-Gear of the pair of speed reduction gears via a Linking Mechanism 153 to engage/disengage, is mounted on the Driving shaft 144, a Duration Extender Module Driven Circular Sprocket is linked by a Chain/Belt 139 and via a Tensioner Sprocket 170, with the Duration Extender Module Driving Circular Sprocket is mounted freewheeling on the Driving shaft 144 or on a Duration Extender Intermediate Driven Shaft 142 parallel to Driving shaft 144. One or more Duration Extender Module Non-Circular Driving Sprockets with teeth uniformly spacing axially connected to the Duration Extender Module Driven Circular Sprocket, and linked via a Chain/Belt 139 and a Tensioner Sprocket 170 to the corresponding Duration Extender Module Circular or Non-Circular Driven Sprockets with teeth uniformly spaced as the Duration Extender Module Non-Circular Driving Sprockets mounted on the Driven Shaft 142, with the ability to engage or disengage with the Driven Shaft 142.

FIG. 142A uses all circular sprockets for transmission, circular sprockets and non-circular sprockets for Duration Extender Module 1001 and driven non-circular sprocket linked to the Driven Shaft 142. By adding a Linking Mechanism 153 to the Driving shaft 144, the rotation of gears in Duration Extension Module can be limited to the duration of ratio change sequence to eliminate vibration as shown in FIG. 142B (linking Driving shaft 144 to Driving Ratio A Sprocket), 25C (axially linking Duration Extender Module Driving Non-Circular-Sprocket to Driven Speed Reduction Sprocket) and 25D (linking Driving shaft 144 to Driving Ratio A Gear and axially linking Duration Extender Module Driving Non-Circular-Sprocket to Driven Speed Reduction Sprocket)

A set of circular Transmission Driving Sprockets 162 varying in size are rigidly mounted on a Driving shaft 144. A set of matching circular Transmission Driven Sprockets 164 freewheeling on, a Driven Shaft 142 with its axis placed parallel to the axis of the Driving shaft 144, with the ability to engage or disengage to any specific circular transmission driven sprocket 164. One or more Duration Extender Module 1001 comprising, a Duration Extender Module Driving Circular Sprocket is axially connected to one of the Transmission Driven Sprockets 164, mounted on the Driven Shaft 142 or a larger driven sprocket of a pair of speed reduction circular sprockets mounted on the Driven Shaft 142 or on a Duration Extender Intermediate Driving shaft 144 parallel to the Driving shaft 144. A smaller driving circular sprocket of the pair of speed reduction sprockets rigidly mounted on the Driving shaft 144. A Duration Extender Module Driven Circular Sprocket is linked by a Chain/Belt 139 and via a Tensioner Sprocket 170, with the Duration Extender Module Driving Circular Sprocket is mounted freewheeling on the Driving shaft 144 or on a Duration Extender Intermediate Driven Shaft 142 parallel to Driving shaft 144. One or more Duration Extender Module Non-Circular Driving Sprockets with teeth uniformly spacing axially connected to the Duration Extender Module Driven Circular Sprocket, and linked via a Chain/Belt 139 and a Tensioner Sprocket 170 to the corresponding Duration Extender Module Circular or Non-Circular Driven Sprockets with teeth uniformly spaced as the Duration Extender Module Non-Circular Driving Sprockets mounted on the Driven Shaft 142, with the ability to engage or disengage with the Driven Shaft 142.

FIG. 143A uses all circular sprockets for transmission, circular sprockets and non-circular sprockets for Duration Extender Module 1001 and driven circular sprocket linked to the Driven Shaft 142. By adding a Linking Mechanism 153 to the Driving shaft 144, the rotation of gears in Duration Extension Module can be limited to the duration of ratio change sequence to eliminate vibration as shown in FIG. 143B (linking Driving shaft 144 to Driving Ratio A Sprocket), 26C (axially linking Duration Extender Module Driving Non-Circular-Sprocket to Driven Speed Reduction Sprocket) and 26D (linking Driving shaft 144 to Driving Ratio A Gear and axially linking Duration Extender Module Driving Non-Circular-Sprocket to Driven Speed Reduction Sprocket)

A set of circular Transmission Driving Sprockets 162 varying in size are rigidly mounted on a Driving shaft 144. A set of matching circular Transmission Driven Sprockets 164 freewheeling on, a Driven Shaft 142 with its axis placed parallel to the axis of the Driving shaft 144, with the ability to engage or disengage to any specific circular transmission driven sprockets 164. One or more Duration Extender Module 1001 comprising a Duration Extender Module Driving Non-Circular Sprocket 147 having two or more constant radii pitch circle with teeth uniformly spaced is axially connected to one of the Transmission Driven Sprockets 164, mounted on the Driven Shaft 142 or a larger driven sprocket of a pair of speed reduction circular sprockets mounted on the Driven Shaft 142 or on a Duration Extender Intermediate Driving shaft 144 parallel to the Driving shaft 144. A smaller Driving-Non-Circular-Gear of the pair of speed reduction sprockets via a Linking Mechanism 153 to engage/disengage, is mounted on the Driving shaft 144. A Duration Extender Module Driven Circular or Non-Circular Sprocket with teeth uniformly and identical spacing as the Duration Extender Module Driving Non-Circular Sprocket 147 is linked by a Chain/Belt 139 and via a Tensioner Sprocket 170, with the Duration Extender Module Driving Non-Circular Sprocket 147, is mounted freewheeling on the Driving shaft 144 or on a Duration Extender Intermediate Driven Shaft 142 parallel to Driving shaft 144. One or more Duration Extender Module Driving Circular Sprocket axially connected to the Duration Extender Module Driven Non-Circular Sprocket 147 and linked via a Chain/Belt 139 to the corresponding Duration Extender Module Driven Circular Sprocket mounted on the Driven Shaft 142, with the ability to engage or disengage with the Driven Shaft 142.

FIG. 144A uses all circular sprockets for transmission, circular gears and non-circular gears for Duration Extender Module 1001 and Driven-Circular-Gear linked to the Driven Shaft 142. By adding a Linking Mechanism 153 to the Driving shaft 144, the rotation of gears in Duration Extension Module can be limited to the duration of ratio change sequence to eliminate vibration as shown in FIG. 144B (linking Driving shaft 144 to Driving Ratio A Sprocket), 27C (axially linking Duration Extender Module Driving Non-Circular-Sprocket to Driven Speed Reduction Sprocket) and 27D (linking Driving shaft 144 to Driving Ratio A Gear and axially linking Duration Extender Module Driving Non-Circular-Sprocket to Driven Speed Reduction Sprocket)

A set of circular Transmission Driving Sprockets 162 varying in size are rigidly mounted on a Driving shaft 144. A set of matching circular Transmission Driven Sprockets 164 freewheeling on a Driven Shaft 142 with its axis placed parallel to the axis of the Driving shaft 144, with the ability to engage or disengage to any specific circular transmission driven sprockets 164. One or more Duration Extender Module 1001 comprising a Duration Extender Module Driving Non-Circular gear 59 axially connected to one of the Transmission Driven Sprockets 164, mounted on the Driven Shaft 142 or a larger driven gear of a pair of speed reduction circular gears mounted on the Driven Shaft 142 or on a Duration Extender Intermediate Driving shaft 144 parallel to the Driving shaft 144 driven by a smaller Driving-Non-Circular-Gear of the pair of speed reduction gears via a Linking Mechanism 153 to engage/disengage, is mounted on the Driving shaft 144. A Duration Extender Module Driven Non-Circular Gear 60, meshing with the Duration Extender Module Driving Non-Circular gear 59, is mounted freewheeling on the Driving shaft 144 or on a Duration Extender Intermediate Driven Shaft 142 parallel to Driving shaft 144. One or more Duration Extender Module Driving Circular Gears 61 axially connected to the Duration Extender Module Driven Non-Circular Gear 60 and meshed to the corresponding Duration Extender Module Driven Circular Gears 62 mounted on the Driven Shaft 142, with the ability to engage or disengage with the Driven Shaft 142.

FIG. 145A uses all circular sprockets for transmission, circular gears and non-circular gears for Duration Extender Module 1001 and Driven-Non-Circular-Gear linked to the Driven Shaft 142. By adding a Linking Mechanism 153 to the Driving shaft 144, the rotation of gears in Duration Extension Module can be limited to the duration of ratio change sequence to eliminate vibration as shown in FIG. 145B (linking Driving shaft 144 to Driving Ratio A Sprocket), 28C (axially linking Duration Extender Module Driving Non-Circular-Sprocket to Driven speed reduction gear 167) and 28D (linking Driving shaft 144 to Driving Ratio A Gear and axially linking Duration Extender Module Driving Non-Circular-Sprocket to Driven speed reduction gear 167)

A set of circular Transmission Driving Sprockets 162 varying in size are rigidly mounted on a Driving shaft 144. A set of matching circular Transmission Driven Sprockets 164 freewheeling on a Driven Shaft 142 with its axis placed parallel to the axis of the Driving shaft 144, with the ability to engage or disengage to any specific circular transmission driven sprockets 164. One or more Duration Extender Module 1001 comprising a Duration Extender Module Driving Circular Gear 61 axially connected to one of the Transmission Driven Sprockets 164, mounted on the Driven Shaft 142 or a larger driven sprocket of a pair of speed reduction circular sprockets mounted on the Driven Shaft 142 or on a Duration Extender Intermediate Driving shaft 144 parallel to the Driving shaft 144. A smaller driving circular sprocket of the pair of speed reduction sprockets rigidly mounted on the Driving shaft 144, A Duration Extender Module Driven Circular Gear 62 meshing with the Duration Extender Module Driving Circular Gear 61 is mounted freewheeling on the Driving shaft 144 or on a Duration Extender Intermediate Driven Shaft 142 parallel to Driving shaft 144. One or more Duration Extender Module Driving Non-Circular gear 59s axially connected to the Duration Extender Module Driven Circular Gear 62 and meshed to the corresponding Duration Extender Module Driven Non-Circular Gear 60, meshing with the Duration Extender Module Driving Non-Circular gear 59, is mounted on the Driven Shaft 142, with the ability to engage or disengage with the Driven Shaft 142.

FIG. 146A uses all circular sprockets for transmission, circular sprockets and non-circular sprockets for Duration Extender Module 1001 and driven non-circular sprocket linked to the Driven Shaft 142. By adding a Linking Mechanism 153 to the Driving shaft 144, the rotation of gears in Duration Extension Module can be limited to the duration of ratio change sequence to eliminate vibration as shown in FIG. 146B (linking Driving shaft 144 to Driving Ratio A Sprocket), 29C (axially linking Duration Extender Module Driving Non-Circular-Sprocket to Driven Speed Reduction Sprocket) and 29D (linking Driving shaft 144 to Driving Ratio A Gear and axially linking Duration Extender Module Driving Non-Circular-Sprocket to Driven Speed Reduction Sprocket)

A set of circular Transmission Driving Sprockets 162 varying in size are rigidly mounted on a Driving shaft 144. A set of matching circular Transmission Driven Sprockets 164 freewheeling on a Driven Shaft 142 with its axis placed parallel to the axis of the Driving shaft 144, with the ability to engage or disengage to any specific circular transmission driven sprockets 164. One or more Duration Extender Module 1001 comprising a Duration Extender Driving Circular Sprocket is axially mounted on the Driving shaft 144 linked by a Chain/Belt 139 to a Duration Extender Module Driven Sprocket 146 mounted on a Duration Extender Module Intermediate Driving shaft 144. A Duration Extender Module Driving Non-Circular Sprocket 147 with teeth uniformly and identical spacing is axially connected to the Duration Extender Module Driven Sprocket 146, via a Chain/Belt 139 and a Tension Sprocket, linked to a Duration Extender Module Driven Non-Circular Sprocket 147 mounted on the Transmission Driven Shaft 142.

FIG. 147A uses all circular gears for transmission and circular sprockets and non-circular gear for Duration Extender Module 1001 and Driven-Non-Circular-Gear linked to the Driven Shaft 142. By adding a Linking Mechanism 153 to the Driving shaft 144, the rotation of gears in Duration Extension Module can be limited to the duration of ratio change sequence to eliminate vibration as shown in FIG. 147B (linking Driving shaft 144 to Driving Ratio A Sprocket), 30C (axially linking Duration Extender Module Driving-Non-Circular-Gear to Driven Speed Reduction Sprocket) and 30D (linking Driving shaft 144 to Driving Ratio A Gear and axially linking Duration Extender Module Driving-Non-Circular-Gear to Driven Speed Reduction Sprocket)

A set of circular Transmission Driving Gears 161 varying in size are rigidly mounted on a Driving shaft 144. A set of matching circular Transmission Driven Gears 160 freewheeling on a Driven Shaft 142 with its axis placed parallel to the axis of the Driving shaft 144, with the ability to engage or disengage to any specific circular Transmission Driven Gears 160. One or more Duration Extender Module 1001 comprising a Duration Extender Module Driving Circular Sprocket is axially mounted on the Driving shaft 144 linked by a Chain/Belt 139 to a Duration Extender Module Driven Sprocket 146 mounted on a Duration Extender Module Intermediate Driving shaft 144. A Duration Extender Module Driving Non-Circular gear 59 is axially connected to the Duration Extender Module Driven Sprocket 146 and paired with a Duration Extender Module Driven Non-Circular Gear 60 mounted on the Transmission Driven Shaft 142.

FIG. 148A uses all circular sprockets for transmission and circular gears and non-circular gears for Duration Extender Module 1001 and Driven-Non-Circular-Gear linked to the Driven Shaft 142. By adding a Linking Mechanism 153 to the Driving shaft 144, the rotation of gears in Duration Extension Module can be limited to the duration of ratio change sequence to eliminate vibration as shown in FIG. 148B (linking Driving shaft 144 to Driving Ratio A Sprocket), 31C (axially linking Duration Extender Module Driving-Non-Circular-Gear to Driven speed reduction gear 167) and 31D (linking Driving shaft 144 to Driving Ratio A Gear and axially linking Duration Extender Module Driving-Non-Circular-Gear to Driven speed reduction gear 167)

A set of circular Transmission Driving Sprockets 162 varying in size are rigidly mounted on a Driving shaft 144 and a set of matching circular Transmission Driven Sprockets 164 freewheeling on a Driven Shaft 142 with its axis placed parallel to the axis of the Driving shaft 144, with the ability to engage or disengage to any specific circular transmission driven sprockets 164. One or more Duration Extender Module 1001 comprising a Duration Extender Driving Circular Gear 61 mounted on the Driving shaft 144 and meshed to a Duration Extender Module Driven Gear mounted on a Duration Extender Module Intermediate Driving shaft 144. A Duration Extender Module Driving Non-Circular gear 59 is axially connected to the Duration Extender Module Driven Gear, is meshed to a Duration Extender Module Driven Non-Circular Gear 60 mounted on the Transmission Driven Shaft 142.

The same shifting concept can be applied to all the above scenarios to achieve uninterrupted gear shifting, only difference is that gears are replaced with sprockets that is ideal for the scenarios.

Additionally, by using a planetary gear system this Pseudo “Continuously” Variable Transmission can be converted to a Pseudo “Infinitely” Variable Transmission, by

a) feeding driving sprocket to either sun or ring or carrier of the planetary system,

b) feeding driven sprocket to either of the remaining two elements and

c) connecting the third element to the wheel.

By appropriately sizing the planetary gear system, forward, reverse, and neutral can be achieved.

to next.

All circular and non-circular gears in FIGS. 118 through 148D can be replaced with Geneva pin and wheel mechanism with custom slot path.

II) Utilizing Non-Circular Gears with “Bald” Regions (without Teeth) and/or Geneve Wheel Mechanism with Custom Slot Path for Multi-Speed Uninterrupted Shifting (MSTUS)

The synchronous shifting is achieved by engaging the driving and the driven gears by aligning them in a single operating plane 1003 and disengaging them by offsetting one of them out of the operating plane 1003. There are three configurations to achieve this.

1) In the first configuration each of the gear pairs is co-planer and they are all made active or inactive by engaging or disengaging with their shafts with a dog clutch 53 individually.

2) In the second configuration the active gear pairs are moved to one common operating plane 1003.

3) In the third configuration there are multiple operating planes 1003 with the active and inactive gear pairs have their own operating plane 1003. The gear pairs are active when they are co-planer with each other, and they are inactive when placed at an offset with each other. Below is a detailed description of each of these configurations.

1) Transmission Using Dog Clutch:

Here a set of driving transmission gears along with driving non-circular gears 143 are mounted on a drive shaft. A set of driven conjugate transmission gears along with driving non-circular gears 143 are mounted on a Driven Shaft 142. One of the gears in each pair has a dog clutch 53 to engage or disengage with its shaft. For every pair of adjacent value of gears has a non-circular pair with its pitch curve having a region of both the circular gear's pitch curves. These pitch curves are sandwiched with an up-shift ramp and a downshift ramp. These ratios are cycled once for every rotation. The uninterrupted shifting is achieved when the non-circular gears, in its cycle matches with the pitch curve of the currently engaged circular transmission pairs, the non-circular gear is also simultaneously engaged with its shaft via its dog clutch 53. Then immediately the currently engaged circular pair is disengaged. After the non-circular gear passes through the ramp and reaches the targeted ratio, the targeted circular gear is simultaneously engaged. Before the non-circular gear reaches the next ramping zone, it is disengaged with its shaft. Thus, the shifting from the existing ratio to the targeted ratio is achieved uninterrupted.

2) Single Operating Plane: (FIG. 2-4)

With the driving and driven sets of several pairs of gears, the two smallest size full gears 13 and 16 are placed co-planer at a fixed center to center distance. Spring loaded Gear Segment 151s forming full larger size gears are placed co-axial but offset to the full-size gears. The larger gears 15 and 18 have an orifice matching the gear profile of the smallest gear. These spring 10 loaded segments of larger gears 15 and 18 can be moved in and out of operating plane 1003 to achieve several input-to-output ratios.

A pair of driving and driven gear/Gear Segment 151s are selected so that the center-to-center distance which is the sum of the radii of the driving and driven pairs is constant. If the driving or driven gear is to be changed from smaller to larger size, then the larger Gear Segment 151s are slipped into the operating plane 1003 for one gear, and the larger Gear Segment 151s are slipped out of the operating plane 1003 for the other gear so that two gears can mesh with each other. The offset planes of segments of gears of driving and driven sets are so placed so that the largest gears of both sets do not interfere with each other. This can be achieved by placing the segment of large gears are placed on either side of the gears are slipped in and out in the regions where driving and driven gears are not in contact. Since the gear teeth are not loaded there is negligible friction to overcome to slide them into the operating plane 1003. In order for the teeth of the driving and driven gears to mesh exactly, the gears may have to be rotated to a certain correct position. This can be achieved using position sensors with computer-controlled solenoids. While switching from one ratio to another the gears will experience sudden change in rotational speed, and this will deteriorate the life of the gears. To eliminate this the driving or the Driven Shaft 142 is fitted with a rotational shock absorber such as a torsion spring 51. Another way to solve this is to use an intermediate non-circular gear to ramp up or ramp down from the active ratio to the targeted ratio. The non-circular gear will have four zones.
Namely
a) low-speed zone, where the low-speed zone has the lower of the two gear ratios of the two circular gear pairs
b) high-speed zone, has the higher of the two gear ratios of the two circular gear pairs, separated by ramping up of the gear ratio during the
c) up-shift zone, and ramping down of the gear ratio during the
d) downshift zone,

Since this non-circular gear or otherwise known as crescent transition gears 14 and 17 with its rotational origin having an orifice of the smallest gear and also matching the portion of the contour, the shape is like a “crescent” as shown in FIGS. 5A and 6B. These crescent shaped non-circular gears 14 and 17 can be packaged inside the larger gears 15 and 18 to minimize the overall size of the transmission.

An alternative way to having a small gear profile is to place the driving and driven transition gear segments 7 and 8 on non-circular telescopic tubular shafts 46, 47, 48 and 49 as shown in FIGS. 21A and 21B.

Here the ideal orientation for the up-shift zone and the downshift zone occurs in cycles. This happens when the driving gear and the driven gear finish a complete revolution at the same time. Because in low speed or high speed the driving gear shaft and the driven gear shaft rotate at a different rate. However, the requirement for the non-circular gear to work they must rotate at a constant speed (1:1). So, the ideal time to use the non-circular gear is cyclic.

Here the up shift is achieved by
a) With the lower speed being active, that is the smaller driving gear 13 is engaged with the larger driven gear 18, them being co-planer
b) During the ideal cycle time for the up-shift the crescent shaped non-circular gears 14 and 17 are slipped into the same operating plane 1003, during up-shift zone, de-activating the lower speed gear.
c) When the non-circular gears 14 and 17 reach the high-speed range, the high-speed gears 15 and 16 are slipped into the operating plane 1003, achieving high-speed.

Similarly, the downshift is achieved by
a) With the higher speed being active, that is the larger driving gear 15 is engaged with the smaller driven gear 16, them being co-planer
b) During the ideal cycle time for the downshift the crescent shaped non-circular gears 14 and 17 are slipped into the same operating plane 1003, during downshift zone, de-activating the lower speed gear.
c) When the non-circular gears 14 and 17 reach the low-speed range, the low-speed gears 13 and 18 are slipped into the operating plane 1003, achieving low-speed.

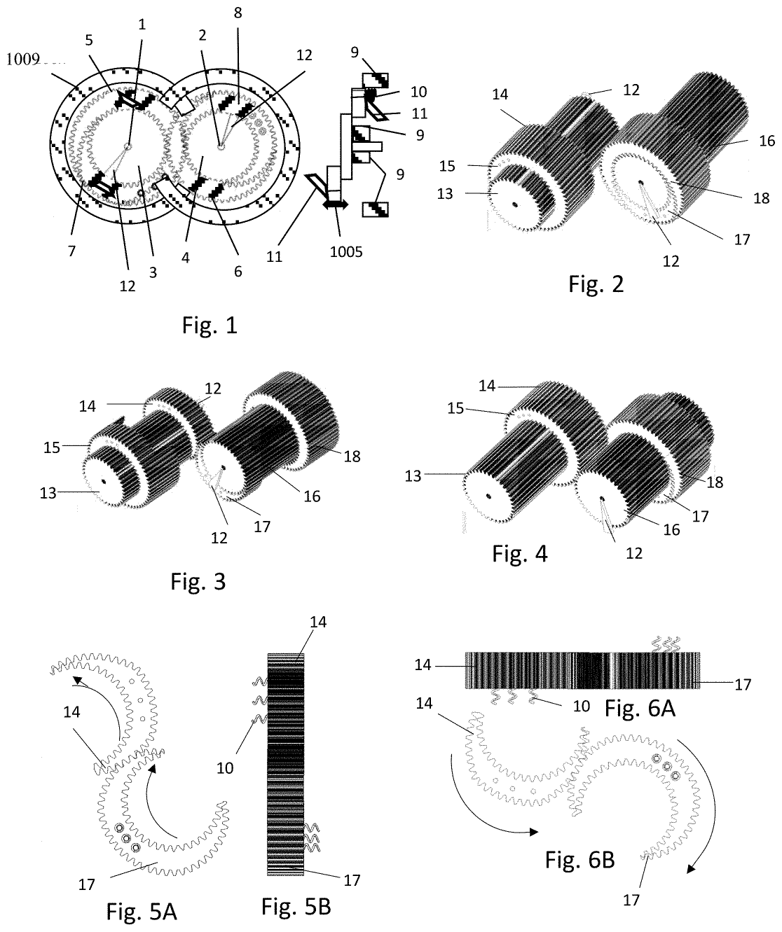

FIG. 1 shows the front view and the side view of the general construction of this concept.

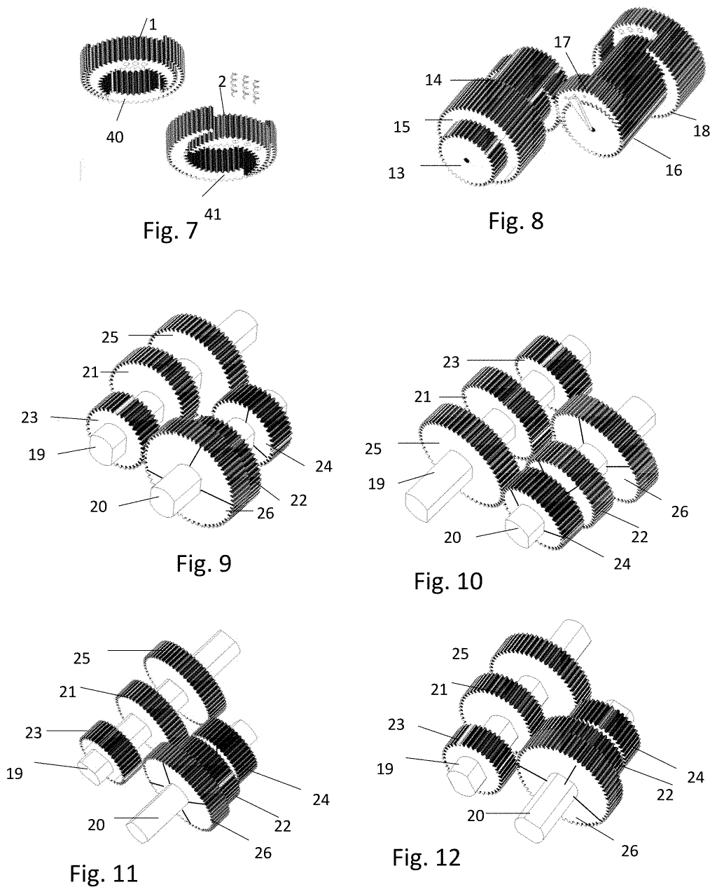

FIG. 2 shows the gear placement for the low speed. FIGS. 3 and 8 shows gear placement of the up-shift or the downshift and FIG. 4 shows the gear placement for the high-speed. FIG. 7 shows that the crescent shaped transition gear along with the large gear without the high-speed zone for the driving and the large gear without the low-speed zone form a full driving and driven gear respectively.

3) Multiple Operating Planes FIGS. 9-12 and 13-16:—

Here, there are two ways of operating this. Gears pairs are placed offset and made co-planer only when desired to make them active. Every gear pair has its own operating plane 1003. The gear pairs are engaged or disengaged by making them co-planer or offset. Here driving or driven or both sets of gears are segmented. All the segments of each gear form a full gear. Each segment is capable of axially moving individually. In order to engage or disengage, each segment is individually moved in or out of the operating plane 1003 one at a time. This is done when none of the teeth in that segment is in contact with its conjugate. This way even helical gear can be brought in alignment to mesh with each other. Since the gear teeth are not loaded there is negligible friction to overcome to slide them into the operating plane.

Here also for every two pairs of driving and driven circular gears 23, 24, 25, 26 with adjacent gear ratio values, there is a non-circular gear pair 21 and 22 with four gear ratio zones. They are
a) Low-speed zone. This zone has the lower of the two gear ratios of the two circular gear pairs
b) High-speed zone. This zone has the higher of the two gear ratios of the two circular gear pairs.
c) Up-shift zone. The low-speed zone and the high-speed zone are separated by this up-shift zone and
d) Downshift zone. The high-speed zone and the low-speed zone are separated by this downshift zone.
It is sufficient if only one gear in the pair is segmented, for example segmented gears 22, 24 and 26 in FIGS. 9-12. It does not matter if that is a driving or a driven gear. The other gear can be a single piece attached rigidly to its shaft.
FIG. 9 shows the gear placement for the low speed. FIG. 10 shows gear placement of the up-shift, FIG. 11 shows gear placement for the downshift and FIG. 12 shows the gear placement for the high-speed. The construction of the segmented gear is explained below.

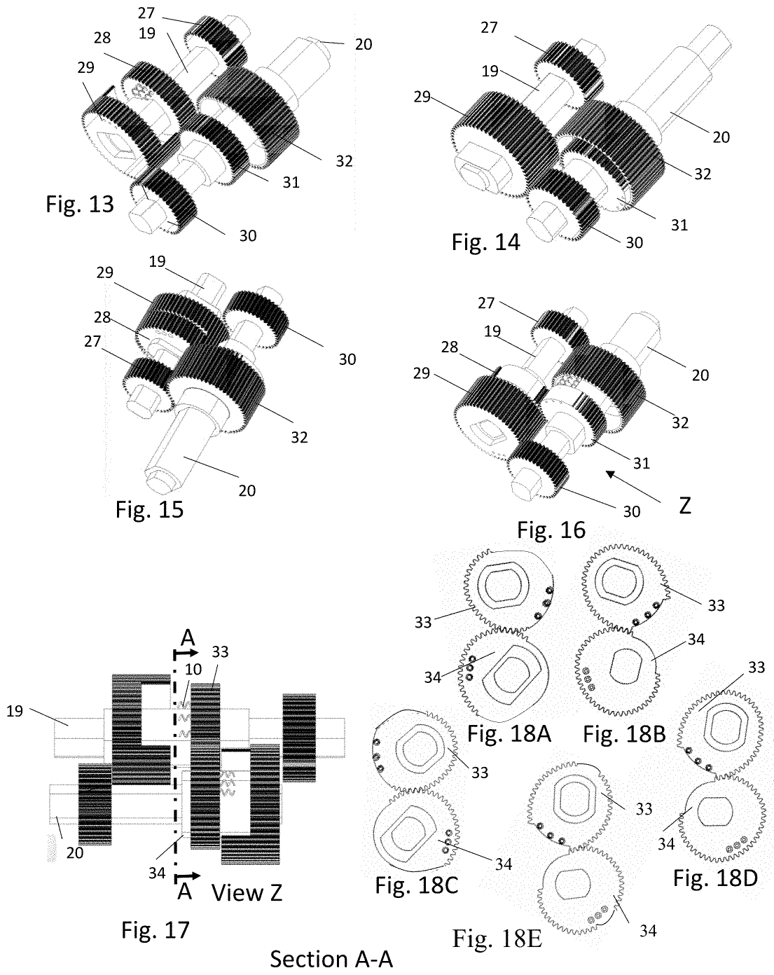

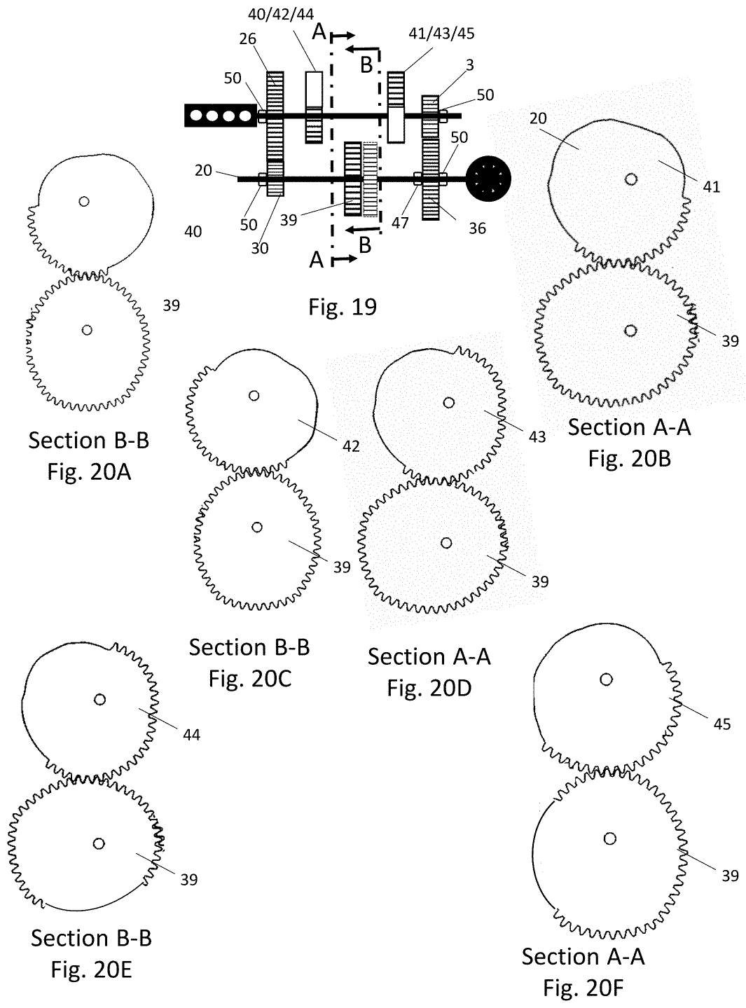

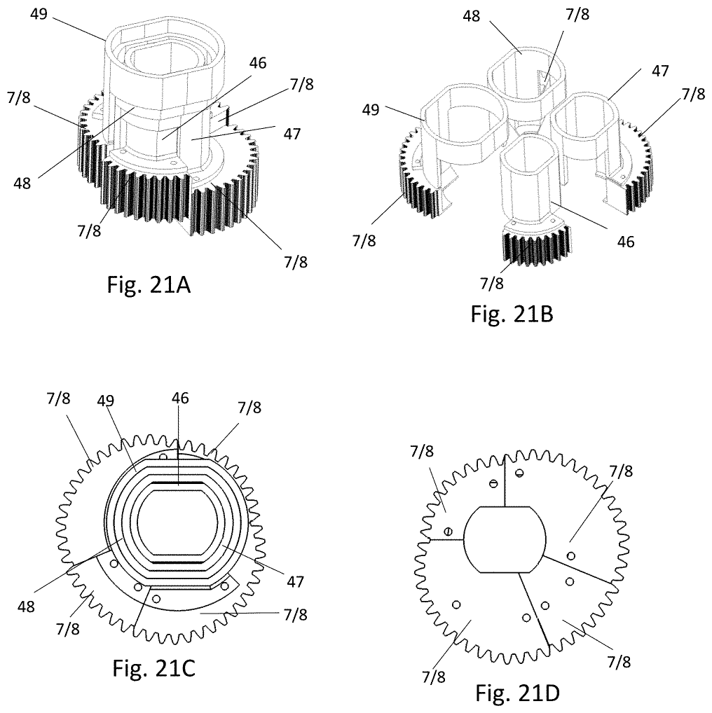

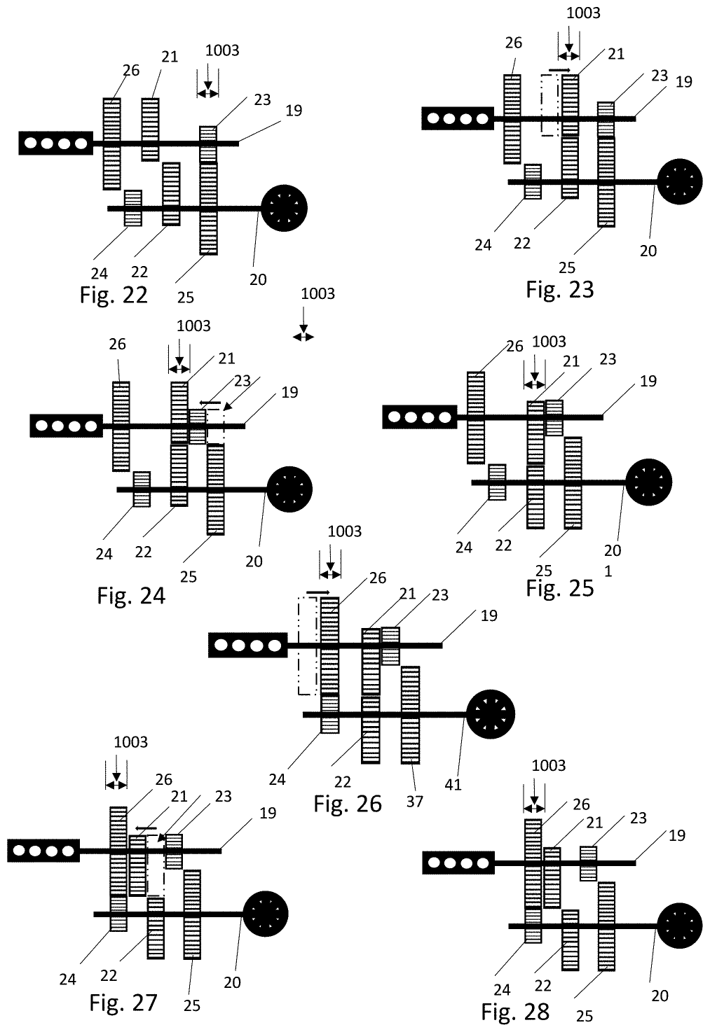

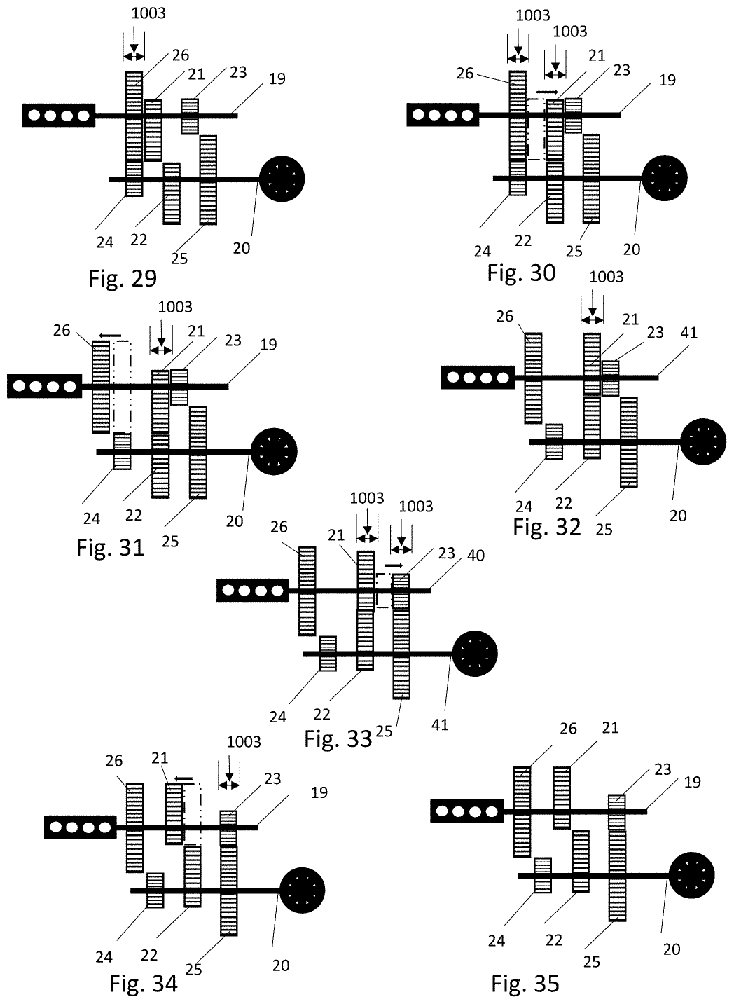

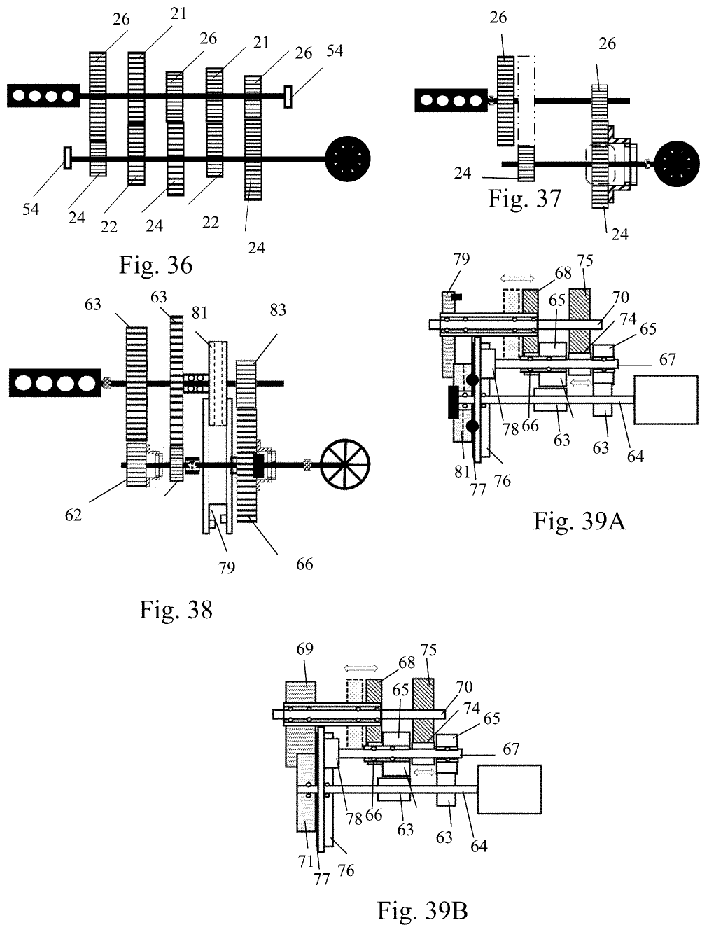

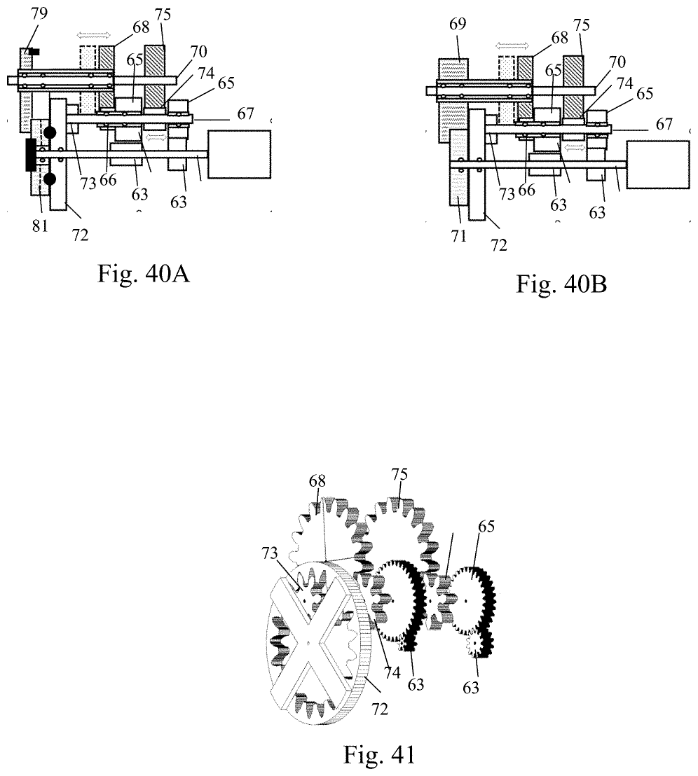

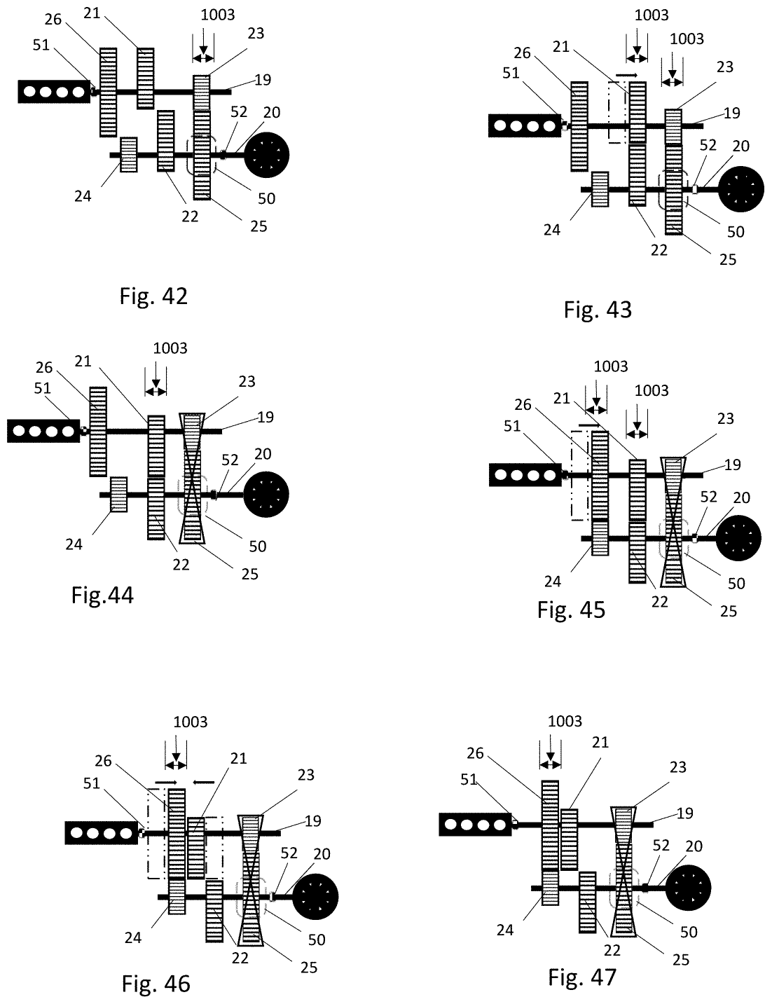

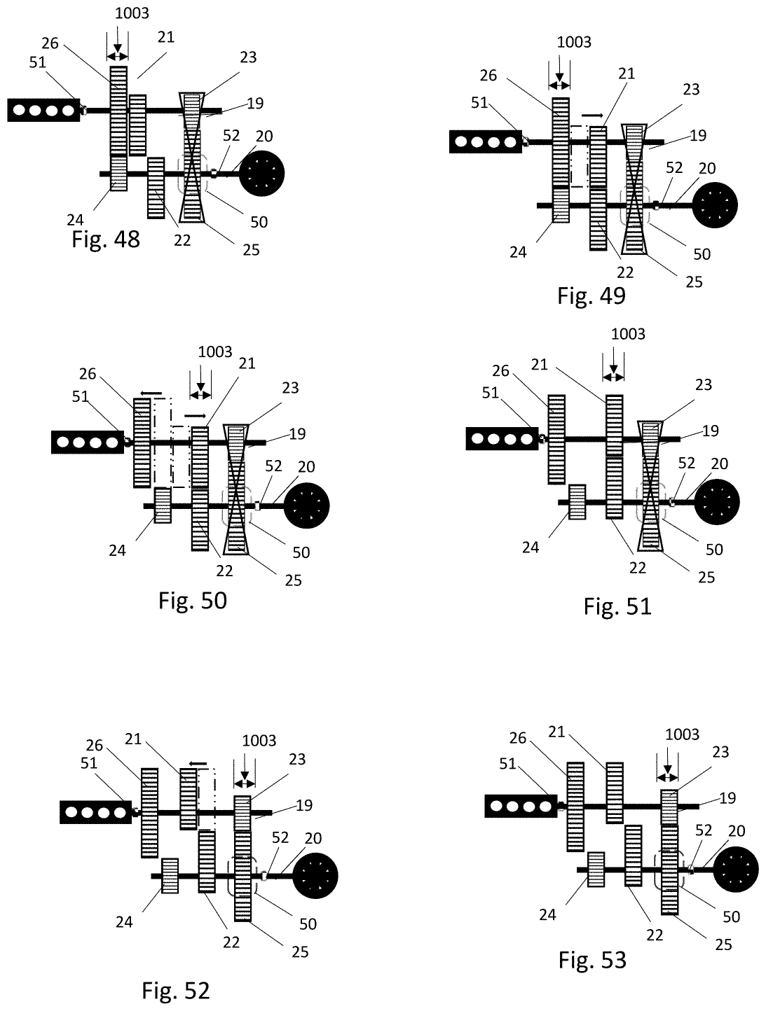

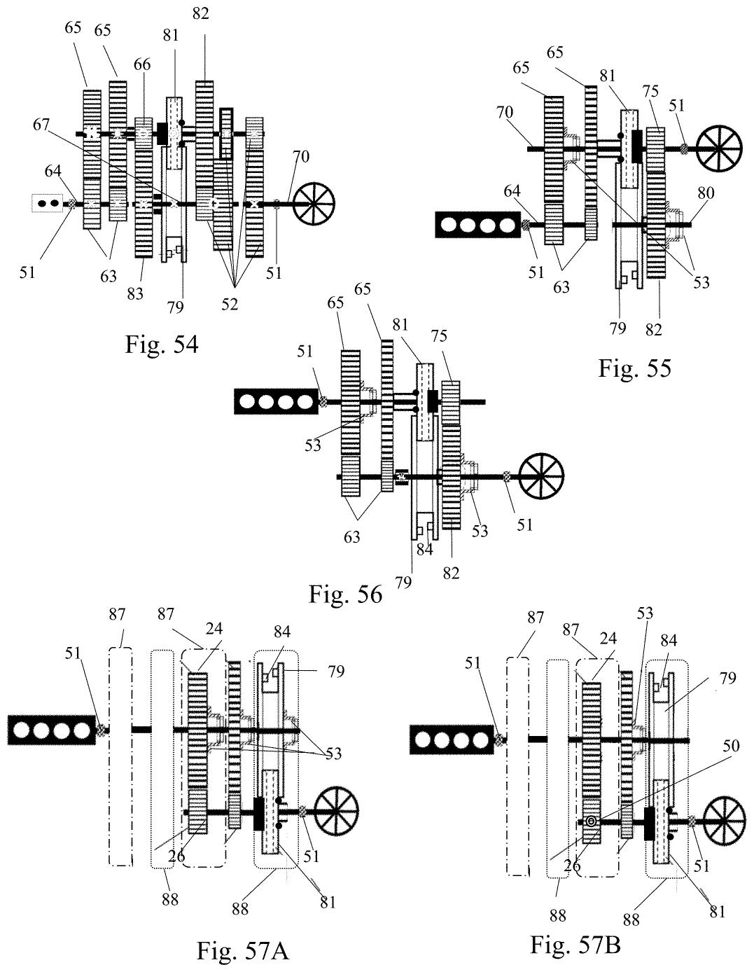

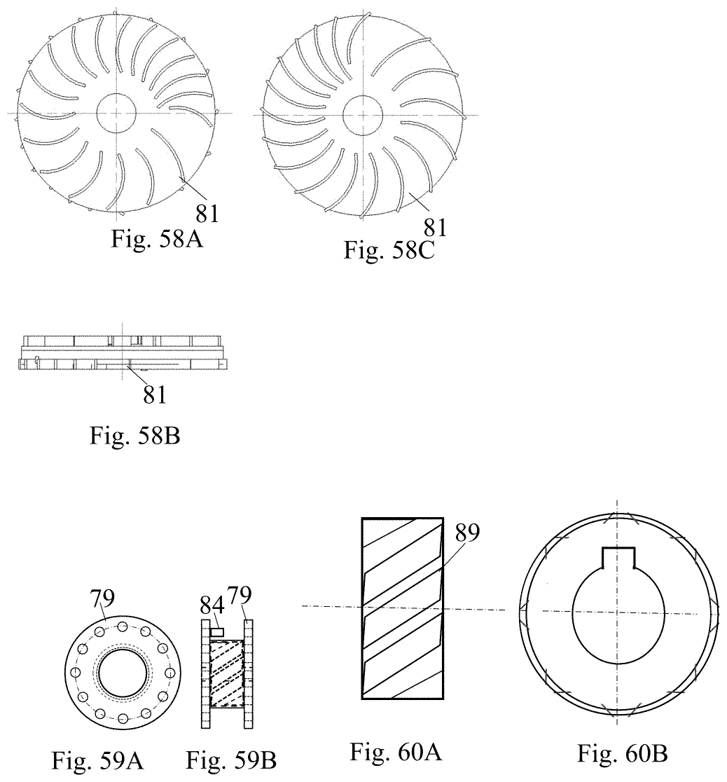

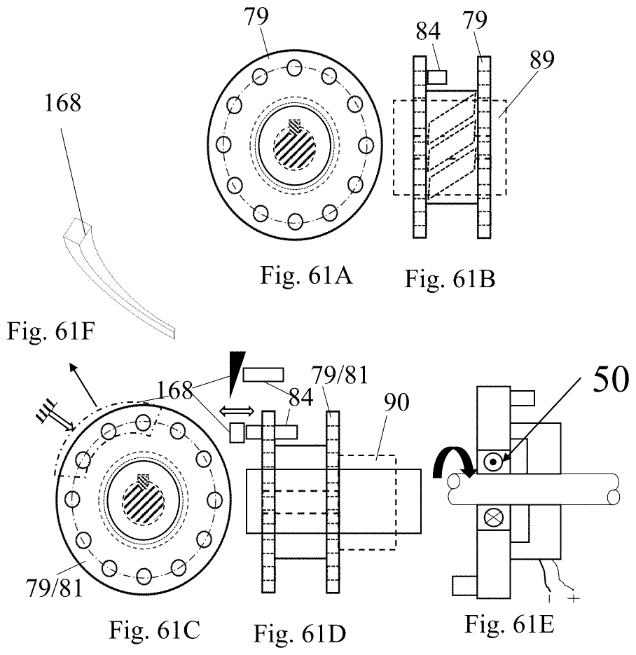

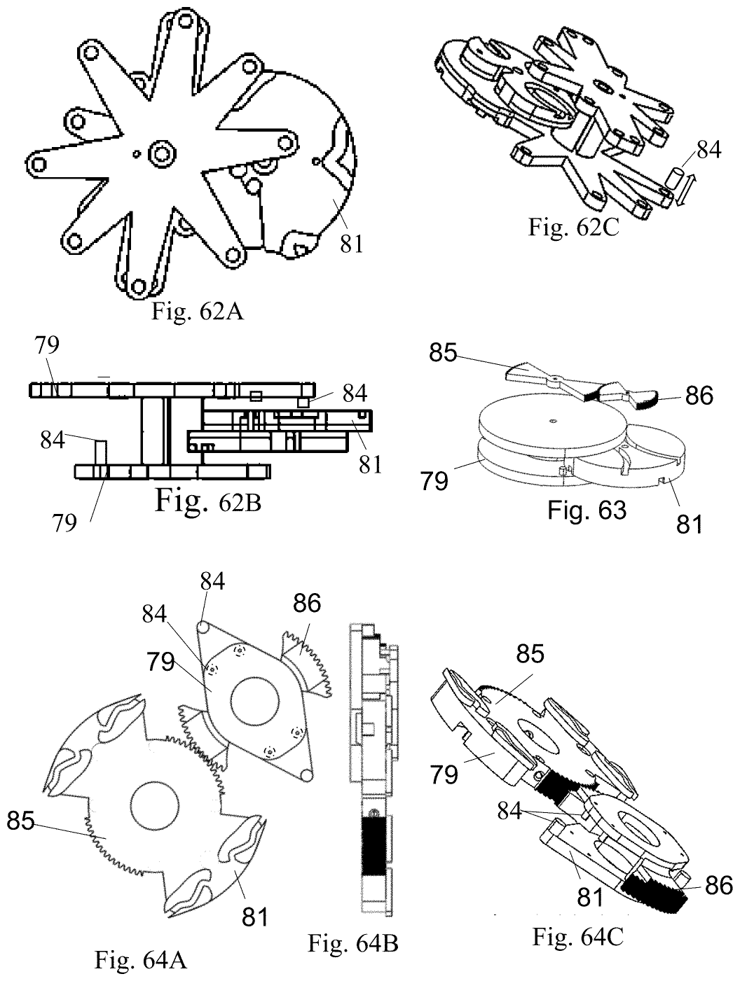

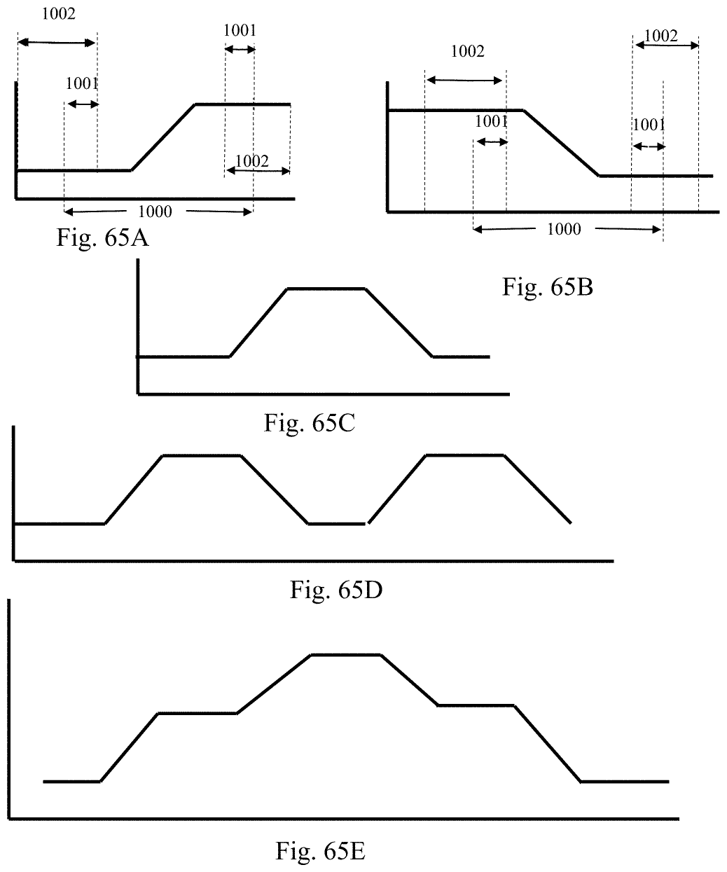

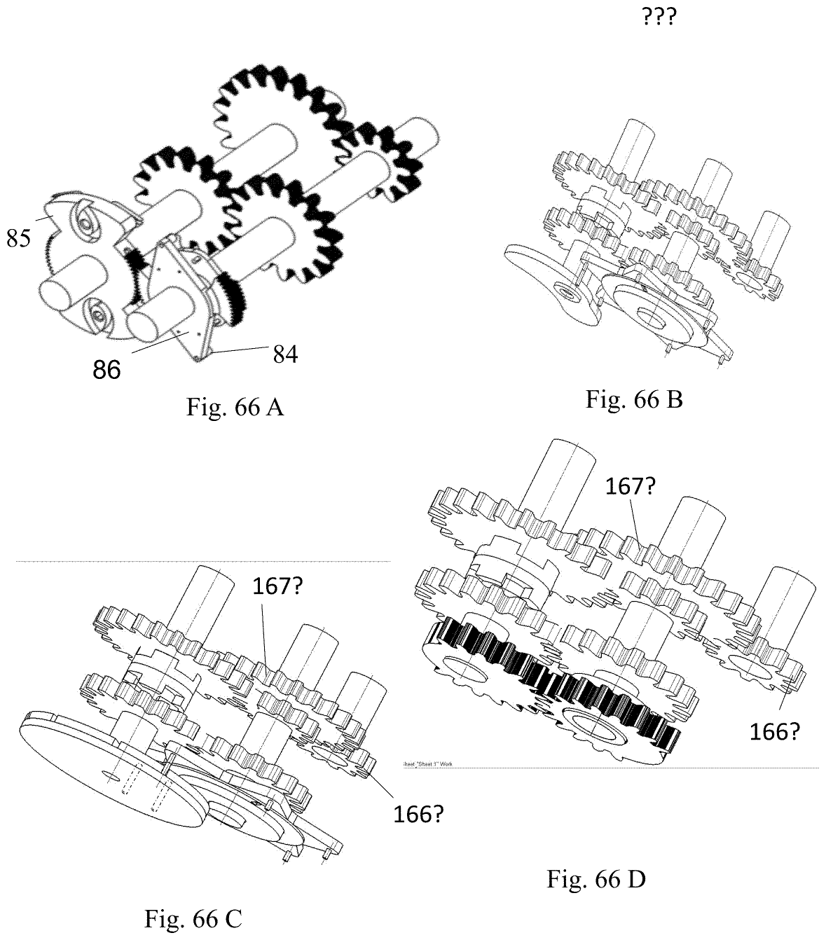

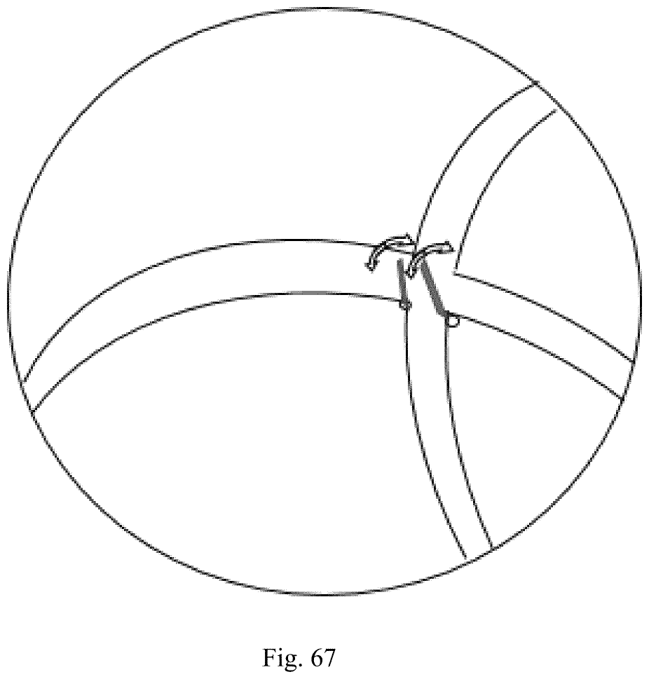

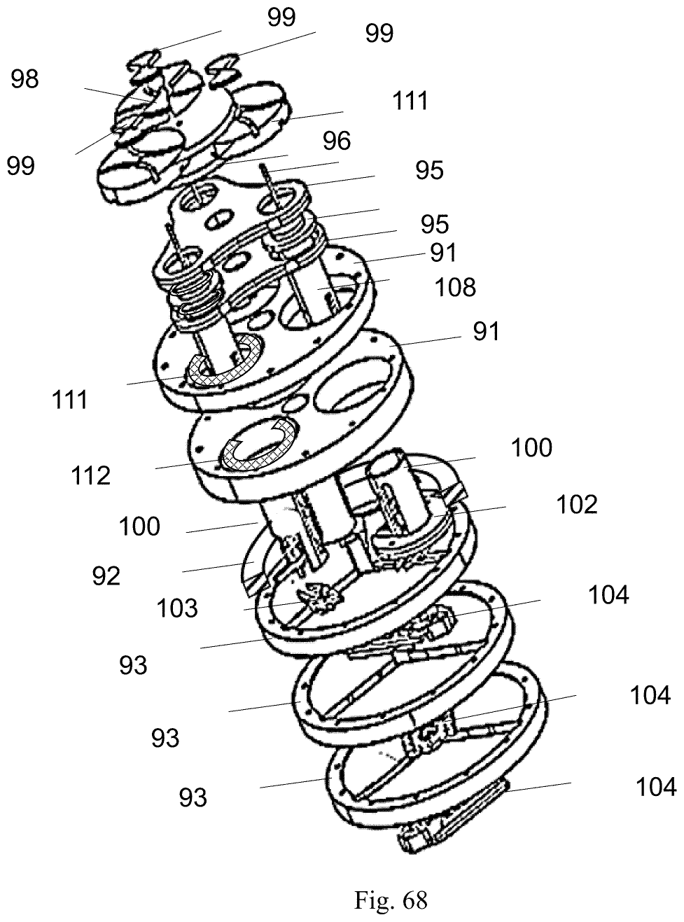

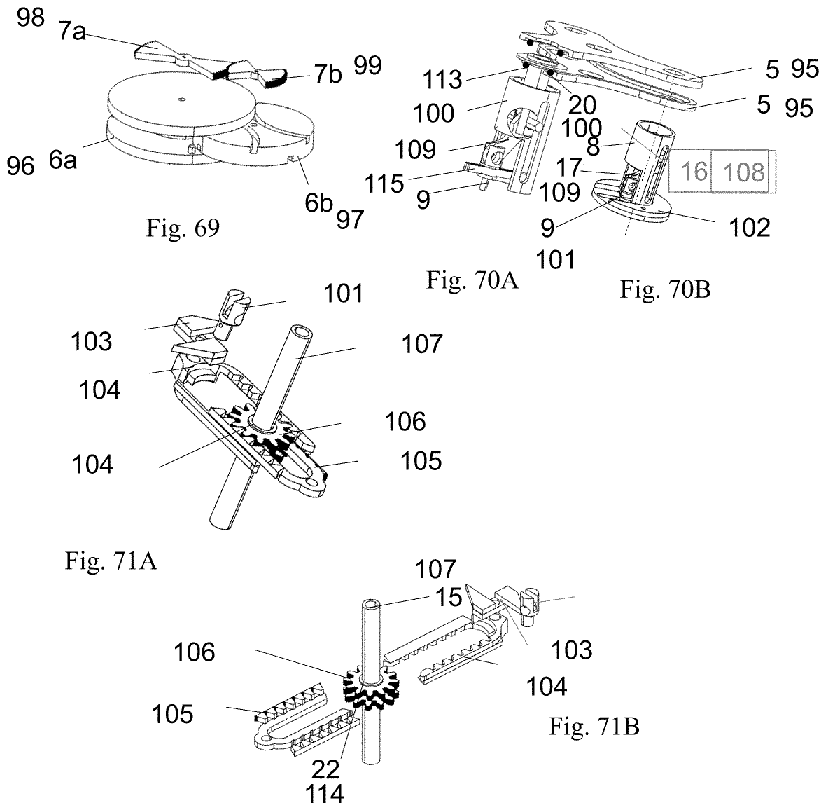

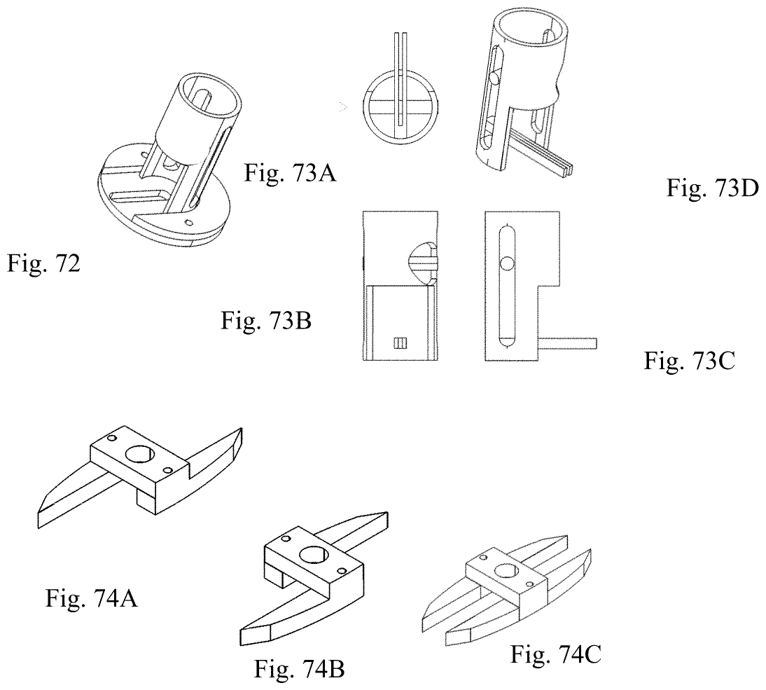

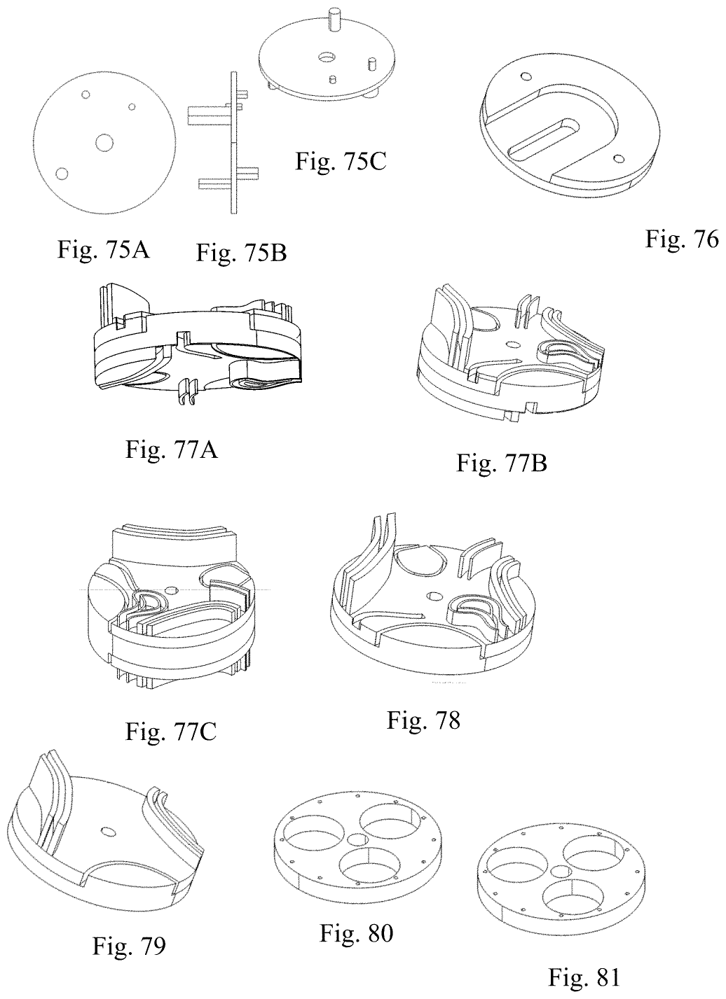

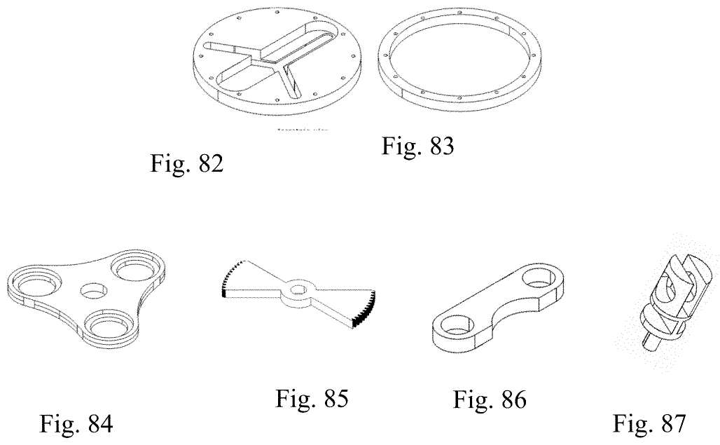

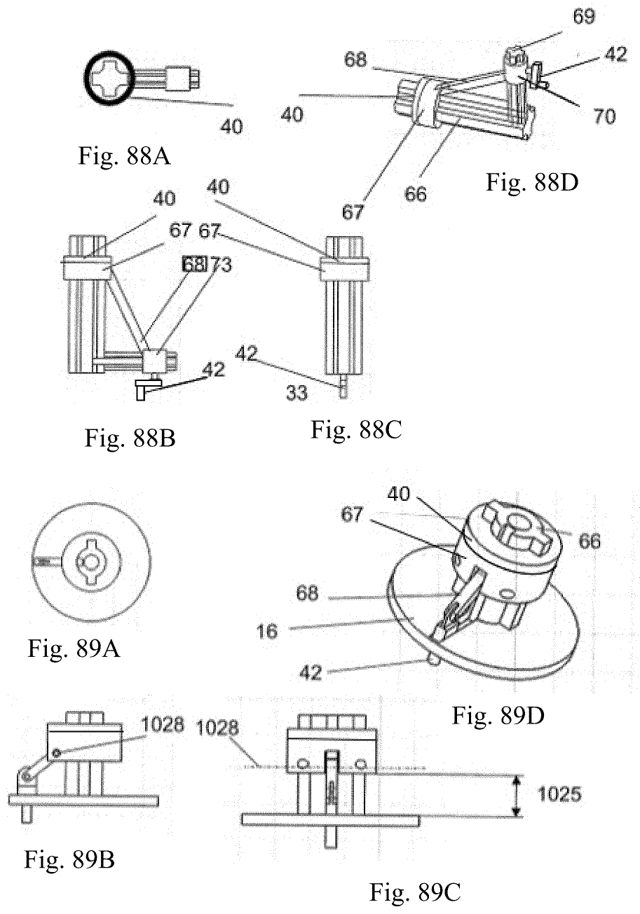

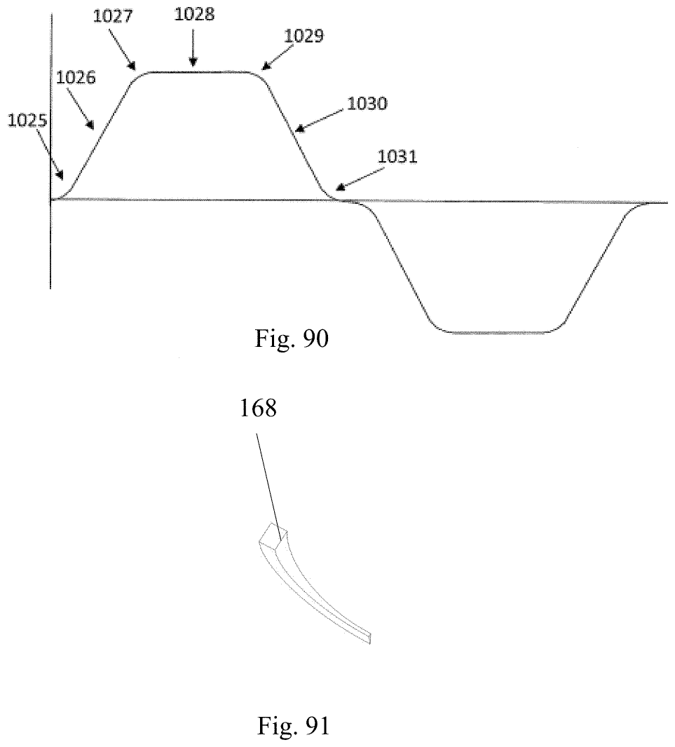

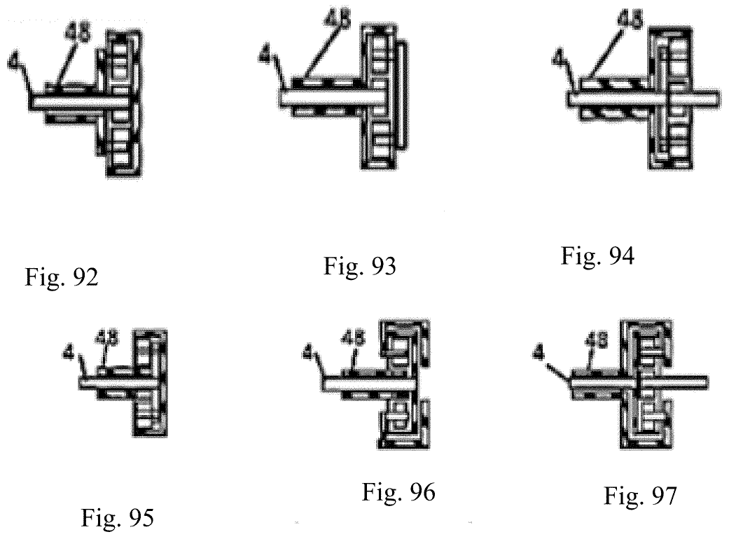

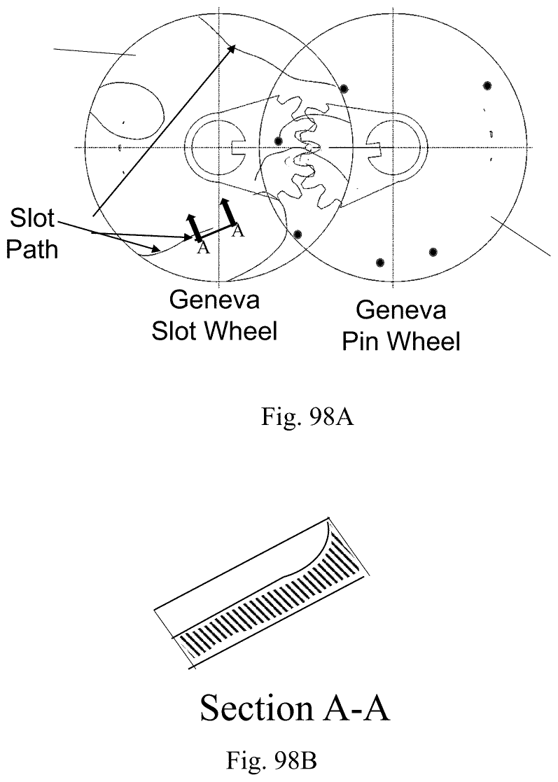

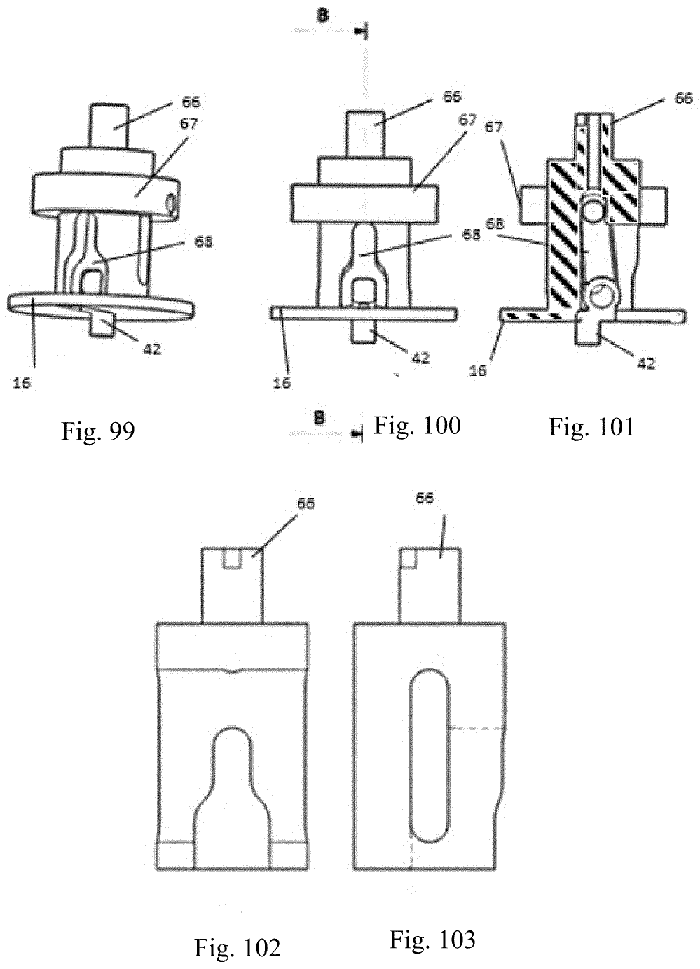

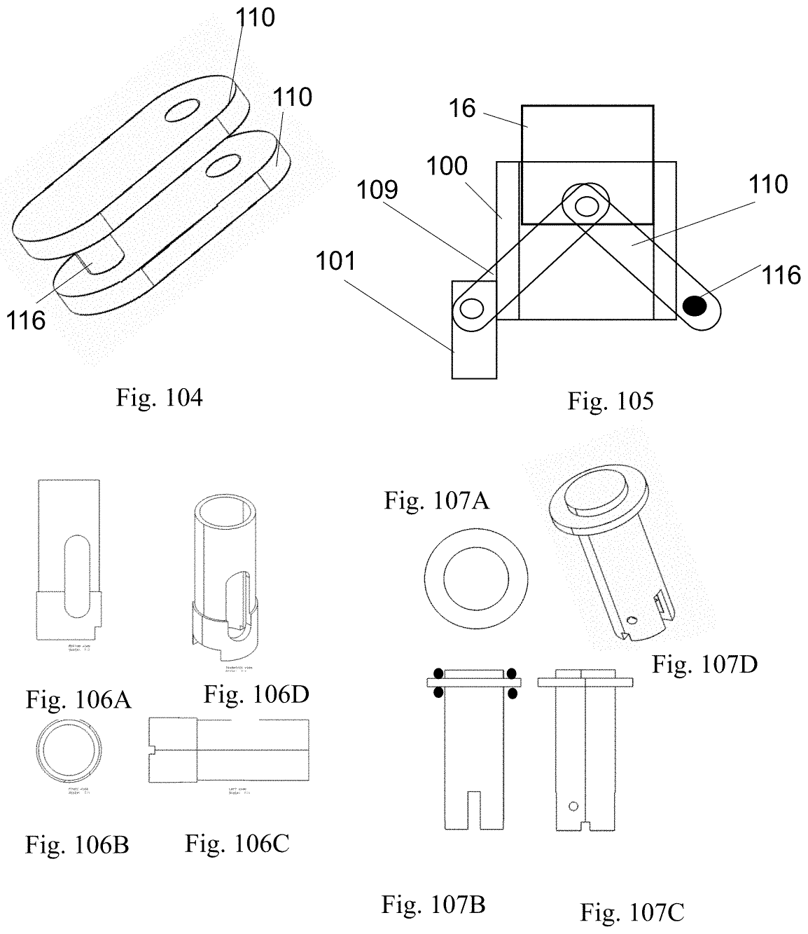

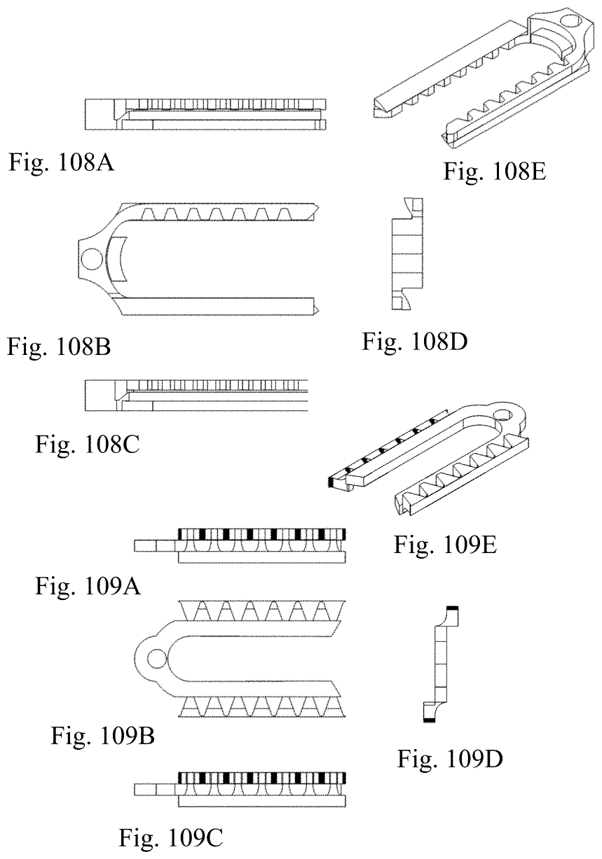

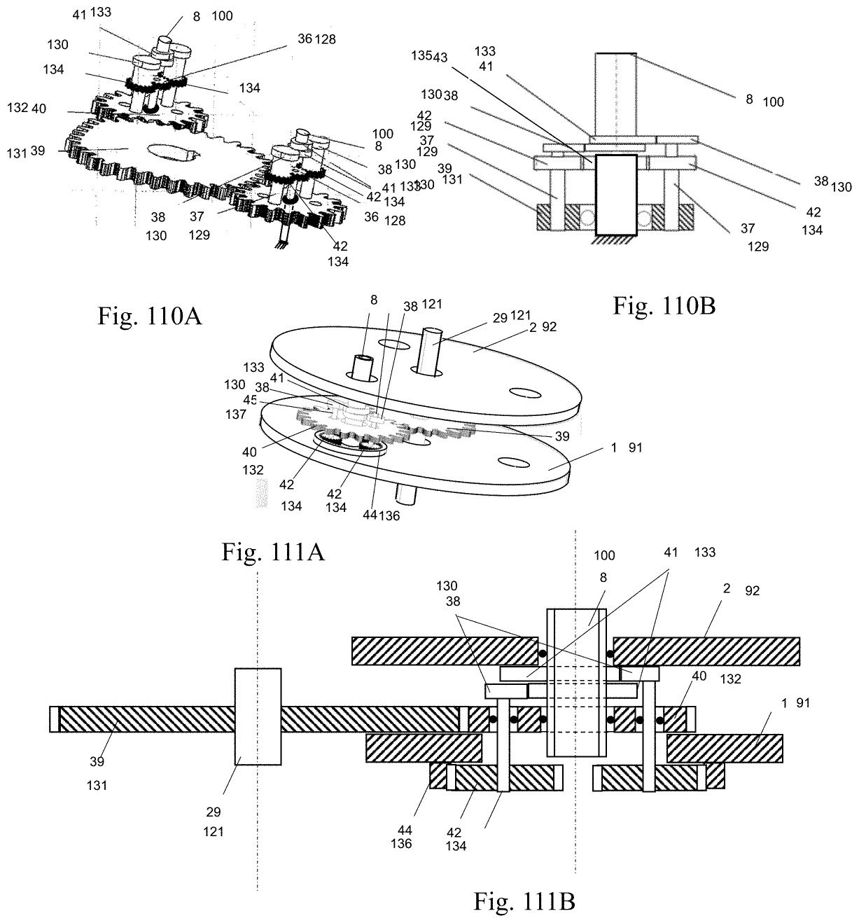

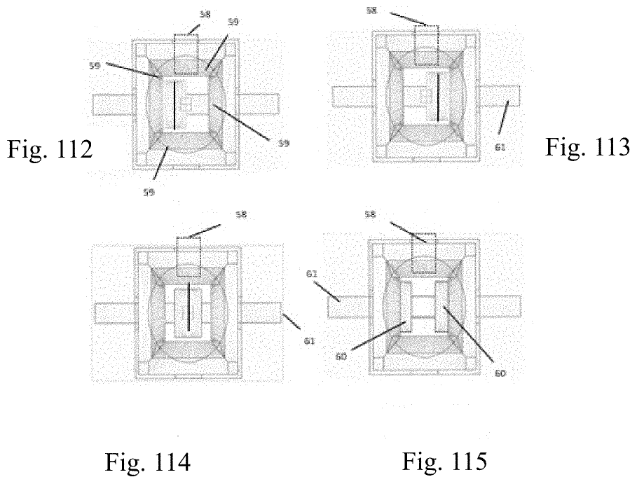

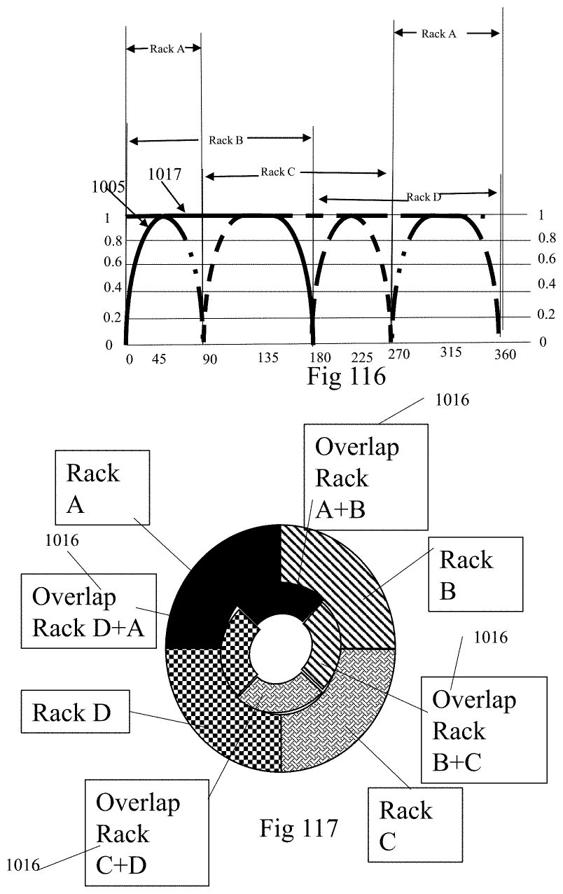

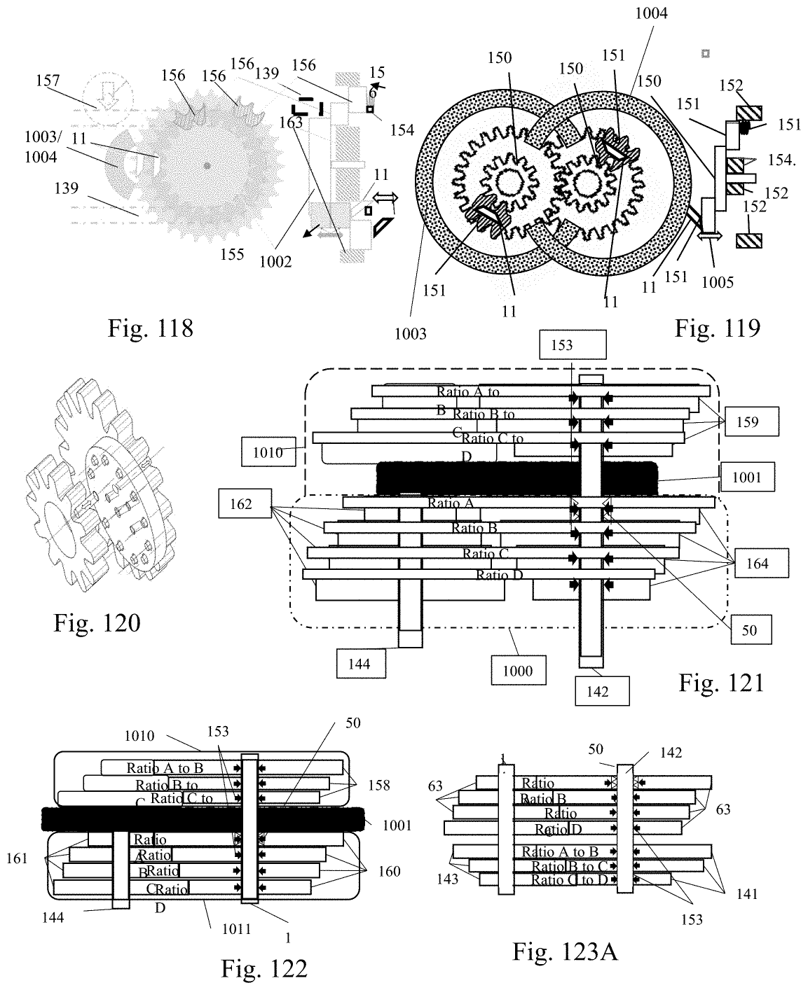

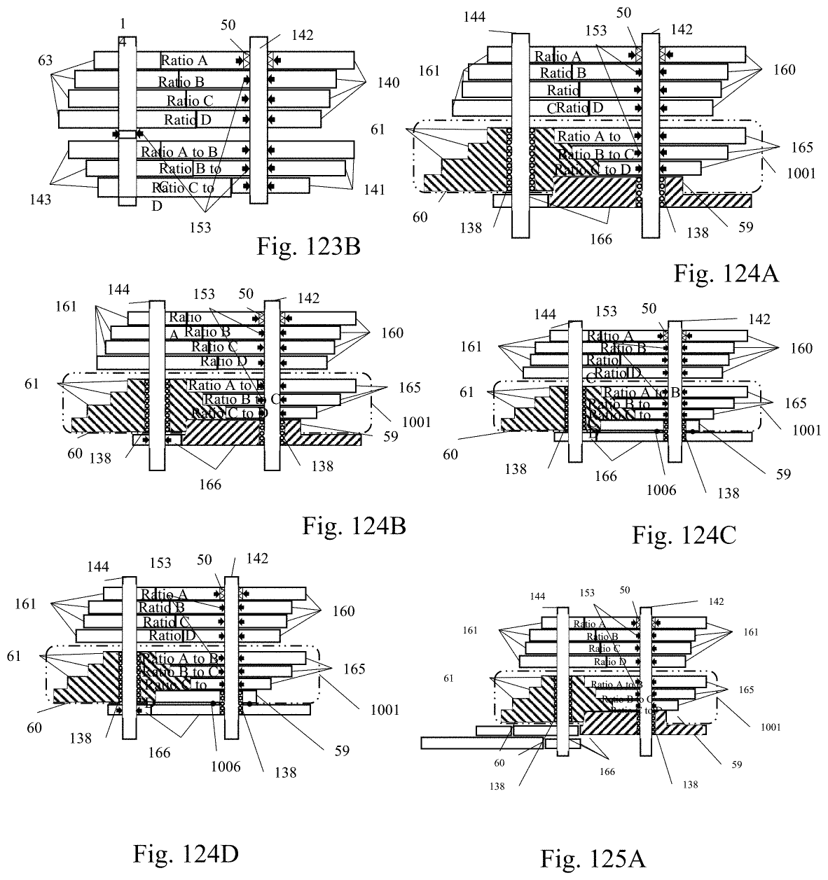

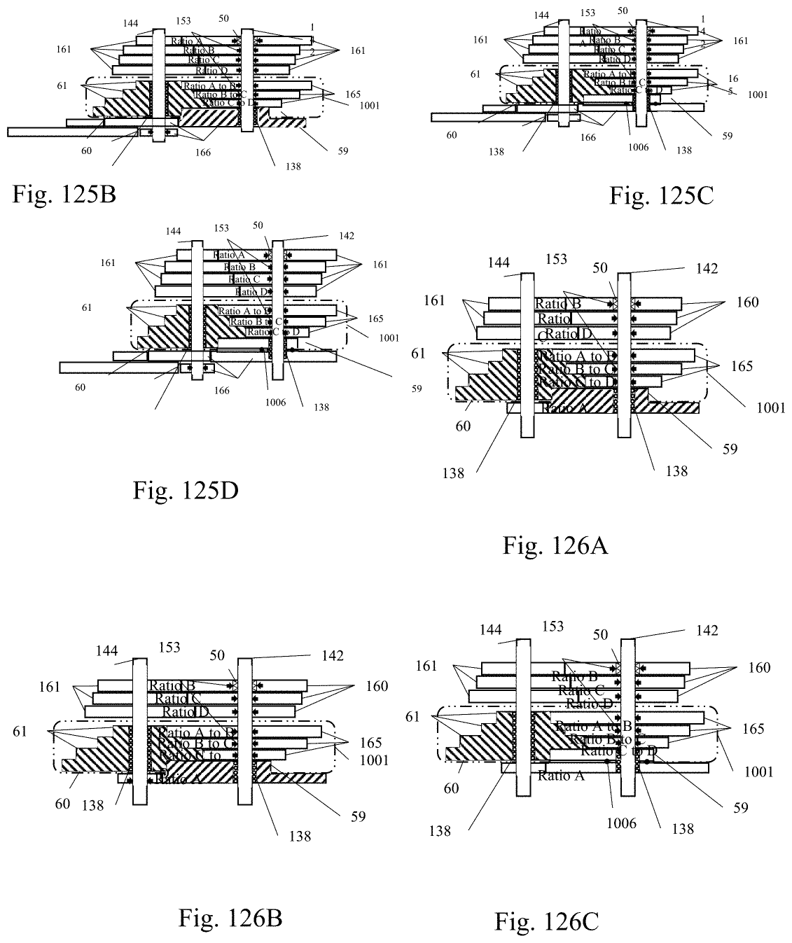

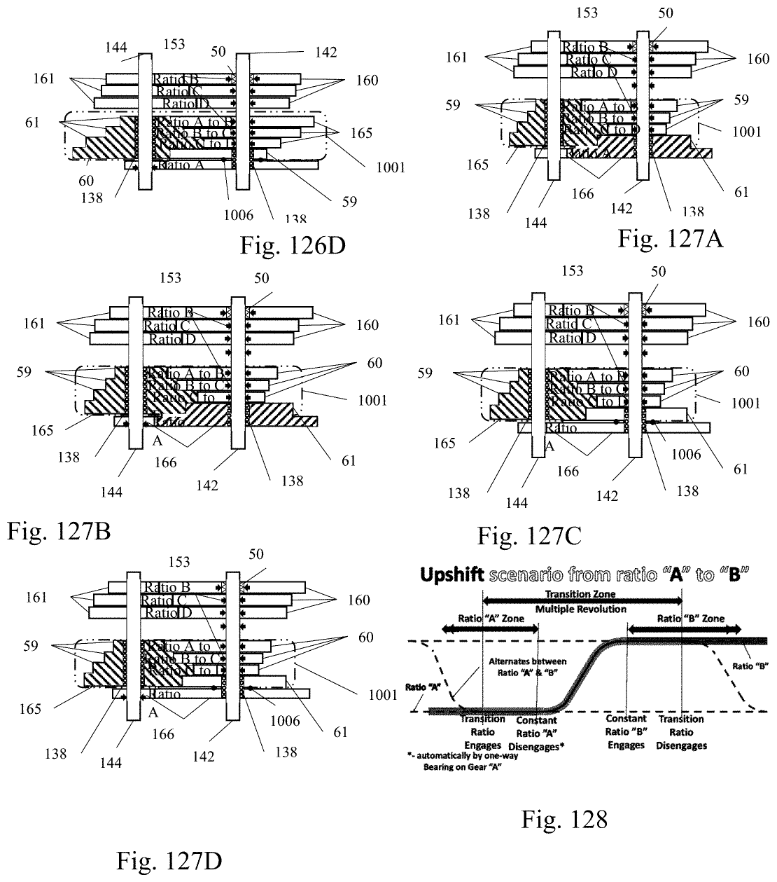

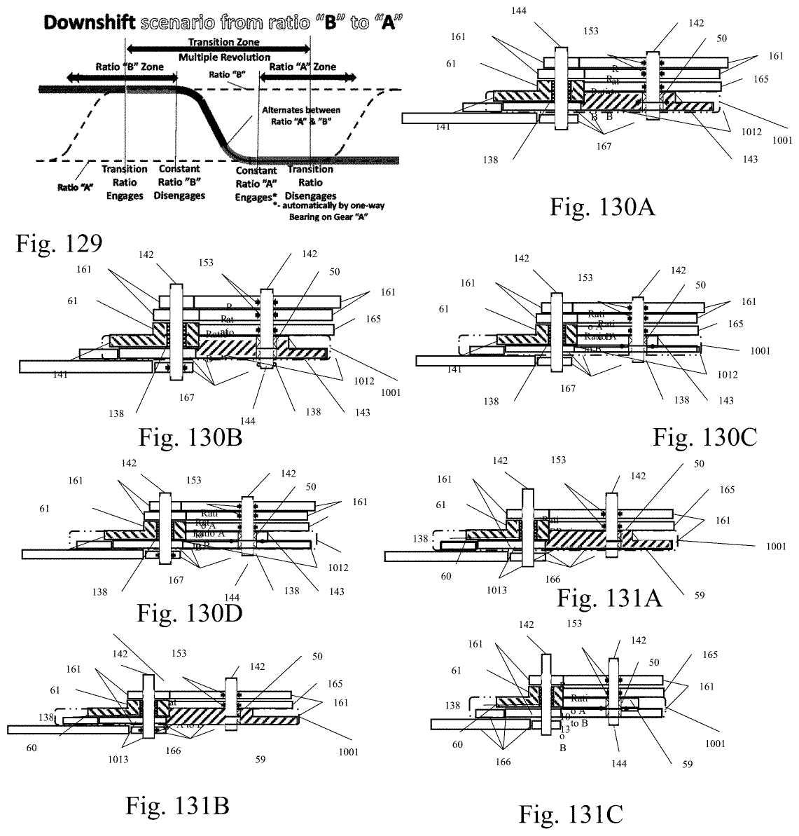

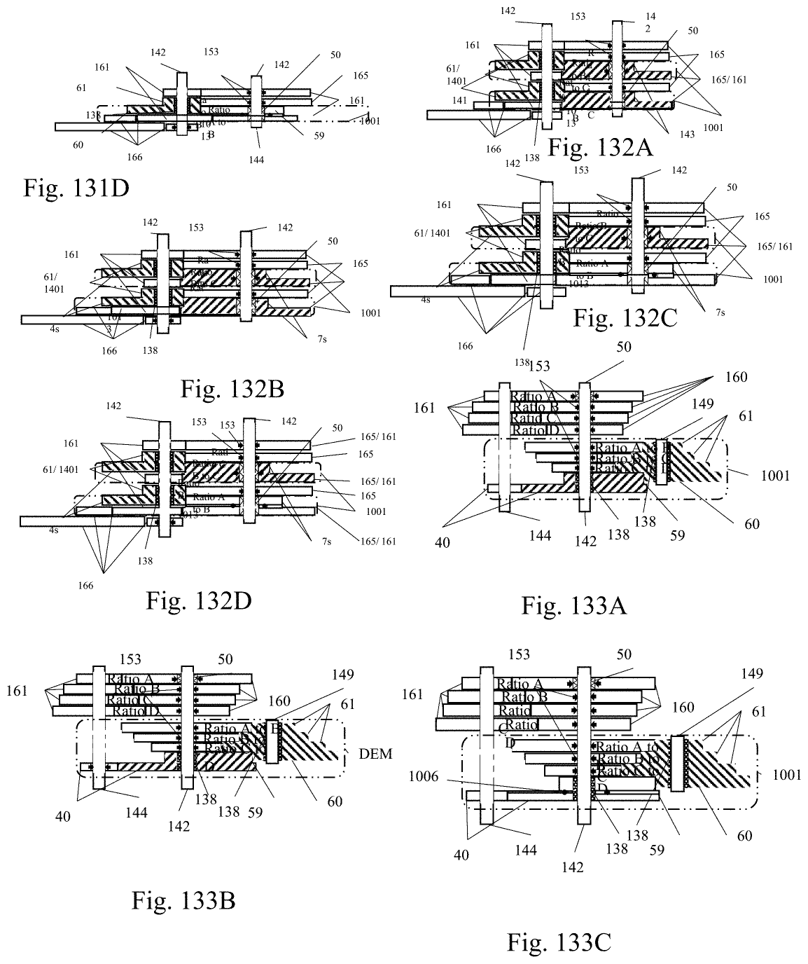

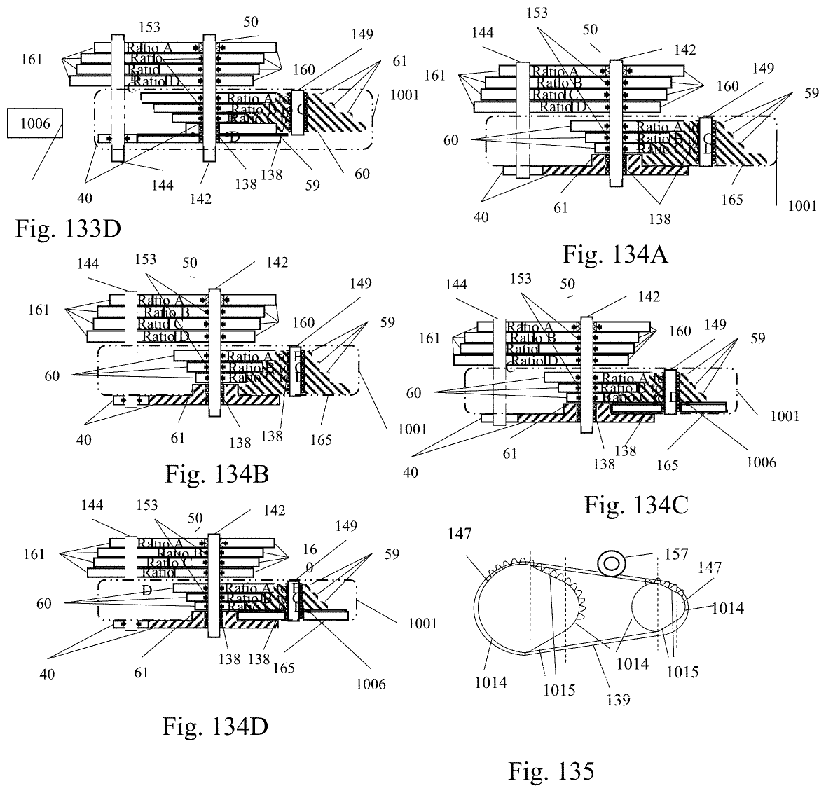

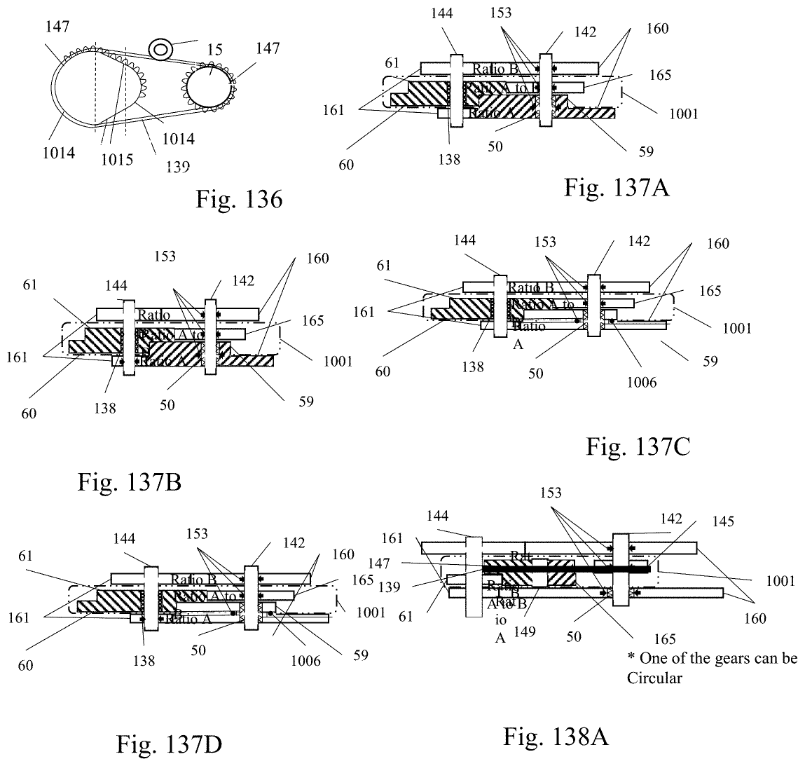

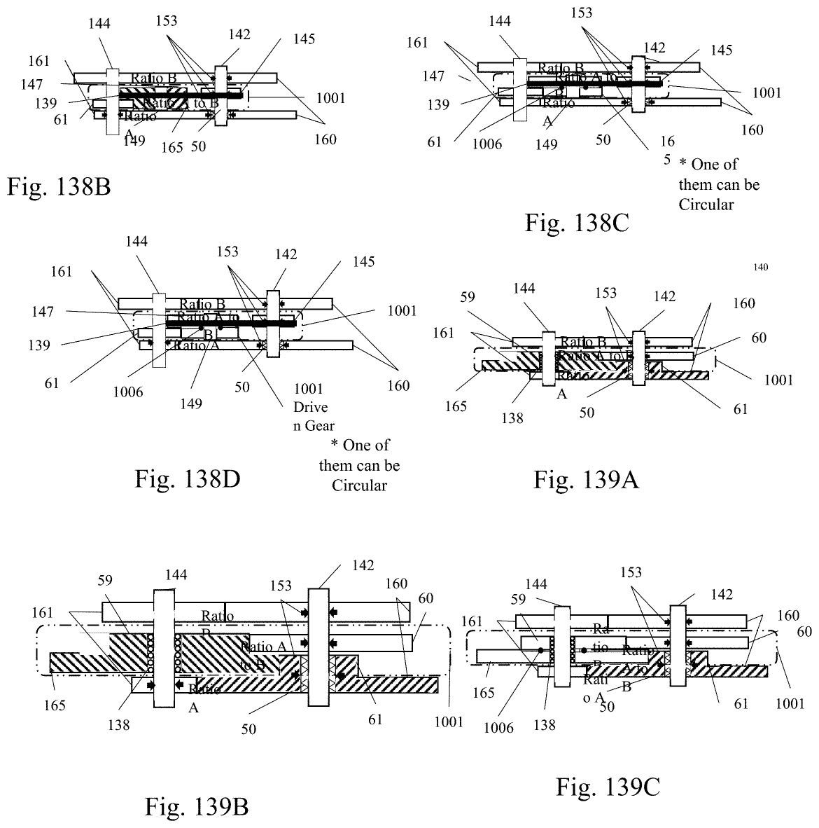

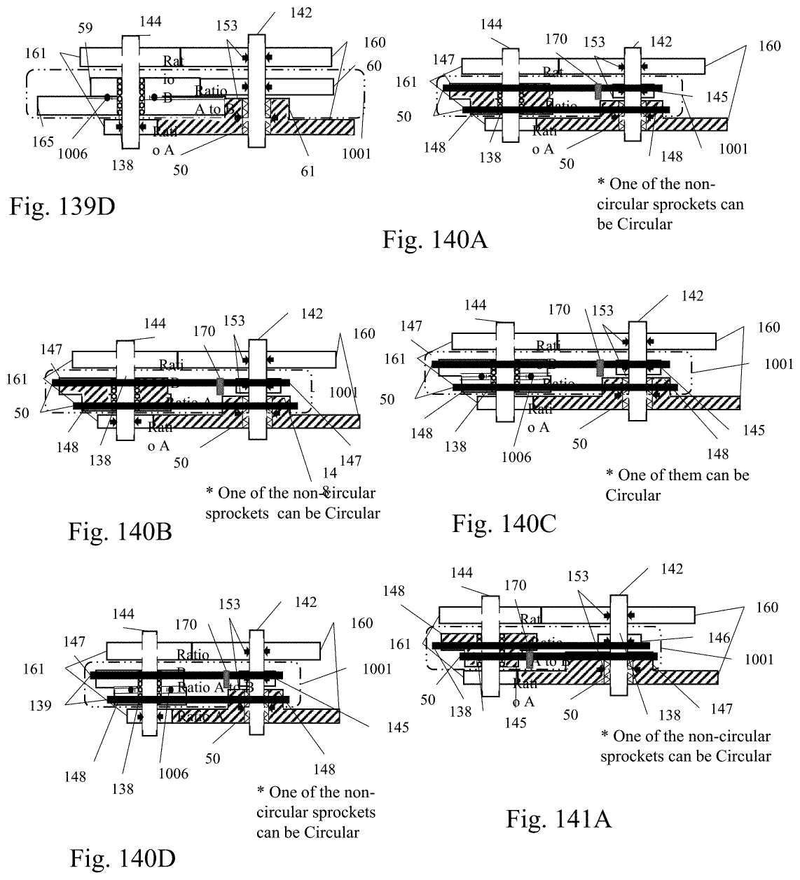

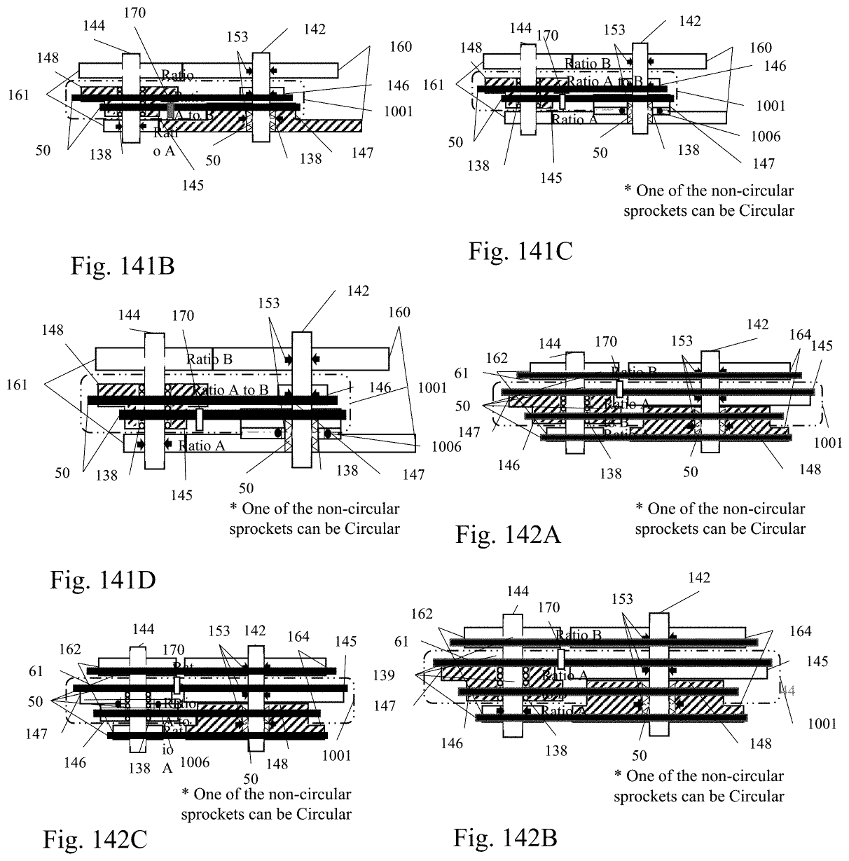

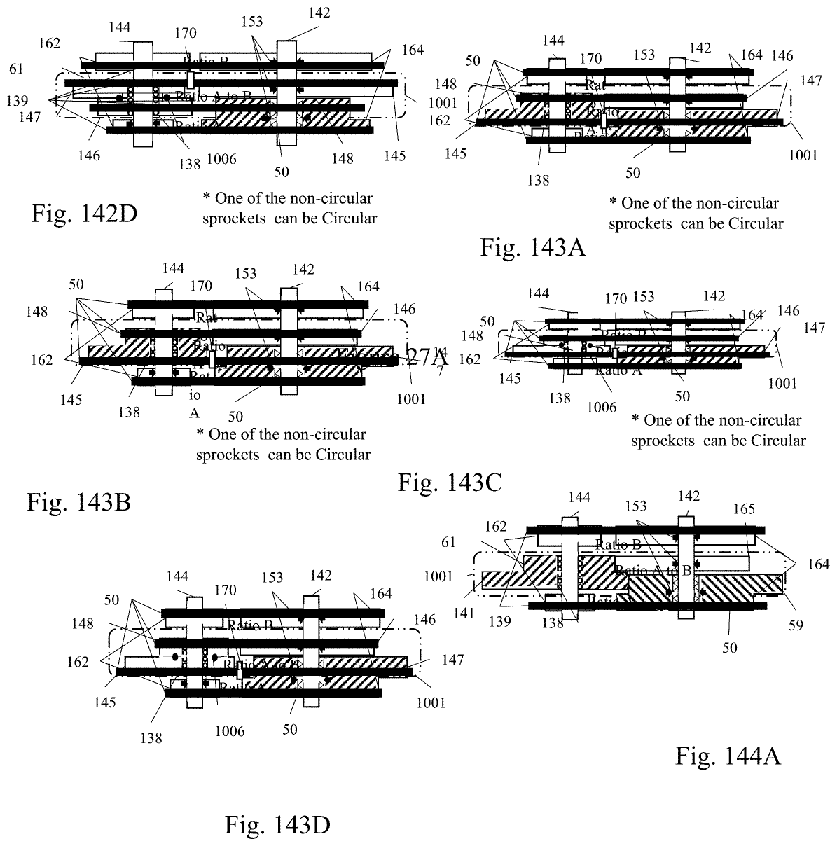

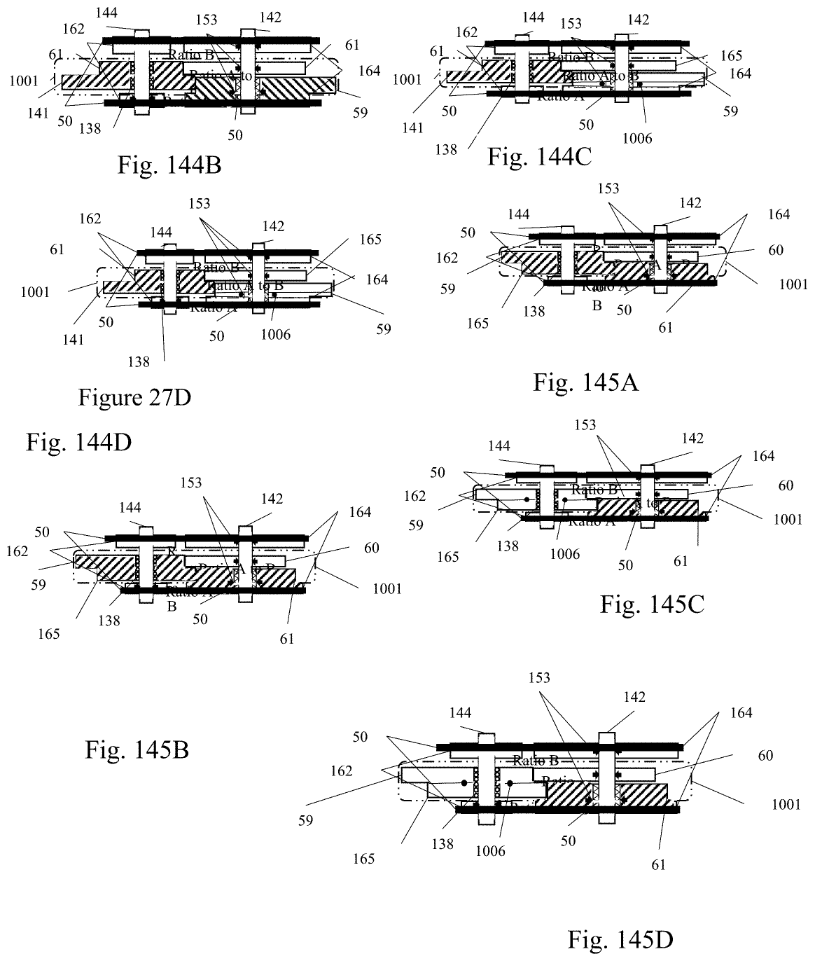

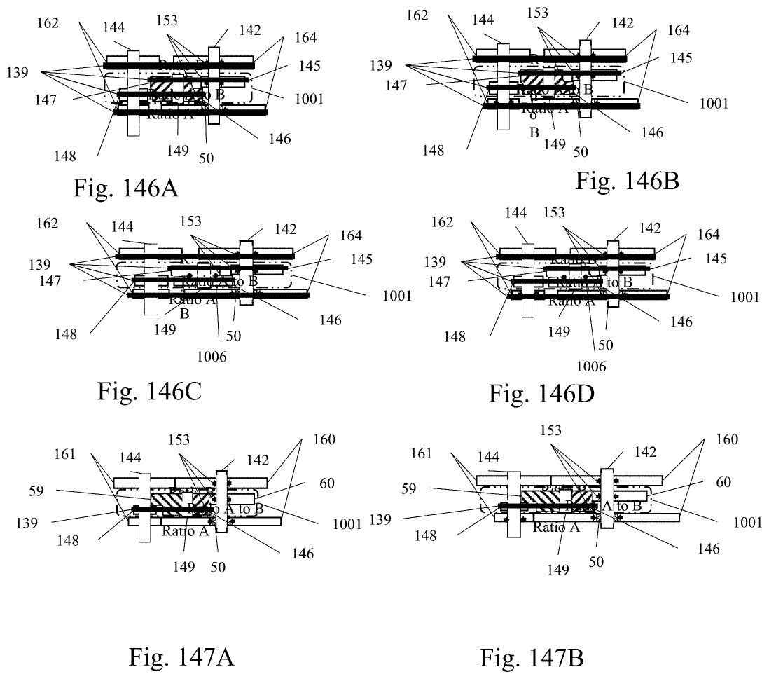

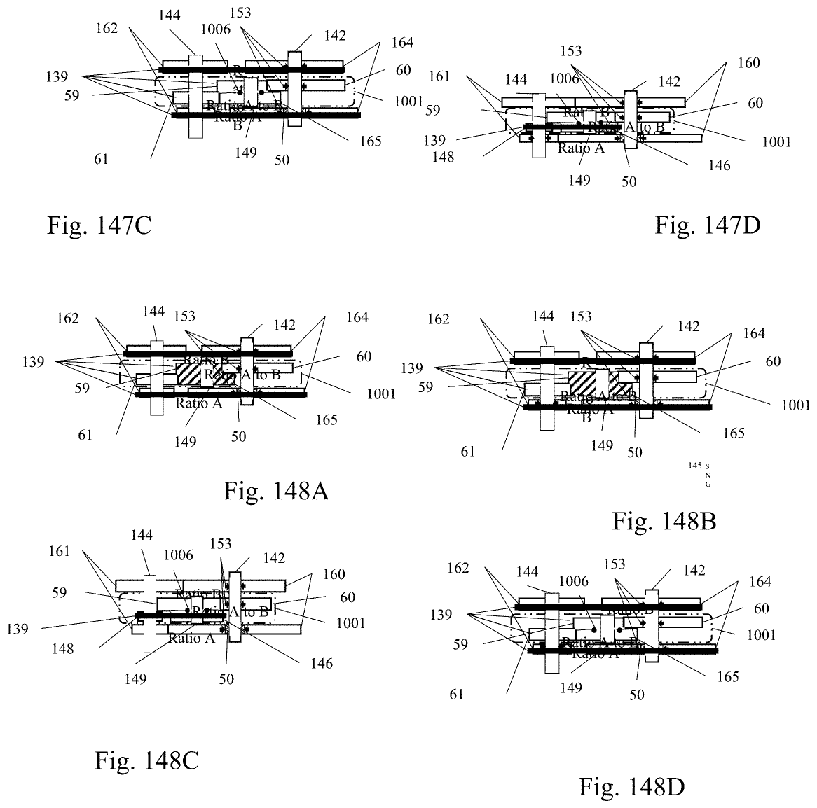

Here the gear segments each are attached to a non-circular tubular telescopic shaft 46, 47, 48 and 49. These tubular shafts 46, 47, 48 and 49 are co-axial with each other. These tubes allow axial movement of the individual segment while restricting relative rotation. These tubular telescopic shafts 46, 47, 48 and 49 are notched at the joining location where it makes a partial contact with the gear segments. This is to eliminate interference during the segments are translated individually axially. The length of the notch is slightly more that the thickness of the gear segments to clear each other. The inner most tubular shaft 46 has its orifice matching the non-circular shaft 19 or 20 it is mounted on. Such that it is rotationally locked while axially movement is possible. This construction is same for the circular and the non-circular gears which are segmented. The tubular shafts 46, 47, 48 and 49 have a flange at the attachment plane where it is bolted to the individual gear segment, as shown if FIGS. 21A, 21B and 21C. FIG. 21D shows the arrangement of the gear segments without the tubular shafts 46, 47, 48 and 49. The non-circular hole formed by these segments match the cross section of the shaft it is mounted on. The hole is clearance to allow axial translation of the segments on its shaft. This construction will allow translation of any segment at random and in any sequence.
Segmentation of the transition gear can be eliminated if either driving or the driven transition has a void zone where there is no contact with its conjugate in that zone. The transition gear can be moved into or out of operating plane 1003 when the void zone is active.
The transition gear can be placed on a non-circular tube with an orifice matching the cross section of the non-circular shaft it is placed on and it can be moved into the pocket in the large gear to decrease the overall size of the transmission. This will help if there is a limited space for the transmission in the engine compartment.
FIG. 15 shows the gear placement for the low speed. FIG. 13 shows gear placement of the up-shift, FIG. 16 shows gear placement for the downshift and FIG. 14 shows the gear placement for the high-speed.
FIG. 17, FIGS. 18A and 18B show without the low-speed zone. FIGS. 18C and 18D show without the low-speed zone and the downshift zone. If a One-way bearing 50 is placed on the low-speed driven gear the need for the low-speed zone and also the downshift zone in the transition gear can be eliminated.
FIG. 18E shows the non-circular gear with six zones that includes two void zones to allow axial translation of the non-circular gear to engage by moving co-planer and to dis-engage by moving offset
FIG. 18F shows the non-circular gear with eight zones where two void zones, one separating the low-speed zone followed by ramp-up zone and then followed high-speed zone and the other separating the high-speed zone followed by ramp-down zone and then followed low-speed zone.
The same can be achieved with a full transition gear 39 with two conjugates 40/42/44 and 41/43/45, one without up-shift zone and high-speed zone and the other without downshift zone and without the low-speed zone. They can be made co-planer with either one depending on if the transition is from low-speed to high-speed or high-speed to low-speed. Here either the full gear can be axially moved to be co-planer with either one of the conjugates with void zone able to be moved to be co-planer with the full gear. FIG. 19 shows the placement of gears for this scenario. FIGS. 20A, 20C and 20E shows active up-shift without 1 or 2 or 3 zones respectively. FIGS. 20B, 20D and 20F shows active downshift without 1 or 2 or 3 zones respectively.
This concept can be extended for multi speed transmission with more than two speeds as shown in FIG. 36.
Since an electric motor in an electric car, the RPM can be drastically increased or reduced relatively quickly when compared with an IC engine, the effect of sudden change without a transition gear can be acceptable. Only the high-speed gears can be moved into or out of their operating plane 1003 while the low-speed gears remain co-planer with a One-way bearing 50 50 placed at the low-speed driven gear. A Torsion spring 51 can be placed on the driving and the Driven Shaft 142, one close to the engine and another close to the wheel to minimize the effect of sudden impact during up-shift or downshift. As discussed above, placing a One-way bearing 50 50 on the low-speed driven gear will not permit engine braking and regenerative braking. So, a dog clutch 53 can be placed at the driven low-speed gear engaging the Driven Shaft 142 to the driven low-speed at the moment when the engine braking or the regenerative braking is required. This concept is shown in FIG. 37.
Below is the working concept of the multiple operating plane 1003 scenario with each low-speed gear pair, transition gear pair and high-speed gear pair with their own operating plane 1003.

Here up-shift is achieved by following steps: (shown in FIG. 22-FIG. 28)
a) while the low-speed circular gears are engaged.
b) When the non-circular gears reach the low-speed zone and are in the correct cyclic orientation for teeth engagement, the non-circular gears are also engaged in the non-circular gear operating plane 1003. These are brought into the operating plane 1003 in segments, when none of the teeth in that segment is in contact with any of the teeth of the conjugate gear.
c) Before the non-circular gear pair transitions to the up-shift zone the lower-ratio circular gear pair is disengaged. These are brought out of the operating plane 1003 in segments when none of the teeth in that segment is in contact with any of the teeth of the conjugate gear.
d) When the non-circular gear pair reaches the high-speed zone after passing through the up-shift zone.
e) Now, the higher gear ratio circular gear pair is also engaged, in segments when none of the teeth in that segment is in contact with any of the teeth of the conjugate gear, and
f) When the higher gear ratio circular gear pair is engaged the non-circular gears are disengaged. With this high-speed ratio is achieved.

Similarly, the downshift is achieved by the following steps: (shown in FIG. 29 through FIG. 35)
a) While the high-speed circular gears are engaged.
b) When the non-circular gears reach the high-speed zone and are in the correct cyclic orientation for teeth engagement, the non-circular gears are also engaged in the non-circular gear operating plane 1003. These are brought into the operating plane 1003 in segments, when none of the teeth in that segment is in contact with any of the teeth of the conjugate gear.
c) Before the non-circular gear pair transitions to the downshift zone the higher-ratio circular gear pair is disengaged. These are brought out of the operating plane 1003 in segments when none of the teeth in that segment is in contact with any of the teeth of the conjugate gear.
d) When the non-circular gear pair reaches the low-speed zone after passing through the downshift zone.
e) Now, the lower gear ratio circular gear pair is also engaged, in segments when none of the teeth in that segment is in contact with any of the teeth of the conjugate gear, and
f) When the lower gear ratio circular gear pair is engaged the non-circular gears are disengaged. With this low-speed ratio is achieved.

By placing a one way bearing in the largest driven gear engaging and disengaging the low-speed gears can be eliminated from all the above steps. This scenario is shown in FIG. 42 through 47 for up-shift and FIG. 48 through FIG. 53 for downshift. One drawback is that this does not allow engine braking. This can be overcome by adding a dog clutch 53 to engage the Driven Shaft 142 to the largest gear when engine braking is desired. It can be programmed to engage the dog clutch 53 during when regenerative braking is activated.

Another option for multiple plane scenario is that the circular gear pairs stay meshed in the operating plane 1003 with a dog clutch 53 placed either on the driving gear or on the driven gear and engage with its shaft only during activating the gear pair. Only the non-circular gears are moved into or out of the operating plane 1003.

In this case the up shift is achieved by following steps:
a) While the high-speed circular gear pair is engaged by engaging with its shaft via the dog clutch 53 and
b) when the non-circular gear pair reach the high-speed zone and are in the correct cyclic orientation for teeth engagement, the non-circular gears are also made to engage by moving it into the operating plane 1003, in segments, when none of the teeth in that segment is in contact with any of the teeth of the conjugate gear.
c) Following immediately and before the non-circular gear pair transitions to downshift zone the high-speed circular gear pair is disengaged by disengaging with its shaft via the dog clutch 53 and
d) when the non-circular gear pair reaches the low-speed zone after passing through the downshift zone.
e) The low-speed circular gear pair is also engaged by engaging with its shaft via the dog clutch 53.
f) While the low-speed circular gear pair is engaged the non-circular gears are disengaged by moving out of the operating plane 1003, in segments, when none of the teeth in that segment is in contact with the conjugate gear teeth, achieving low-speed ratio.

The downshift is achieved by following steps:
a) While the low-speed circular gear pair is engaged by engaging with its shaft via the dog clutch 53 and
b) when the non-circular gear pair reach the low-speed zone and are in the correct cyclic orientation for teeth engagement, the non-circular gears are also made to engage by moving it into the operating plane 1003, in segments, when none of the teeth in that segment is in contact with any of the teeth of the conjugate gear.
c) Following immediately and before the non-circular gear pair transitions to up-shift zone the low-speed circular gear pair is disengaged by disengaging with its shaft via the dog clutch 53 and
d) when the non-circular gear pair reaches the high-speed zone after passing through the downshift zone.
e) The high-speed circular gear pair is also engaged by engaging with its shaft via the dog clutch 53.
f) While the high-speed circular gear pair is engaged the non-circular gears are disengaged by moving out of the operating plane 1003, in segments, when none of the teeth in that segment is in contact with the conjugate gear teeth, achieving low-speed ratio.

Again, here by placing a one way bearing in the largest driven gear engaging and disengaging the low-speed gears can be eliminated from all the above steps. And to overcome the engine braking issue a dog clutch 53 can be used and activated at the low-speed largest driven gear when engine braking is desired, via a computer controller.

When segmentation is not desired the non-circular pair can have locally a void zone where the teeth are removed below the dedendum of the tooth. The non-circular gear does not make contact with the conjugate non-circular gear at this void zone. The non-circular gear is axially moved into or out of the operating plane 1003 when the non-circular pair is in the void zone. The non-circular gear can be in addition to the four zones or replacing one of the zones. When the void zone is replacing one of the zones, two or more non-circular gears will be conjugates to a full non-circular gear. If the void zone replaces up-shift zone this can be paired with the full non-circular gear during downshift and if the void zone replaces the downshift zone this can be paired with the full non-circular gear during up-shift. If the void zone is replacing low speed zone, a One-way bearing 50 50 installed at the largest driven gear will fulfill the need for this missing zone. Again, here by adding a dog clutch 53 to engage the largest driven gear to its shaft for engine braking.

Electric motors spin at a very high speed when compared with ICEs. In all the scenarios mentioned earlier, the shifting occurs in nano seconds. It may be beneficial if this duration can be extended so it allows more time for the shifting to occur. The following arrangements with a “duration extender module” extend the duration for the shifting. Here uninterrupted shifting of two-speed transmission is explained. The same idea can be extended to more than two-speed transmission.

The general arrangement is

1) a set of circular Transmission Driving circular gears 63 varying in size are rigidly mounted on a Driving shaft 144. A set of matching circular Transmission Driven circular gears placed on bearings so they freewheel on the Driven Shaft 142. The largest driven circular gear 140 is placed on a One-way bearing 50 on the Driven Shaft 142. The Driven Shaft 142 is placed parallel to the axis of the Driving shaft 144, at a distance (CTR) equal to the sums of the radii of the conjugate pair. These driven gears have the ability to engage or disengage with the Driven Shaft 142 via a dog clutch 53. Here there is no need for a synchronizer since the engagement and dis-engagement occurs when the shaft and the driven gears rotate at a same angular velocity. So just a dog clutch 53 will be sufficient. There is one dog clutch 53 for each one of the driven gears so that they can be engaged or disengaged independently in any order with respect to each other. For every two pairs of transmission driving and driven circular gears with adjacent gear ratio value, there is a Duration Extender Module.

The duration extender module comprises
1) Duration Extender Module Driving Non-Circular gear 59 placed on a bearing on the Driven Shaft 142 and is rigidly attached to the larger driven gear of the low-speed gear pair. This larger driven gear of the low-speed gear is placed on a One-way bearing 50 on the Driven Shaft 142. It is meshed with the duration extender module driven non-circular gear 60 that is placed on the driven gear with a bearing so that it free wheels. The non-circular gear pair has four gear ratio zones.
They are in the order
1) low-speed zone,
2) up-shift zone,
3) high-speed zone and
4) downshift zone.

Here the low-speed zone has the lower of the two gear ratios of the two circular gear pairs. The high-speed zone has the higher of the two gear ratios of the two circular gear pairs. They are separated by ramping up from lower ratio to the higher ratio. This is used during an up-shift operation. The ramping down from the higher ratio to the lower ratio. This is used during a downshift operation.

The driven non-circular gear 141 is meshed with the Driving Non-Circular gear 143 and is placed on the driving shaft with a bearing, so it freewheels. A Duration Extender Module Driving Circular Gear 61 axially connected to the Duration Extender Module Driven Non-Circular Gear 60. This meshes to a corresponding Duration Extender Module Driven Circular Gear 62 that is mounted on the Driven Shaft 142. It is rotationally locked with the ability to axially translate to be co-planer to engage or to be offset to disengage with the freewheeling Duration Extender Module Driving Circular Gear 61.

with this arrangement the angular velocity of the Duration Extender Module Driving Circular Gear 61 constantly alters between the angular velocity of the two circular transmission driving gear ramping up and down. Here the Duration Extender Module Driving and driven Circular Gears 61 and 62 have identical pitch curve as the higher speed transmission driving and driven circular gears respectively.

The same arrangements can be used with three dog clutch 53 which connect the Duration Extender Module Driven Circular Gear 62 and both the transmission gears to the Driven Shaft 142 individually. Since moving of the Duration Extender Module Driven Circular Gear 62 axially require segmentation, the other option is to use dog clutch 53 individually.

Here the sequence for an uninterrupted shift from existing gear ratio to a targeted gear ratio, is achieved by,

A) With the Driven Shaft 142 engaged to one of the existing Transmission Driven gears.

B) when the angular velocity of the Duration Extender Module Driving Circular Gear 61 is same as the angular velocity of the currently engaged Transmission Driving Gear and synchronized the Duration Extender Module Driven Circular Gear 62 meshes with Duration Extender Module Driven Circular Gear 62 and

C) immediately the currently engaged Transmission Driven Gear is disengaged from the Driven Shaft 142 while the currently engaged Duration Extender Module Driven Circular Gear 62 is still in the same region and

D) after the Duration Extender Module Driven Circular Gear 62 passes through the ramp region and reaches and is well within region of the targeted Transmission Driven Gear's angular velocity and synchronized, the Transmission Driven Gear with the targeted ratio is also engaged to the Driven Shaft 142 and

E) immediately the Duration Extender Module Driven Circular Gear 62 is disengaged from the Driven Shaft 142 while in the same region achieving uninterrupted shifting.

Double DEM Transmission with Non-Circular Gears

A set of driving circular gears 63 are rigidly mounted on a drive shaft 64. Correspondingly, there is a set of freewheeling conjugate driven gears 65. A double DEM driving circular gear 66 is axially attached to one of them. The freewheeling conjugate driven gears 65 and the double DEM driving circular gear 66 each use a dog clutch 53 53 to engage or disengage with the intermediate shaft 67 they are mounted on. The largest gear is placed on a One-way bearing 50 50. A segmented freewheeling double DEM driven gear 68, that is capable of moving axially out of or into an operating plane 1003 with the double DEM driving circular gear 66, is axially attached to a freewheeling DEM driving non-circular gear 69. The segmented freewheeling double DEM driven gear 68 and the double DEM driving circular gear 66 are both placed on an output-shaft 70. The freewheeling DEM driving non-circular gear 69 meshes with a freewheeling DEM driven non-circular gear 71 which is axially linked with a freewheeling DEM driving circular ring gear 72. Both the freewheeling DEM driving circular ring gear 72 and the freewheeling DEM driven non-circular gear 71 are both mounted on the drive shaft 64. The DEM driving circular ring gear 72 meshes with a DEM intermediate circular planet gear 73 rigidly mounted on the intermediate shaft 67 where a driving final output gear 75 that is rigidly mounted on the intermediate shaft, drives a driven final output gear 76.

Single DEM Transmission with Geneva Wheels

A set of driving circular gears 63 are rigidly mounted on a drive shaft 64. There is a set of freewheeling conjugate driven gears 65 each having a dog clutch 53 to engage or disengage with an output shaft 70 they are mounted on. The largest gear is placed on a One-way bearing 50 and is axially attached to a DEM driving Geneva pin wheel with retractable pins 79. The retractable pins are operated via rotationally fixed axially movable spiral ramp/cam 168 or solenoids activated by position sensor sensing angle of the drive shaft 64 and driven shaft. The pins are extended only during when the pins are in contact with the slot in the region where the pin and wheel are in contact. When the pins are not in contact with the slot, the pins are retracted in that region. Also, the slot can ramp up when the pin and slot engagement region at the near end such that the pins are pushed out to the retracted position. The DEM driving Geneva pin wheel 79 engages with DEM driven Geneva slot wheel 81, mounted on a Geneva shaft 80 along with a DEM uninterrupted shifting wheel 82 that drives a driven final output gear 75 which is mounted on the output shaft 70.

The Geneva pin wheel has non-circular pins that are capable of extending into and retracting from the Geneva slot wheel and driving it. The Geneva slot wheel having at least one slot when engaged with the pin causing the wheel to ramp up from R1 to R2 and at least one slot causing the wheel to ramp down from R2 to R1, where R1 and R2 are the ratio of the driving circular gears to the conjugate driven gears.

The sequence for an uninterrupted shift from existing gear ratio to a targeted gear ratio, is achieved by,

A) With the intermediate Shaft engaged to one of the conjugate driven gears,

B) when the angular velocity of the driven final output gear is same as the angular velocity of the currently engaged conjugate driven gear and synchronized to match the position of the pin and the slot the driven final output gear engages with the intermediate shaft via a dog clutch and

C) immediately the currently engaged conjugate driven gear is disengaged from the intermediate shaft while the currently engaged driven final output gear is still in the same region and

D) after the driven final output gear passes through the ramp region and reaches and is well within region of the targeted conjugate driven gear's angular velocity and synchronized, the conjugate driven gear with the targeted ratio is also engaged to the intermediate Shaft via a dog clutch and

E) immediately the driven final output gear is disengaged from the intermediate shaft while in the same region achieving uninterrupted shifting.

Double DEM Transmission with Geneva Wheels

A set of driving circular gears 63 are rigidly mounted on a drive shaft 64. Correspondingly, there is a set of freewheeling conjugate driven gears 65. A double DEM driving circular gear 66 is axially attached to one of them. The freewheeling conjugate driven gears 65 and the double DEM driving circular gear 66 each use a dog clutch 53 to engage or disengage with the intermediate shaft 67 they are mounted on. The largest gear is placed on a One-way bearing 50. A double DEM driven gear 83 meshing with the double DEM driving circular gear 66, is axially attached to a DEM driving Geneva pin wheel with retractable pins 79. The double DEM driven gear 83 and the double DEM driving circular gear 66 are both placed on a Geneva shaft 80. The DEM driving Geneva pin wheel 79 engages with a DEM driven Geneva slot wheel 81 which is axially linked with a DEM uninterrupted shifting wheel 82 via a train of gears 52. Both the DEM uninterrupted shifting wheel 82 and the DEM driven Geneva slot wheel 81 are both mounted on the intermediate shaft 64. A driving final output gear 75 that is rigidly mounted on the intermediate shaft 67, drives a driven final output gear 76 rigidly mounted on an output shaft 70.

Here the Geneva pin wheel has non-circular pins that are capable of extending into and retracting from the Geneva slot wheel driving it. When the pins are retracted the Geneva pin wheel does not engage with the Geneva slot wheel. The pins are extended only during when the pins are in contact with the slot in the region where the pin and wheel are in contact. When the pins are not in contact with the slot, the pins are retracted in that region. Also, the slot can ramp up when the pin and slot engagement region at the near end such that the pins are pushed out to the retracted position. The pins are extended only when the shifting is desired. The Geneva slot wheel has at least one slot causing the wheel to ramp from an angular velocity ratio of 1:1 between the Geneva pin wheel and the Geneva slot wheel to a ratio 1:(R1/R2), and at least one slot causing the wheel to ramp from (R1/R2):1 to a ratio 1:1, where, R1 and R2 are the angular velocity ratio of the driving circular gears 63 to the conjugate driven circular gears 62.

The sequence for an uninterrupted shift from existing gear ratio to a targeted gear ratio, is achieved by,

A) With the intermediate Shaft engaged to one of the conjugate driven gears,

B) when the angular velocity of the driving final output gear is same as the angular velocity of the currently engaged conjugate driven gear and synchronized to match the position of the pin and the slot the driving final output gear engages with the intermediate shaft via a dog clutch and

C) immediately the currently engaged conjugate driven gear is disengaged from the intermediate shaft while the currently engaged driving final output gear is still in the same region and

D) after the driving final output gear passes through the ramp region and reaches and is well within region of the targeted conjugate driven gear's angular velocity and synchronized, the conjugate driven gear with the targeted ratio is also engaged to the intermediate Shaft via a dog clutch and

E) immediately the driving final output gear is disengaged from the intermediate shaft while in the same region achieving uninterrupted shifting.

Geneva Wheel Mechanism with NO DEM with Geneva Pin and Slot Wheel

A set of driving gears and one or more Geneva pin wheels with retractable pins are rigidly mounted on a drive shaft and a set of conjugate driven gears along with one or more Geneva slot wheels is mounted on the Driven Shaft 142. Either the driving gears, or the driven gears, or both driving and driven gears have the capability to selectively engage with their respective shaft via a clutch/dog clutch or any other means. The Geneva pin wheels or slot wheels or both pin and slot wheels are either rigidly attached via a dog clutch or clutch or any other means or have the capability to engage or disengage with their respective shaft. If there are only two angular velocity ratios for the transmission, the most inexpensive option with the least number of components is to make the largest driving gear with the ability to selectively engage to its shaft and the largest driven gear with a one way bearing, and the Geneva pin and slot wheels rigidly connected to their respective shafts. The path of the Geneva slots is shaped such that the pin wheels rotate the slot wheels at constant angular velocity ratios of the gear pairs sandwiching a ramp up or a ramp down region to reach the targeted ratio. These are functional regions since they are used to transition the angular velocity ratio from one value to the immediate next value required. The Geneva pin and wheel mechanism has two or more regions of constant angular velocity ratio and two or more regions of ramp. Having a separate Geneva pin wheel and slot wheel for each ramp, whether up or down, will be the most practical and easiest way to implement this. The Geneva pins are retractable and can be circular or non-circular in cross-section. If the Geneva pins are non-retractable, an alternative way to achieve the above is by using dog clutch or synchronized clutch or similar devices. Ramps on the slots can be used to push the Geneva pin to retracted position as shown in 98B and spring-loaded gates on the slot be used to prevent the Geneva pin entering into another slot when the slot paths cross each other as shown in 67A, B and C. 67A shows a “door” type gate and 67B&C show lift gate type which are activated by the Geneva pin. The spring brings the gate to original position after the pin passes thru.

The transition from lower to higher angular velocity ratio by ramping up is shown in FIG. 65A. The transition from higher to lower angular velocity ratio by ramping down is shown in FIG. 65B. In the region denoted by 1000 only Geneva pin and slot wheels are active and engaged with the Geneva pins are extended. In the region denoted by 1002 only driving and driven transmission gears are active and engaged. In the region denoted by 1001, Geneva pin and slot wheels as well as driving and driven transmission gears are active and engaged with an overlap and the Geneva pins are extended.

FIG. 65C shows the transition from lower to higher angular velocity ratio by ramping up followed by transition from higher to lower angular velocity ratio by ramping down. FIG. 65E shows more than two areas of constant angular velocity ratio and transition from lower to higher angular velocity ratio and transition from higher to lower angular velocity ratio between the regions of constant angular velocity.

The sequence for achieving an uninterrupted shift from existing gear ratio to a targeted gear ratio is as follows:

A) With the existing driven gear engaged to its shaft and the conjugate driving gear,

B) When the Geneva pin and slot wheels are oriented to synchronize with the existing gear ratio, the Geneva pins are extended to engage with the slot that ramps to the targeted ratio ramping from existing ratio to the targeted ratio

C) Immediately either the currently engaged conjugate driven gear or the driving gear is disengaged from its shaft and the angular velocity ratio of the Geneva pin and slot wheels ramps to the targeted ratio.

D) when the Geneva pin and slot wheel mechanism is well within region of the targeted ratio and synchronized with the targeted ratio, the driving gear and the conjugate driven gear with the targeted ratio are also engaged to their respective shafts via a dog clutch or clutch or any other means and

E) Immediately the Geneva slot and pin wheels are disengaged by retrieving the pins (84) achieving uninterrupted shifting.

For “N” number of gear pairs 87 we can use “N−1” Geneva pin and slot wheels where each pair is used to ramp us as well as ramp down. We will need twice the number of Geneva pin and slot wheels if each is used to either ramp up or ramp down and not both. NO DEM Geneva pin/slot wheel assembly 88 is shown in FIGS. 57A and 57B.

Alternatively, all the driving and driven gears and the Geneva pin and slot wheels all have an ability to engage or disengage with their respective shaft via a dog clutch or synchronous clutch and all the driven gears and the Geneva slot wheels are rigidly mounted onto the Driven Shaft 142s or all the driven gears and the Geneva slot wheels are have an ability to engage or disengage with the driving shaft via a dog clutch or synchronous clutch and all the driven gears and the Geneva slot wheels are rigidly mounted onto the driven shafts 142 (vice versa). The largest driven gear is placed on a one-way bearing so that disengaging that gear to its shaft is unnecessary. The retractable pins are activated via rotationally fixed axially movable spiral ramp/cam 168 or solenoid valves controlled by a controller that uses position sensor placed on the gears to determine the timing of extending or retracting the pins. In addition to the functional region there is a non-functional region where the Geneva pin wheel has additionally one or more pins on the Geneva pin wheel and additional one or more slots on the Geneva slot wheel to rotate Geneva slot wheel rapidly and simultaneously disengaging the Geneva pin and slot wheels to complete a full rotation such that the rotation ratio of the Geneva pin wheel to the rotation of the Geneva slot wheel is an integer or a reciprocal of an integer. These slots can be radial since this a nonfunctional region and the rate at which this is achieved is not important.

In all the scenarios, instead of using retracting pins an alternate way to disengage the Geneva wheels can be achieved by disengaging the Geneva pin and slot wheels with a clutch or dog clutch.

All gears are either installed rigidly or via a one way bearing or with a clutch with synchro or dog clutch, to its shaft. The one-way bearing includes the one way bearing that is capable of all the selectable operating modes such as freewheeling clockwise, freewheeling counterclockwise, freewheeling both clockwise and counterclockwise and totally locking. This technology is currently known as multi-mode clutch module (MMCM) that uses a cam to select the operating mode. This makes the one-way bearing switch mode when the engine or the electric motor switches direction.

The Geneva pin wheel has spiral flutes on the ID. A matching spiral fluted collar 89 is sandwiched between the Geneva pin wheel and the driving shaft. An axial movement of the spiral fluted collar with respect to the Geneva pin wheel will cause a rotation of the Geneva pin wheel with respect to the driving shaft. The ability to rotate Geneva slot wheel with respect to its shaft will allow precise engagement of the pins to the Geneva slot wheel 61. This also can be achieved with a stepper motor with position sensors. There are also several other ways to achieve this. The Geneva pinwheel and the slot wheel can also be rotated with respect to their shafts with a stepper motor 90 while they are disengaged with their respected shafts via dog clutch/synchronizer clutch. After they are oriented to a precise engaging location for the transition, they can be engaged back to their shafts via the dog clutch/synchronizer clutch as shown in FIGS. 61C and 61D. Another option is Geneva pin wheel placed on a one-way bearing to its shaft and using the stepper motor the Geneva pin wheel can be rotated in the direction that will not have any effect on the shaft it is mounted on via the one-way bearing.

To allow repetition of the up-shift or down shift scenario it is desirable to have the driving and driven pin and slot wheel to complete an integer rotation. In other words, the rotation ratio of the driving and driven pin and slot wheel is an integer or a reciprocal of an integer. To bring the driving and the driven pin and slot wheel to an integer or a reciprocal of an integer rotation a partial circular gear 85 and 86 (driving and driven) or an additional a radial or straight Geneva slot/slots and pin/pins can be used to bring the driven slot wheel to an integer or a reciprocal of an integer rotation (as shown in FIGS. 60 & 61). If the path of the slot interferes with any pin at any point during the upshift/down shift cycle, the pins can be retracted to eliminate the interference.

In all scenarios smallest driving gear and/or largest driven gear [any driving and/or driven] are optionally placed on a one-way bearing.

In all scenarios, all gears have the option of having a one way bearing to the shaft.

Geneva pin wheel and Geneva slot wheel with a slot with a specific geometry/path can be used in place of non-circular gears or circular gears.

### III) Utilizing Geneva Wheel Mechanism for Infinitely Variable Transmission

To briefly describe this invention is an Infinitely Variable Transmission (IVT). Unlike existing CVT designs, this particular design does NOT depend on friction to transmit power. Most of the CVTs that exist today depend on friction to transmit power and therefore cannot be used where there is a need to transmit high power at low speed. Due to this advantage, it is possible to use this invention where high torque transmission is required. Co-axial input and output can be achieved with this layout.

The working of this CVT can be described by the following simple sequential of operations.

a) A crank pin 101 (FIG. 70B), revolves around the longitudinal axis of an Input disk 102 (FIG. 76) or an Input shaft 100 (FIG. 106) at an offset distance as shown in FIG. 70A, and this offset distance can be altered. The offset distance ranges from zero to a non-zero value. The concept described in this operation exists in several other patent application US 20100199805, U.S. Pat. No. 9,970,520 etc.

b) This offset Crank pin 101 is caged in
1) the Input disk 102 or alternatively slides on a Crank pin shaft 115, and
2) a slot of a Slotted Rack holder 103 (FIG. 74A-74C).

The input shaft 100 is slotted to allow the crankpin and link 109 to pass through it, allowing the longitudinal axis of the input shaft 100 or the input disk to be co-axial with the longitudinal axis of the crank pin 101. The Slotted rack holder 103 is restricted such that it can move only in the direction that is normal to its slot. A Rack 104 is fastened to the Slotted Rack holder 103, such that the Rack 104 is parallel to the Slotted rack holder's 44 direction of movement. In the alternative construction, the Crank pin shaft 115 is orthogonal to the Input shaft 100. The revolution of the crank pin 101 9 about the longitudinal axis 1021 of Input disk 102 is translated to pure linear back and forth movement or reciprocating movement of the Rack 104. This mechanism is commonly known as “Scotch-Yoke-Mechanism” in the industry. The distance of this linear back and forth movement (stroke) is directly proportional to the radial distance of the Crank pin 9 from the longitudinal axis 1021 of the Input disk 102. Since the work done is constant, which is a product of force applied multiplied by the distance traveled (F*stroke), for a smaller stroke, the force applied is greater and for a longer stroke, the force applied is smaller.

c) The Rack 104 is linked to a Pinion 106 (FIG. 71A) converting this linear movement of the Rack 104 to rocking oscillation of the Pinion 106.

d) This rocking oscillation is converted to a unidirectional rotation, using a One-way bearing/Computer-Controlled-Clutch/Ratchet-mechanism 22.

One main purpose of this invention is to achieve a CONSTANT AND UNIFORM output angular velocity when the input angular velocity is constant and uniform. However, using the steps described above, this is NOT achieved, as the output is sinusoidal.

By modifying the rate of change of angular displacement of the Input disk 102, a uniform steady output can be achieved. U.S. Pat. No. 9,970,520 uses a pair of non-circular gears to achieve this. This invention achieves it by using modified Geneva mechanism customized for this.

By using a set of Geneva pin wheel 96 (FIG. 75A-75C) and Geneva slot wheel 97 (FIG. 77A-77C) the instantaneous rate of change of angular displacement at the Input disk 102 can be altered.

The components are grouped into modules/mechanisms for easier understanding:

Detailed description of Assembly, Sub-assembly of components/Modules and their functions:

a) Angular-Velocity-Modifier-Module (FIG. 69) The main purpose of this module is to change the uniform power input to a reciprocal of sinusoidal output. This is to reverse the effect of the sinusoidal output in a scotch yoke mechanism. This module comprises of:
1) Driving Geneva pin wheel 96,
2) Driven Geneva slot wheel 97 and
3) Power shaft 121

The Driving Geneva pin wheel 96 is mounted on the Input shaft 100. The shape of the Geneva slot wheel 97 is designed to achieve the end result which is the reciprocal of sinusoidal output. Multiple pins and multiple slots are used and with an overlap of more than one pin achieving a portion of the same results simultaneously. More than one set of driving Geneva pin wheel 96 and driven Geneva slot wheel 97 can be used in a single module. The slot or the walls of the slot are terminated where a pin's path forms loop. Also, multiple modules can share a common Geneva pin wheel 96 or a common Geneva slot wheel 97. In the slot wheel 97 the paths of the slots are cut from a slot wheel 97 or the walls of the path can be raised from a slot wheel 97 or a combination of both. This is to clear the interference of the pin where the pin and slot or slot walls do not produce desired result. Pins of the Geneva pin wheel 96 can be made with different heights so that they do not interfere with the wall of slots of other Geneva pins. A portion of the rotation of the Geneva pin wheel 96 and Geneva slot wheel 97 be achieved using one or more partial circular gears and/or one or more partial non-circular gear in parallel. The partial gears generate the non-functional region of the rack velocity while the Geneva wheel system generates functional portion of the rack velocity. The Geneva wheel slots also have an overlap of the region generated by the partial gear. This is to achieve a 1:X ratio of rotation between Geneve pin wheel 96 and Geneva slot wheel 97. Here X is an integer or a reciprocal of an integer. Optionally, a one-way bearing can be placed between the circular or non-circular gear linking the Geneva slot wheel 97 to the partial driven gear. Depending on the scenario either the Geneva pin wheel 96 or the Geneva slot wheel 97 can be made driving or driven.

b) Scotch-Yoke-Module (FIG. 71A, 71B): The main purpose of this module is to convert circular motion to a reciprocating motion. The output is sinusoidal for a steady, uniform input. This output is converted to a steady, uniform output using Angular-Velocity-Modifier-Module.

This Scotch-Yoke-Module comprises of:
1) Input disk 102,
2) Slotted Rack holder 103, and
3) Crank pin 101

The Input disk 102 has a radial slot.

The Slotted Rack holder 103 has a slot namely “Crank pin slot” 1013. It also has an extension on either side of the slot at the middle of the slot. This extension is normal to the Crank pin slot 1013. The Slotted rack holder 44, is placed on the other side of the Input disk 102 sandwiching the Input disk 102 between the Slotted Rack holder 103 and a Ratio-Changing-Mechanism, which is described in subsequent paragraphs. The Crank pin 101 passes through the slots of Ratio-Changing-Mechanism, Input disk 102, and Slotted Rack holder 103
c) Rectifier-Module: The main purpose of this module is a mechanical equivalent to a diode in an electrical circuit. It allows power transfer to one specific direction.
1) Rack 104,
2) Pinion 106,
3) Shaft-Pinion 48 and
4) One-way bearing/Computer-Controlled-Clutch/Ratchet-mechanism 22

The Rack 104 is attached to the Slotted Rack holder 103 normal to the Crank pin slot 1013 and paired with the Pinion 106. The Pinion 106 is mounted on a Shaft-Pinion 48. The computer-controlled clutch/one-way bearing/Ratchet-Mechanism 50 is mounted on the Shaft-Pinion 48. The Output-Gear/Output-Sprocket 51 is mounted on the OD of the One-Way-Bearing 50. Multiple pinions from multiple modules can be mounted on a common shaft-pinion 48. The one-way bearing can be placed between the pinion and the pinion shaft. In this scenario the shaft-pinion 48 will function as the CVT output. The shaft-pinion can be made hollow so that the CVT input shaft 100 can pass through the shaft-pinion 48 making the input and output of the CVT co-axial.

Two Rectifier-Modules are placed next to the Slotted Rack holder 103 such that the Rack 104 is placed normal to the Slotted rack holder's 44 Crank pin slot.

d) Gear-Changing-Mechanisms

Link Mechanism:

The Input shaft 100 has a non-circular hole in the middle. This is paired with a Sliding-Collar 108 with a matching exterior contour, which is co-axially placed allowing relative axial movement while restricting rotational angular displacement with respect to each other. Two thrust bearings 40 are co-axially placed in contact with one on either end of the Sliding-Collar 67 as shown in FIG. 89D and the Sliding-Collar-Auxiliary-Shaft 67 has a pivot 1028 on the other end. One end of a Link 109 is attached to the pivot 1028 and the other end of the Link 109 is either attached to the Crank pin 101, as shown in (FIG. 70A) or to the Crank pin shaft 115, as shown in (FIG. 70A) as appropriate. An axial displacement of the Sliding-Collar-Auxiliary-Shaft 67 will cause a radial displacement of the Crank pin 101 through the Link 109. This axial translation is achieved with a Lever-Ratio-Changing-Spiral-Flute-Mechanism 41 that pushes the Thrust bearing 40 attached to the Sliding-Collar-Auxiliary-Shaft 67. Optionally this can be sprung back with a Compression-Spring 39 placed between Input disk 102 and the Sliding-Collar-Auxiliary-Input-Shaft 67. Also, when this link mechanism is used the Driven-Geneva-slot wheel 97 can also function as the Input disk 102 when a radial slot is added to the Driven-Geneva-slot wheel 97, thereby eliminating the need for a separate Input disk 102.

For each scotch yoke module two Racks 64 can be placed on the Slotted Rack holder 103 with a phase shift of 180° engaged with their respective pinions placed co-axially on a common pinion shaft via a one-way bearing/computer-controlled clutch/a ratchet mechanism 114 to allow the pinion shaft to rotate in a specific direction. Many of these scotch yoke modules can be stacked and all the pinions of all the modules can be placed on one common pinion shaft, making the pinion shaft the output of the IVT. Further this common pinion shaft can be made hollow allowing the power shaft 121 which drives the driving Geneva pin wheel 96, to pass thru. With this arrangement a co-axial input to output can be achieved. This configuration allows to modify the output with a planetary gear system to achieve reverse gear converting the CVT to an IVT. This configuration also allows the force on the rack holder to pass through the plane of the common pinion shaft axis. In other words, the longitudinal axis of the common pinion and the force of the crankpin acting on the rack holder will be co-planer. This will minimize the moment of the force from the crank pin acting on the rack holder due to the resistance by the pinion and maximize the tangential force on the pinion.

Mechanism to Compensate Vibration (Rotational Imbalance):

1. Dummy-Crank pin 43: The Crank pin 101 is placed off-center when the Input disk 102 revolves. This imbalance will result in vibration. To compensate this, a Dummy-Crank pin 43 is placed at same distance 180° apart. This movement is identical to the movement of the Crank pin 101. The dummy crank pin 116 is attached to a dummy link 110 that links to the dummy crank pin 116 that is pivoted to the collar 108 placed to move in the opposite direction of the crank pin 101. The input shaft 100 is slotted to allow the link 109 and crank pin and dummy link 110 and dummy crank pin 116 to pass thru

2. Dummy-Rack 55 for counter oscillation: As the Input disk 102 rotates the Slotted Rack holder 103 has an oscillatory motion which will result in vibration. It is cancelled by having an appropriate mass oscillating in the opposite direction. This is achieved by pinion as shown in FIGS. 71A & 71B in contact with the Rack 104, which will spin back and forth. Bringing an appropriate mass in contact with the pinion at 180° apart will compensate for this vibration. A separate wheel can also be used in spite of the pinion or a lever pivoting on the pinion shaft can be used to link the rack and the Dummy Rack 105 such that they move in opposite direction. A slider connecting the lever and sliding in a slot normal to the rack teeth will guide the lever allowing the rack and Dummy Rack 105 to only slide in the direction of the longitudinal axis of the rack.

Reverse Gear Mechanism:

When the output from the Pinion shaft 107 is coupled with Miter/Bevel Gear Differential input shaft 31. The Miter/Bevel Gear Differential output shaft 32 will rotate in opposite directions via Miter/Bevel Gear 33. The Miter/Bevel Gear Differential input shaft 31 of this differential-mechanism is placed co-axial with The Miter/Bevel Gear Differential output shaft 32 with clearance so that it is free to spin independently with respect to the Miter/Bevel Gear Differential input shaft 31. Two Clutch-Park/Neutral/Reverse clutch/dog clutch 35 with a clutch are placed on the Miter/Bevel Gear 33 allowing them to move axially. These can be made to link with either of the Miter/Bevel Gear 33, which rotate in opposite direction. When one of the collars 108 is made to link via the Clutch-Park/Neutral/Reverse clutch/dog clutch 35, by means of clutch, with a particular output Clutch-Park/Neutral/Reverse clutch/dog clutch 35 and the Miter/Bevel Gear Differential output shaft 31 will rotate in a particular direction. It will reverse its direction if the link 109 is swapped to the other Miter/Bevel Gear 33.

Neutral Gear Mechanism:

When the collars 108 are not in link via the Clutch-Park/Neutral/Reverse clutch/dog clutch 35 with any of the Miter/Bevel Gear 33, the collar 108 and the Miter/Bevel Gear Differential output shaft 32 are not restricted and, therefore, they are free to spin in any direction and function as a “neutral” gear.

Park Mechanism:

When the collars 108 are in link via the Clutch-Park/Neutral/Reverse clutch/dog clutch 35 with both the Miter/Bevel Gear 33, the collar 108 is restricted from spinning and the Miter/Bevel Gear Differential output shaft 32 is totally restricted and, therefore, they are restricted to spin in any direction and function as a “parking” gear.

Converting CVT to an IVT (Infinitely-Variable-Transmission):

Having a co-axial input and output allows the CVT to function as an IVT. This can be achieved by adding a Planetary gear system with a Sun-Gear, Ring-Gear and Planets supported by Carriers, and linking with Input shaft 100, the Co-Axial-Output-Element-With-Internal-Gear/Planetary gear 65.

The following are the options to achieve this:
a) The Input shaft 100 is directly linked to the Sun-Gear of the planetary gear system with following 2 sub-options
   a. The Co-Axial-Output-Element-With-Internal-Gear/Planetary gear 65 is directly linked to the Carrier of the Planetary gear system and Ring-Gear of the Planetary gear system functions as the final output or wheel system 1022
   b. The Co-Axial-Output-Element-With-Internal-Gear/Planetary gear 65 is linked to the Ring-Gear of the Planetary gear system and the Carrier functions as the final output or wheel system 1022.
b) The Co-Axial-Output-Element-With-Internal-Gear/Planetary gear 65 is directly linked to the Sun-Gear of the Planetary gear system with following 2 sub-options.
   a. The Input shaft 100 is directly linked to the Carrier of the Planetary gear system and the Ring-Gear of the Planetary gear system functions as the final output or wheel system 1022.
   b. The Input shaft 100 is directly linked to the Ring-Gear of the Planetary gear-System and the Carrier functions as the final output or wheel system.
c) The Input shaft 100 is directly linked to the Ring-Gear of the planetary gear system with following 2 sub-options
   a. The Co-Axial-Output-Element-With-Internal-Gear/Planetary gear 65 is directly linked to the Carrier of the Planetary gear system and Sun-Gear of the Planetary-Gear-System functions as the final output or wheel system 1022.
   b. The Co-Axial-Output-Element-With-Internal-Gear/Planetary gear 65 is linked to the Sun-Gear of the Planetary gear system and the Carrier functions as the final output or wheel system 1022.
d) The Co-Axial-Output-Element-With-Internal-Gear/Planetary gear 65 is directly linked to the Ring-Gear of the Planetary gear system with following 2 sub-options.
   a. The Input shaft 100 is directly linked to the Carrier of the Planetary gear system and the Carrier of the Planetary gear system and the Sun-Gear of the Planetary-Gear-System functions as the final output or wheel system 1022.
   b. The Input shaft 100 is directly linked to the Sun-Gear of the Planetary gear system and the Carrier functions as the final output or wheel system 1022.
e) The Input shaft 100 is directly linked to the Carrier of the planetary gear system with following 2 sub-options
   a. The Co-Axial-Output-Element-With-Internal-Gear/Planetary gear 65 is directly linked to the Ring-Gear of the Planetary gear system and Sun-Gear of the Planetary gear system functions as the final output or wheel system 1022.
   b. The Co-Axial-Output-Element-With-Internal-Gear/Planetary gear 65 is linked to the Sun-Gear of the Planetary gear system and the Sun-Gear functions as the final output or wheel system 1022.
f) The Co-Axial-Output-Element-With-Internal-Gear/Planetary gear 65 is directly linked to the Carrier of the Planetary gear system with following 2 sub-options.
   a. The Input shaft 100 is directly linked to the Ring-Gear of the Planetary gear-System and the Ring-Gear of the Planetary gear system and the Sun-Gear of the Planetary gear system functions as the final output or wheel system 1022.
   b. The Input shaft 100 is directly linked to the Sun-Gear of the Planetary gear system and the Ring-Gear functions as the final output or wheel system 1022.

In other words, The Co-Axial-Output-Element-With-Internal-Gear/Planetary gear 65 is connected to one of the three elements, either a Ring-Gear, a Carrier, or a Sun-Gear of a Planetary gear system. The Input shaft 100 is connected to one of the remaining two elements of the Planetary gear system. The third remaining element of the Planetary-System functions as the final output or wheel system 1022. This converts the CVT to an IVT.

Compensating for Deviation in Rack Movement with Cams:

It is beneficial to have smooth and gradual transitions in the rack movement profile to improve the life of the transmission. As shown in FIG. 90, the ideal rack velocity profile is as follows:

1. gradual increase in acceleration from rest 1025

2. a region of acceleration 1026

3. gradual reduction in acceleration to a constant velocity 1027

4. a region of constant velocity 1028

5. gradual increase in deceleration to a constant deceleration 1029

6. a region of deceleration 1030

7. gradual reduction in deceleration to zero velocity 1031

8. steps 1 through 7 above repeated in the opposite direction

It may not always be possible to generate perfect Geneva wheel mechanism to meet the above desired Rack 104 movement. If the slot curves 1006 of the Geneva slot wheel 97 and the Geneva pin wheel 96 do not to achieve this desired Rack 104 movement, a planetary system can be used to compensate for any deviations from the desired Rack 104 movement profile. To achieve this, a Stationary sun gear 135 with respective to the ratio modifier frame 92 is placed co-axial with a driven circular or non-circular gear 132 which is driven by a driving circular or non-circular gear 131 as appropriate. This can also be used in addition to the Geneva wheel system. This is shown in FIGS. 110A & 110B. This Driving circular or non-circular gear 131 is mounted on the power shaft 121. One or more Cam shaft 129 is placed on the driven circular or non-circular gear 132 which acts like a carrier of the planetary gear system. A Cam-Gear 38 is rigidly attached on the Cam shaft 129. Each of this Cam-Gear 38 is made to engage another Cam input shaft 41 each. which is rigidly attached on the Input shaft 100. The cams can be designed to give a desired rack velocity profile. The above configuration will also work when the stationary sun is replaced with a Stationary ring gear 135. This is shown in FIGS. 111A & 111B.

1. A Pseudo Continuously Variable transmission with uninterrupted shifting comprising a controlled rotation device using a Geneva wheel mechanism with a one or more pins acting on a one or more slots with custom path, with instance of simultaneous instances, to achieve a specific angular velocity profile between a driving shaft and a driven shaft they are mounted on and the specific angular velocity profile include one or more combination of constant angular velocity ratio, change in angular velocity ratio, zero angular velocity ratio and in either a same or a reverse direction with respect to the driving shaft's direction of rotation as an alternate path from power source to wheel.

2. A Pseudo Continuously Variable transmission with uninterrupted shifting comprising a controlled rotation device, wherein two sets of co-axial gears, one for driving and one for driven, where a sum of radii of pitch diameters of each pair of meshing gears are same and are placed at a distance equal to the sum of the radii; where the smallest pitch diameter gear on both ends are full gears and are co-planer known as operating plane and other pairs of larger pitch diameters are in segments forming a full gear and have a center hole shaped same as the perimeter of the next lower pitch diameter gear and placed co-axial but at an offset plane and each set on either side of the operating plane avoiding intersection of larger pitch diameter gears with each other; where the pair of desired ratio is brought in and out of operating plane in segments sequentially in a region where the pairs are not in contact.

3. A Pseudo Continuously Variable transmission with uninterrupted shifting comprising a controlled rotation device of claim 2, wherein the spring-loaded segments are guided by one or more gear segment guides to guide the spring-loaded segments to stay co-axial to the axis of the driving and/or driven full gear.

4. A Pseudo Continuously Variable transmission with uninterrupted shifting comprising a controlled rotation device of claim 1, where the pins are circular or non-circular and multiple pins acting on multiple slots have briefly overlapped engagement with the same angular velocity profile, extended or retracted using solenoids or springs

5. A Pseudo Continuously Variable transmission with uninterrupted shifting comprising a controlled rotation device of claim 1, where the slots have a ramp to push the pins out of the slot to aid retraction of the pin from the slot and a rotationally fixed and axially movable spiral ramp extends the pin to engage with the slot.

6. A Pseudo Continuously Variable transmission with uninterrupted shifting comprising a controlled rotation device of claim 1, at the location where any two slots intersect, one or more spring loaded gates activated by an extension on the pin guides the pin on to its original track and prevent the pin from slipping into the crossing slot.

7. A Pseudo Continuously Variable transmission with uninterrupted shifting comprising a controlled rotation device comprising a controlled rotation device using a non-circular pin gear mechanism with a one or more pins with instances of simultaneously acting on teeth with custom profile to achieve a specific angular velocity profile between a driving shaft and a driven shaft they are mounted on and the specific angular velocity profile include one or more combination of constant angular velocity ratio, change in angular velocity ratio, zero angular velocity ratio as an alternate path from power source to wheel

8. A Pseudo Continuously Variable transmission with uninterrupted shifting comprising a controlled rotation device comprising a controlled rotation device a Geneva wheel mechanism of claim 1, wherein an uninterrupted shifting from existing gear ratio to a targeted gear ratio, is achieved by a sequence where the Geneva mechanism has a ramp region in between constant ratio region to another constant ratio region,
a) With a driving gear engaged to its conjugate driven gear,
b) when the angular velocity of the Geneva wheel mechanism is same as the angular velocity ratio of the currently engaged gear pair and synchronized, the Geneva wheel mechanism engages with its shaft via a dog clutch and
c) immediately the currently engaged gear pair disengages from its shaft while the currently engaged Geneva wheel mechanism is still in the same region and
d) after the Geneva wheel mechanism passes thru a ramp region and reaches and is well within region of the targeted conjugate driven gear's angular velocity and synchronized, the conjugate driven gear with the targeted ratio also engages to its shaft via a dog clutch and immediately the Geneva wheel mechanism disengages from its shaft while in the same region achieving uninterrupted shifting

9. A Pseudo Continuously Variable transmission with uninterrupted shifting comprising a controlled rotation device, comprising a controlled rotation device using a segmented non-circular gear with at least 2 constant zones separated by a ramp region and the non-circular gear has at least one “bald” region with no teeth, where the segments have ability to in or out of an operating plane in segments where it engages with its conjugate. (NCG independent)

10. A Pseudo Continuously Variable transmission with uninterrupted shifting comprising a controlled rotation device comprising a controlled rotation device of claim 9, wherein an uninterrupted shifting from existing gear ratio to a targeted gear ratio, is achieved by a sequence where the segmented non-circular gear pair has a ramp region in between constant ratio region to another constant ratio region,
a) With a driving gear engaged to its conjugate driven gear,
b) when the angular velocity of the segmented non-circular gear pair is same as the angular velocity ratio of the currently engaged gear pair and synchronized, the segmented non-circular gear slides to its operating plane and engages with its shaft via a dog clutch and
c) immediately the currently engaged gear pair disengages from its shaft while the currently engaged non-circular gear is still in the same region and
d) after the non-circular gear passes thru a ramp region and reaches and is well within region of the targeted conjugate driven gear's angular velocity and synchronized, the conjugate driven gear with the targeted ratio also engages to its shaft via a dog clutch and immediately the non-circular gear disengages from its shaft while in the same region achieving uninterrupted shifting

11. A Pseudo Continuously Variable transmission with uninterrupted shifting comprising a controlled rotation device comprising a controlled rotation device of claim 6, Duration Extender Module (DEM) transmission with uninterrupted shifting comprising
a) a set of driving circular gears rigidly mounted on (FIG. 39A) (GOOD KEEP)
b) a drive shaft and
c) a set of freewheeling conjugate driven gears, along with a double DEM driving circular gear axially attached to one of them, each with a
d) dog clutch to engage or disengage with
e) an intermediate shaft they are mounted on and the largest gear in addition placed on
f) a one-way bearing and
g) a segmented freewheeling double DEM driven gear, capable of moving axially out of or into an operating plane in segments with the double DEM driving circular gear, is axially attached to
h) a freewheeling DEM driving non-circular gear both placed on a
i) output-shaft and the DEM driving non-circular gear meshes with
j) a freewheeling DEM driven non-circular gear which is axially linked with
k) a freewheeling DEM driving circular ring gear or a freewheeling DEM driving sprocket both mounted on the drive shaft and the DEM driving circular ring gear meshes with
l) a DEM intermediate circular planet gear or DEM driven sprocket rigidly mounted on the intermediate shaft where,
m) a driving final out put gear that is rigidly mounted on the intermediate shaft, drives
n) a driven final output gear

12. A Pseudo Continuously Variable transmission with uninterrupted shifting comprising a controlled rotation device of claim 11 (previous), where the non-circular gear has a region of angular velocity ratio of 1:1 followed by a second region ramping from an angular velocity ratio of 1:1 to 1:(R1/R2) and a third region of angular velocity region of 1:(R1/R2) and a fourth region ramping to angular velocity ratio of 1:1, where, R1 and R2 are the angular velocity ratio of the driving circular gears to the conjugate driven circular gears.

13. A Pseudo Continuously Variable transmission with uninterrupted shifting comprising a controlled rotation device comprising a controlled rotation device of claim 1, Duration Extender Module (DEM) transmission with uninterrupted shifting comprising
a) a set of driving circular gears rigidly mounted on (FIG. 39A) (GOOD KEEP)
b) a drive shaft and
c) a set of freewheeling conjugate driven gears, along with a double DEM driving circular gear axially attached to one of them, each with a
d) dog clutch to engage or disengage with
e) an intermediate shaft they are mounted on and the largest gear in addition placed on
f) a one-way bearing and
g) a segmented freewheeling double DEM driven gear, capable of moving axially out of or into an operating plane in segments with the double DEM driving circular gear, is axially attached to
h) a freewheeling DEM Geneva pin wheel both placed on a
i) output-shaft and the DEM Geneva pin wheel engages with
j) a freewheeling DEM Geneva slot wheel with custom path which is axially linked with
k) a freewheeling DEM driving circular ring gear or a freewheeling DEM driving sprocket both mounted on the drive shaft and the DEM driving circular ring gear meshes with
l) a DEM intermediate circular planet gear or DEM driven sprocket rigidly mounted on the intermediate shaft where,
m) a driving final out put gear that is rigidly mounted on the intermediate shaft, drives
n) a driven final output gear

14. A Pseudo Continuously Variable transmission with uninterrupted shifting comprising a controlled rotation device of claim 13, where the Geneva wheel mechanism has a region of angular velocity ratio of 1:1 followed by a second region ramping from an angular velocity ratio of 1:1 to 1:(R1/R2) and a third region of angular velocity region of 1:(R1/R2) and a fourth region ramping to angular velocity ratio of 1:1, where, R1 and R2 are the angular velocity ratio of the driving circular gears to the conjugate driven circular gears

15. A Pseudo Continuously Variable transmission with uninterrupted shifting comprising a controlled rotation device comprising a controlled rotation device of claim 9, A double Duration Extender Module (DEM) transmission with uninterrupted shifting comprising
a) a set of driving circular gears rigidly mounted on
b) a drive shaft and
c) a set of freewheeling conjugate driven gears, along with a double DEM driving circular gear axially attached to one of them, each with a
d) dog clutch to engage or disengage with
e) an intermediate shaft they are mounted on and the largest gear in addition placed on
f) a one-way bearing and
g) a segmented freewheeling double DEM driven gear, capable of moving axially out of or into an operating plane in segments with the double DEM driving circular gear, is axially attached to
h) a freewheeling DEM driving non-circular gear both placed on a
i) output-shaft and the DEM driving non-circular gear meshes with
j) a freewheeling DEM driven non-circular gear which is axially linked with
k) a freewheeling DEM driving circular ring gear or a freewheeling DEM driving sprocket both mounted on the drive shaft and the DEM driving circular ring gear meshes with
l) a DEM intermediate circular planet gear or DEM driven sprocket rigidly mounted on the intermediate shaft where,
m) a driving final out put gear that is rigidly mounted on the intermediate shaft, drives a driven final output gear.

16. A Pseudo Continuously Variable transmission with uninterrupted shifting comprising a controlled rotation device of claim 15 (previous), where the non-circular gear has a region of angular velocity ratio of 1:1 followed by a second region ramping from an angular velocity ratio of 1:1 to 1:(R1/R2) and a third region of angular velocity region of 1:(R1/R2) and a fourth region ramping to angular velocity ratio of 1:1, where, R1 and R2 are the angular velocity ratio of the driving circular gears to the conjugate driven circular gears.

17. A Pseudo Continuously Variable transmission with uninterrupted shifting comprising a controlled rotation device of claim 16 (previous), wherein a sequence for an uninterrupted shift from existing gear ratio to a targeted gear ratio, is achieved by,
a) With the intermediate Shaft engaged to one of the conjugate driven gear,
b) when the angular velocity of the driving final output gear is same as the angular velocity of the currently engaged conjugate driven gear and synchronized the driving final output gear engages with the intermediate shaft via a dog clutch and
c) immediately the currently engaged conjugate driven gear is disengaged from the intermediate shaft while the currently engaged driving final output gear is still in the same region and
d) after the driving final output gear passes thru the ramp region and reaches and is well within region of the targeted conjugate driven gear's angular velocity and synchronized, the conjugate driven gear with the targeted ratio is also engaged to the intermediate Shaft via a dog clutch and
e) immediately the driving final output gear is disengaged from the intermediate shaft while in the same region achieving uninterrupted shifting

18. A Pseudo Continuously Variable transmission with uninterrupted shifting comprising a controlled rotation device of claim 17 (previous), wherein a sequence for an uninterrupted shift from existing gear ratio to a targeted gear ratio, is achieved by,
a) With the intermediate Shaft engaged to one of the conjugate driven gear,
b) when the angular velocity of the driving final output gear is same as the angular velocity of the currently engaged conjugate driven gear and synchronized the driving final output gear engages with the intermediate shaft via a dog clutch and
c) immediately the currently engaged conjugate driven gear is disengaged from the intermediate shaft while the currently engaged driving final output gear is still in the same region and
d) after the driving final output gear passes thru the ramp region and reaches and is well within region of the targeted conjugate driven gear's angular velocity and synchronized, the conjugate driven gear with the targeted ratio is also engaged to the intermediate Shaft via a dog clutch and
e) immediately the driving final output gear is disengaged from the intermediate shaft while in the same region achieving uninterrupted shifting

19. A Pseudo Continuously Variable transmission with uninterrupted shifting comprising a controlled rotation device with Geneva wheel of claim 1 comprising
a) a set of driving circular gears rigidly mounted on
b) a drive shaft and
c) a set of freewheeling conjugate driven gears, along with a double DEM driving circular gear axially attached to one of them, each with a
d) dog clutch to engage or disengage with
e) an intermediate shaft they are mounted on and the largest gear in addition placed on
f) a one-way bearing and
g) a double DEM driven gear, meshing with the double DEM driving circular gear, is axially attached to
h) a DEM driving Geneva pin wheel with solenoid operated retractable pins both placed on
i) a Geneva-shaft and the DEM driving Geneva pin wheel engages with
j) a DEM driven Geneva slot wheel which is axially linked with
k) a DEM uninterrupted shifting gear, via a train of freewheeling gears, rigidly mounted on the intermediate shaft and
l) a driving final out put gear that is rigidly mounted on the intermediate shaft, drives
m) a driven final output gear.

20. A Pseudo Continuously Variable transmission with uninterrupted shifting comprising a controlled rotation device with Geneva wheel of claim 19, where the Geneva pin wheel has non-circular pins that are capable of extending into and retracting from the Geneva slot wheel driving it and the Geneva slot wheel having at least one slot causing the wheel to ramp from an angular velocity ratio of 1:1 between the Geneva pin wheel and the Geneva slot wheel to a ratio 1:(R1/R2), and at least one slot causing the wheel to ramp from (R1/R2):1 to a ratio 1:1, where, R1 and R2 are the angular velocity ratio of the driving circular gears to the conjugate driven circular gears.

21. A Pseudo Continuously Variable transmission with uninterrupted shifting comprising a controlled rotation device with Geneva wheel of claim 20, wherein a sequence for an uninterrupted shift from existing gear ratio to a targeted gear ratio, is achieved by,
a) With the intermediate Shaft engaged to one of the conjugate driven gear,
b) when the angular velocity of the driving final output gear is same as the angular velocity of the currently engaged conjugate driven gear and synchronized the driving final output gear engages with the intermediate shaft via a dog clutch and
c) immediately the currently engaged conjugate driven gear is disengaged from the intermediate shaft while the currently engaged driving final output gear is still in the same region and
d) after the driving final output gear passes thru the ramp region and reaches and is well within region of the targeted conjugate driven gear's angular velocity and synchronized, the conjugate driven gear with the targeted ratio is also engaged to the intermediate Shaft via a dog clutch and
e) immediately the driving final output gear is disengaged from the intermediate shaft while in the same region achieving uninterrupted shifting.

22. A Pseudo Continuously Variable transmission with uninterrupted shifting comprising a controlled rotation device with smooth transition of claim 1 comprising
a) a set of driving circular gears rigidly mounted on
b) a drive shaft and
c) a set of freewheeling conjugate driven gears, each with a
d) dog clutch to engage or disengage with
e) an output shaft they are mounted on and the largest gear in addition placed on
f) a one-way bearing and is axially attached to
g) a DEM driving Geneva pin wheel with solenoid operated retractable pins engages with
h) a DEM driven Geneva slot wheel, freewheeling on the drive shaft and axially linked
i) a DEM uninterrupted shifting gear that drives
j) a driven final output gear mounted on the output shaft.

23. A Pseudo Continuously Variable transmission with uninterrupted shifting comprising a controlled rotation device with smooth transition of claim 22, wherein the Geneva pin wheel has non-circular pins that are capable of extending into and retracting from the Geneva slot wheel and driving it and the Geneva slot wheel having at least one slot when engaged with the pin causing the wheel to ramp up from R1 to R2 and at least one slot causing the wheel to ramp down from R2 to R1, where, R1 and R2 are the ratio of the driving circular gears to the conjugate driven gears.

24. A Pseudo Continuously Variable transmission with uninterrupted shifting comprising a controlled rotation device with smooth transition of claim 23, wherein a sequence for an uninterrupted shift from existing gear ratio to a targeted gear ratio, is achieved by,
a. With the intermediate Shaft engaged to one of the conjugate driven gear,
b. when the angular velocity of the driven final output gear is same as the angular velocity of the currently engaged conjugate driven gear and synchronized the driven final output gear engages with the intermediate shaft via a dog clutch and
c. immediately the currently engaged conjugate driven gear is disengaged from the intermediate shaft while the currently engaged driven final output gear is still in the same region and
d. after the driven final output gear passes thru the ramp region and reaches and is well within region of the targeted conjugate driven gear's angular velocity and synchronized, the conjugate driven gear with the targeted ratio is also engaged to the intermediate Shaft via a dog clutch and immediately the driven final output gear is disengaged from the intermediate shaft while in the same region achieving uninterrupted shifting.

25. A Pseudo Continuously Variable transmission with uninterrupted shifting comprising a controlled rotation device, infinitely variable transmission comprising of claim 1:
one or more driving Geneva pin wheels mounted on an input shaft, operably connected to one or more driven Geneva slot wheels each operably connected to rotate an input disk of a scotch yoke mechanism, causing a crank pin of the scotch yoke mechanism, placed at an offset distance to an axis of rotation of the input disk where the offset distance can be altered from 0 to a real value using an external force, to revolve around the axis of rotation of the input disk, which reciprocates one or more racks, which are restricted to only move along the rack's pitch line and each rack rocks a pinion comprising a one way bearing that is mounted on a hollow output shaft that is co-axially placed with the input shaft, wherein the input shaft passes completely through the output shaft.

26. A Pseudo Continuously Variable transmission with uninterrupted shifting comprising a controlled rotation device infinitely variable transmission comprising of claim 1:
A) at least one scotch yoke module comprising:
a. a crank pin revolving around
b. a notched input shaft, at an offset distance between a longitudinal axes of the crank pin and the auxiliary input shaft that remain parallel to each other, and the offset distance that can be altered when the crank pin is co-axial to the auxiliary input shaft from zero to a non-zero real number by displacing the crank pin along a radial slot of
c. an input disk rigidly mounted on the input shaft, by
B) a crank pin displacement mechanism comprising:
a. a sliding collar disposed co-axially with the auxiliary input shaft with a feature preventing relative angular displacement while allowing relative translation,
b. a link assembly comprising
i. a link pivoting the crank pin through the notch
ii. a crank pin pivot pin on one end and pivoting the sliding collar about
iii. a sliding collar pivot pin on another end of the link,
c. at least one thrust bearing that is co-axially placed in contact with the sliding collar, such that an external force applied on the thrust bearing causing an axial displacement of the thrust bearing along with the sliding collar with respect to the auxiliary input shaft, alters the offset distance by moving the crank pin along the radial slot of the input disk,
d. a slotted rack holder comprising one or more racks, which is restricted to only move along a direction of the longitudinal axis of the one or more racks, and a crank pin slot for receiving the crank pin, with a longitudinal axis of the crank pin slot orthogonal to the one or more racks,
C) at least one angular velocity module comprising:
a. an input shaft,
b. one or more driving Geneva pin wheels mounted on the input shaft and driving
c. at least one driven Geneva slot wheel each rotating the auxiliary input shaft
D) at least one rectifier module comprising:
a. a pinion engaged with the rack, and mounted on
b. a pinion shaft through
c. a computer-controlled clutch, a one-way clutch, or a ratchet mechanism
arranged such that a uniform rotation of the driving Geneva pin wheel via the input shaft, causes a non-uniform angular velocity of the input shaft via the driven Geneva slot wheel and the planetary gear system, causing the crank pin to reciprocate the rack substantially along a longitudinal direction of the rack at a substantially constant velocity and slowing down briefly during direction reversal and accelerating to the constant velocity, where a magnitude of the reciprocation is proportional to the offset distance of the crank pin and the auxiliary input shaft, and this reciprocation of the rack causes an alternating rotation of the pinion and this alternating rotation of the pinion is converted to a unidirectional rotation of the pinion shaft via the computer-controlled clutch, the one-way clutch or the ratchet mechanism.

27. A Pseudo Continuously Variable transmission with uninterrupted shifting comprising a controlled rotation device The infinitely variable transmission of claim 26, wherein the feature preventing relative angular displacement while allowing relative translation between the sliding collar and the auxiliary input shaft is further defined as one of the co-axially placed sliding collar or the auxiliary input shaft having a non-circular cross section and the other of the sliding collar and the auxiliary input shaft having a non-circular orifice matching the non-circular cross section.

28. A Pseudo Continuously Variable transmission with uninterrupted shifting comprising a controlled rotation device infinitely variable transmission comprising claim 1:
A) at least one scotch yoke module comprising:
a. a crank pin revolving around
b. a notched auxiliary input shaft, at an offset distance between longitudinal axes of the crank pin and the auxiliary input shaft that remain parallel to each other, and the offset distance that can be altered from zero when the crank pin is co-axial to the auxiliary input shaft to a non-zero real number by displacing the crank pin along a radial slot of
c. an input disk rigidly mounted on the auxiliary input shaft, by
B) a crank pin displacement mechanism comprising:
a. a sliding collar disposed co-axially with the auxiliary input shaft with a feature preventing relative angular displacement while allowing relative translation,
b. a link assembly comprising
i. a link pivoting the crank pin through the notch
ii. a crank pin pivot pin on one end and pivoting the sliding collar about
iii. a sliding collar pivot pin on another end of the link,
c. at least one thrust bearing that is co-axially placed in contact with the sliding collar, such that an external force applied on the thrust bearing causing an axial displacement of the thrust bearing along with the sliding collar with respect to the auxiliary input shaft, alters the offset distance by moving the crank pin along the radial slot of the input disk,
d. a slotted rack holder comprising one or more racks, which is restricted to only move along a direction of the longitudinal axis of the one or more racks, and a crank pin slot for receiving the crank pin, with a longitudinal axis of the crank pin slot orthogonal to the one or more racks,
C) at least one angular velocity module comprising:
a. an input shaft,
b. one or more driving circular or non-circular gear mounted on the input shaft and driving
c. at least one driven circular or non-circular gear that is mounted free to spin on a fixed shaft, where the driven non-circular gear further functions as a carrier of a planetary gear system, with
d. at least one free to spin planet gear meshing with a stationary ring gear that is mounted on a frame and is axially attached to
e. a primary cam that is operably engages with
f. a secondary cam that is mounted on the auxiliary input shaft and
D) at least one rectifier module comprising:
a. a pinion engaged with the rack, and mounted on
b. a pinion shaft through
c. a computer-controlled clutch, a one-way clutch, or a ratchet mechanism
arranged such that a uniform rotation of the driving non-circular gear via the input shaft, causes a non-uniform angular velocity of the auxiliary input shaft via the driven non-circular gear and the planetary gear system, causing the crank pin to reciprocate the rack substantially along a longitudinal direction of the rack at a substantially constant velocity and slowing down briefly during direction reversal and accelerating to the constant velocity, where a magnitude of the reciprocation is proportional to the offset distance of the crank pin and the auxiliary input shaft, and this reciprocation of the rack causes an alternating rotation of the pinion and this alternating rotation of the pinion is converted to a unidirectional rotation of the pinion shaft via the computer-controlled clutch, the one-way clutch or the ratchet mechanism.

29. A Pseudo Continuously Variable transmission with uninterrupted shifting comprising a controlled rotation device comprising
1) a set of circular Transmission Driving Gears varying in size are rigidly mounted on
2) a Driving Shaft,
3) a set of matching circular Transmission Driven Gears freewheeling on,
4) a Driven Shaft with its axis placed parallel to the axis of the Driving Shaft, with the ability to engage or disengage to any specific circular transmission driven gears,
5) one or more Duration Extender Module comprising
A) a Duration Extender Module Driving Non-Circular Gear axially connected via a disengageable linking mechanism to
B) one of the Transmission Driven Gears, mounted on the Driven Shaft or a larger driven gear of a pair of speed reduction circular gears mounted on the Driven Shaft or on
C) a Duration Extender Module Intermediate Driving Shaft parallel to the Driving Shaft
D) driven by a smaller Driving-Circular-Gear of the pair of speed reduction gears rigidly mounted on the Driving Shaft
E) a Duration Extender Module Driven Non-Circular Gear, meshing with the Duration Extender Module Driving Non-Circular Gear, is mounted freewheeling on the Driving Shaft or on
F) a Duration Extender Intermediate Driven Shaft parallel to Driving Shaft,
G) one or more Duration Extender Module Driving Circular Gears axially connected to the Duration Extender Module Driven Non-Circular Gear, and meshed to the corresponding
H) Duration Extender Module Driven Circular Gears mounted on the Driven Shaft, with the ability to engage or disengage with the Driven Shaft;
where the non-circular pairs have two or more constant angular velocity regions spaced by a ramp up or ramp down regions and the value of low and high ratios of the non-circular gears and the sizes of the circular Duration Extender Module driving and driven gears are selected so that all the constant angular velocities of the circular Duration Extender Module Driven Gears match the angular velocities of the circular transmission driven gears.

30. A Pseudo Continuously Variable transmission with uninterrupted shifting comprising a controlled rotation device of claim 29, wherein a sequence for an uninterrupted shift from existing gear ratio to a targeted gear ratio, is achieved by,
A) With the Driven Shaft engaged to one of the existing Transmission Driven Gear,
B) when the Duration Extender Module Driven Circular Gear corresponding to the currently engaged Transmission Driven Gear is well within the active region matching the angular velocity of the currently engaged Transmission Driven Gear and synchronized Duration Extender Module Driven Circular Gear is also engaged to the Driven Shaft and
C) immediately the currently engaged Transmission Driven Gear is disengaged from the Driven Shaft while the currently engaged Duration Extender Module Driven Circular Gear is still in the same region and
D) after the Duration Extender Module Driven Circular Gear passes thru the ramp region and reaches and is well within region of the targeted Transmission Driven Gear's angular velocity and synchronized, the Transmission Driven Gear with the targeted ratio is also engaged to the Driven Shaft and
E) immediately the Duration Extender Module Driven Circular Gear is disengaged from the Driven Shaft while in the same region.

31. A Pseudo Continuously Variable transmission with uninterrupted shifting comprising a controlled rotation device of claim 29, wherein one or more gears including non-circular gears can be replaced with sprockets and chain achieving the same result.
